(19) United States
(12) Patent Application Publication
(10) Pub. No.: US 2014/0227585 A1
(43) Pub. Date: Aug. 14, 2014

(54) BATTERY COMPONENTS WITH LEACHABLE METAL IONS AND USES THEREOF

(71) Applicant: Hollingsworth & Vose Company, E. Walpole, MA (US)

(72) Inventors: John Wertz, Hollis, NH (US); Christopher Campion, Townsend, MA (US); Rene Gargan, Townsend, MA (US); Mohan Rajaram, Albany, OR (US); Svetlana Krupnikov, Ashland, MA (US); John Windisch, Corvallis, OR (US)

(73) Assignee: Hollingsworth & Vose Company, E. Walpole, MA (US)

(21) Appl. No.: 14/259,415

(22) Filed: Apr. 23, 2014

Related U.S. Application Data
(63) Continuation-in-part of application No. 13/239,317, filed on Sep. 21, 2011, now abandoned.
Application No. 13/239,317 is a continuation-in-part of application No. 13/239,320, filed on Sep. 21, 2011.
Application No. 13/239,320 is a continuation-in-part of application No. 13/239,330, filed on Sep. 21, 2011.

(51) Int. Cl. H01M 10/42

(52) U.S. Cl. CPC H01M 10/4235
USPC 429/163; 429/233

(57) ABSTRACT

The disclosure describes compositions and methods for producing a change in the voltage at which hydrogen gas is produced in a lead acid battery. The compositions and methods relate to producing a concentration of one or more metal ions in the lead acid battery electrolyte. The various compositions disclosed include battery electrode plate grids designed to produce a concentration of one or more metal ions in the lead acid battery electrolyte. The disclosure also describes resin coated battery components or battery components coated with a metal oxide layer in which the coatings produce a concentration of one or more metal ions in the lead acid battery electrolyte.

### CROSS REFERENCE TO RELATED APPLICATIONS

This application is a continuation-in-part of U.S. patent application Ser. No. 13/239,320 filed Sep. 21, 2011; a continuation-in-part of U.S. patent application Ser. No. 13/239,317 filed Sep. 21, 2011; and a continuation-in-part of U.S. patent application Ser. No. 13/239,330 filed Sep. 21, 2011, the contents of each of which is incorporated by reference herein.

### BACKGROUND

The operation and efficiency of batteries (e.g., lead acid batteries) involves many complex electrochemical reactions. Lead acid batteries, including but not limited to valve regulated lead acid (“VRLA”), gelled electrolyte and flooded batteries, are particularly complex. One complication is the generation of oxygen and hydrogen that occurs at the positive and negative electrodes, respectively, when the battery is charged. The ability to prevent excessive oxygen and hydrogen formation within the battery is an aspect of battery design and manufacture that influences the overall quality and operation of a lead acid battery.

Further complicating battery recharging is a charge imbalance that builds up between the negative electrode(s) and the positive plate(s). This charge imbalance occurs because the battery is charged to a constant voltage where the sum of the voltage elevation or polarization determine when the capped voltage or voltage lid is achieved. When the voltage lid is achieved, the current is reduced by the charging system. The escalation of voltage of one electrode can cause the voltage lid to be reached with subsequent tapering of current before the other electrode is completely charged. The negative electrode in the lead acid battery has high potential for this to happen since the negative electrode is significantly more efficient in charging than the positive plate.

As a result of the imbalance, the negative electrode obtains a full charge first, after which hydrogen gas production begins. The positive plate continues to charge, albeit more slowly while hydrogen gas is produced. The underlying charge imbalance is difficult to address in current battery designs because the current applied to the battery cannot be regulated to suit the behaviors of the two plates.

### SUMMARY

In various embodiments of the present invention presents a lead acid battery electrode grid metal alloy including: between about 0.01 weight percent and about 0.15 weight percent calcium; between about 0.01 weight percent and about 1.6 weight percent tin; an additional alloy component and amount selected from the group consisting of: between about 0.007 weight percent and about 0.08 weight percent bismuth; between about 0.001 weight percent and about 0.013 weight percent nickel; between about 0.002 weight percent and about 0.026 weight percent antimony; between about 0.003 weight percent and about 0.036 weight percent cobalt; between about 0.002 weight percent and about 0.02 weight percent copper, and between about 0.002 weight percent and about 0.02 weight percent titanium; and balance lead.

In some embodiments, the additional alloy component and amount are selected from the group consisting of: between about 0.02 weight percent and about 0.04 weight percent bismuth; between about 0.032 weight percent and about 0.063 weight percent nickel; between about 0.064 weight percent and about 0.013 weight percent antimony; between about 0.009 weight percent and about 0.018 weight percent cobalt; between about 0.005 weight percent and about 0.010 weight percent copper, and between about 0.005 weight percent and about 0.010 weight percent titanium.

In some embodiments, the grid metal alloy includes between about 0.085 weight percent and about 0.1 weight percent calcium. In some embodiments, the grid metal alloy includes between about 1.3 weight percent and about 1.6 weight percent tin. In some embodiments, the grid metal alloy includes between about 0.5 weight percent and about 0.6 weight percent tin. In some embodiments, the grid metal alloy includes between about 0.001 weight percent and about 0.01 weight percent silver.

In various aspects, the present invention presents a lead acid battery including the electrode grid metal alloy as described above and an electrolyte.

In some embodiments, the electrode grid metal alloy leaches metal ions into the electrolyte with a target metal ion concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the electrode grid metal alloy leaches metal ions into the electrolyte with a target metal ion concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In some embodiments, the electrode grid metal alloy is in a positive electrode of the lead acid battery. In some embodiments, the electrode grid metal alloy is in a negative electrode of the lead acid battery.

In various embodiments of the present invention the present invention presents a lead acid battery that includes a negative electrode, a positive electrode, a separator between the negative and positive electrodes, and an electrolyte in contact with the negative and positive electrodes, wherein an electrode includes an electrode grid metal alloy with a means for shifting the voltage at which hydrogen is produced at the negative electrode by between about 10 mV and about 120 mV.

In some embodiments, the electrode grid metal alloy is in a positive electrode of the lead acid battery. In some embodiments, the electrode grid metal alloy is in a negative electrode of the lead acid battery. In some embodiments, the means for shifting the voltage leaches metal ions selected from the group consisting of bismuth ions, nickel ions, antimony ions, cobalt ions, copper ions, titanium ions and combinations thereof into the electrolyte.

In some embodiments, the means for shifting the voltage leaches metal ions into the electrolyte with a target metal ion concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the lead acid battery includes a means for shifting the voltage at which hydrogen is produced at the negative electrode by between about 30 mV and about 60 mV.

In some embodiments, the means for shifting the voltage leaches metal ions into the electrolyte with a target metal ion concentration selected from the group consisting of: between about 42.9 ppm and about 85.8 ppm of bismuth ions, between about 6.8 ppm and about 13.6 ppm of nickel ions, between about 6.8 ppm and about 13.6 ppm of tin ions, between about 13.8 ppm and about 27.6 ppm of antimony ions, between about 19.3 ppm and about 38.6 ppm of cobalt ions, between about 10.7 ppm and about 21.4 ppm of copper ions, and between about 10.7 ppm and about 21.4 ppm of titanium ions.

In various aspects, the lead acid battery that includes a negative electrode, a positive electrode, a separator between the negative and positive electrodes, and an electrolyte in contact with the negative and positive electrodes, wherein an electrode includes an electrode grid metal alloy that includes a means for providing metal ions into the electrolyte with a target concentration in the electrolyte that is selected from the group consisting of: between about 14.3 ppm and about 172 ppm of bismuth ions, between about 2.3 ppm and about 27.2 ppm of nickel ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the electrode grid metal alloy includes a means for providing metal ions into the electrolyte with a target concentration in the electrolyte that is selected from the group consisting of: between about 42.9 ppm and about 85.8 ppm of bismuth ions, between about 6.8 ppm and about 18.2 ppm of nickel ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a lead acid battery including the following components: a case, a negative electrode, a positive electrode, a separator, an electrolyte, and a coating of metal or metal oxide coating a surface of at least one battery component wherein the surface is a surface that contacts the electrolyte within the battery.

In some embodiments, the coating is a metal coating. In some embodiments, the coating is a metal oxide coating. In some embodiments, the metal or metal oxide are selected from the group consisting of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the metal or metal oxide are present in an amount sufficient to provide a target metal ion concentration in the electrolyte selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the metal or metal oxide are present in an amount sufficient to provide a target metal ion concentration in the electrolyte selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In some embodiments, the battery component is selected from the group consisting of a separator, a case, a positive electrode, a negative electrode and combinations thereof. In some embodiments, the metal oxide is bismuth oxide and the thickness of the coating is between about 0.004 microns and about 0.5 microns thick. In some embodiments, the coating includes between about 20.9 mg and about 251 mg of bismuth oxide.

In some embodiments, the metal oxide is nickel oxide and the thickness of the coating is between about 0.001 microns and about 0.14 microns thick. In some embodiments, the coating includes between about 4.6 mg and about 54.4 mg of nickel oxide.

In some embodiments, the metal oxide is tin oxide and the thickness of the coating is between about 0.001 microns and about 0.11 microns thick. In some embodiments, the coating includes between about 3.8 mg and about 44.9 mg of tin oxide.

In some embodiments, the metal oxide is antimony oxide and the thickness of the coating is between about 0.002 microns and about 0.26 microns thick. In some embodiments, the coating includes between about 7.2 mg and about 85.6 mg of antimony oxide.

In some embodiments, the metal oxide is cobalt oxide and the thickness of the coating is between about 0.003 microns and about 0.34 microns thick. In some embodiments, the coating includes between about 10.6 mg and about 127.3 mg of cobalt oxide.

In some embodiments, the metal oxide is copper oxide and the thickness of the coating is between about 0.002 microns and about 0.19 microns thick. In some embodiments, the coating includes between about 5.9 mg and about 69.5 mg of copper oxide.

In some embodiments, the metal oxide is titanium oxide and the thickness of the coating is between about 0.003 microns and about 0.37 microns thick. In some embodiments, the coating includes between about 7.8 mg and about 92.7 mg of titanium oxide.

In some embodiments, the coating is in the form of nanowires. In some embodiments, the coating is in the form of a continuous coating.

In various aspects, the present invention provides a lead acid battery component including a coating of metal or metal oxide coating a surface of the battery component wherein the surface is a surface that contacts the battery electrolyte within a battery.

In some embodiments, the component is defined by any one of embodiments described above.

In various aspects, the present invention provides a method of coating a lead-acid battery component including coating a surface of a battery component with a metal or metal oxide wherein the surface is a surface that contacts the battery electrolyte within a battery.

In some embodiments, the coating step includes chemical vapor deposition, sputtering, or thermal spraying. In some embodiments, the battery component is selected from the group consisting of a separator, a positive electrode, a negative electrode, a case and combinations thereof.

In some embodiments, the metal or metal oxide is selected from the group consisting of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the coating results in a coating that is between about 0.004 microns and about 0.48 microns thick, and the metal oxide is bismuth oxide. In some embodiments, the coating results in a coating that includes about 20.9 mg and about 251 mg of bismuth oxide.

In some embodiments, the coating results in a coating that is between about 0.001 microns and about 0.14 microns thick, and the metal oxide is nickel oxide. In some embodiments, the coating results in a coating that includes about 4.6 mg and about 54.4 mg of nickel oxide.

In some embodiments, the coating results in a coating that is between about 0.001 microns and about 0.11 microns thick, and the metal oxide is tin oxide. In some embodiments, the coating results in a coating that includes about 3.8 mg and about 44.9 mg of tin oxide.

In some embodiments, the coating results in a coating that is between about 0.002 microns and about 0.26 microns thick, and the metal oxide is antimony oxide. In some embodiments, the coating results in a coating that includes about 7.2 mg and about 85.6 mg of antimony oxide.

In some embodiments, the coating results in a coating that is between about 0.003 microns and about 0.34 microns thick, and the metal oxide is cobalt oxide. In some embodiments, the coating results in a coating that includes about 10.6 mg and about 127.3 mg of cobalt oxide.

In some embodiments, the coating results in a coating that is between about 0.002 microns and about 0.19 microns thick, and the metal oxide is copper oxide. In some embodiments, the coating results in a coating that includes about 5.9 mg and about 69.5 mg of copper oxide.

In some embodiments, the coating results in a coating that is between about 0.003 microns and about 0.37 microns thick, and the metal oxide is titanium oxide. In some embodiments, the coating results in a coating that includes about 7.8 mg and about 92.7 mg of titanium oxide.

In some embodiments, the amount of metal or metal oxide that is coated onto the battery component is such that if the battery component is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

It is to be understood that in this context and others described below, the term “battery component” may, in certain embodiments, include more than one physical component (e.g., in the case of separators where a single lead-acid battery may include a plurality of separators, the term “battery component” may refer to a single separator, more than one separator or all of the separator material for a given battery; the same is true of the electrodes in a lead-acid battery).

In some embodiments of this aspect and other battery components aspects described herein, the defined concentration is achieved when the battery component is placed in 0.75 to 1.25 liters of a sulfuric acid solution with a specific gravity of 1.26 at 20° C. In some embodiments of this aspect and other battery component aspects described herein the defined concentration is achieved when the battery component is placed in about 1 liter of a sulfuric acid solution with a specific gravity of 1.26 at 20° C. In some embodiments of this aspect and other battery component aspects described herein the defined concentration is the measured or predicted concentration that is achieved when all of the available metal ion is leached from the battery component.

In some embodiments, the amount of metal or metal oxide that is coated onto the battery component is such that if the battery component is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a lead acid battery separator including: glass fibers, non-glass additive fibers; and metal or metal oxide particles; wherein the metal or metal oxide particles are electrostatically bound to the non-glass additive fibers.

In some embodiments, the non-glass additive fibers are selected from the group consisting of cellulose fibers, synthetic fibers and combinations thereof. In some embodiments, the non-glass additive fibers are negatively charged. In some embodiments the separator further includes a dispersant.

In some embodiments, the dispersant is selected from the group consisting of polyacrylamides, polyethylene oxide, natural gums, alum, carboxymethylcellulose and combinations thereof. In some embodiments, the natural gum is guar gum.

In some embodiments, the metal or metal oxide particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the metal oxide particles are bismuth oxide particles that are present in an amount that is between about 0.02 weight percent and about 0.27 weight percent of the battery separator.

In some embodiments, the metal oxide particles are nickel oxide particles that are present in an amount that is between about 0.005 weight percent and about 0.06 weight percent of the battery separator.

In some embodiments, the metal oxide particles are tin oxide particles that are present in an amount that is between about 0.004 weight percent and about 0.05 weight percent of the battery separator.

In some embodiments, the metal oxide particles are antimony oxide particles that are present in an amount that is between about 0.008 weight percent and about 0.09 weight percent of the battery separator.

In some embodiments, the metal oxide particles are cobalt oxide particles that are present in an amount that is between about 0.01 weight percent and about 0.13 weight percent of the battery separator.

In some embodiments, the metal oxide particles are copper oxide particles that are present in an amount that is between about 0.006 weight percent and about 0.08 weight percent of the battery separator.

In some embodiments, the metal oxide particles are titanium oxide particles that are present in an amount that is between about 0.009 weight percent and about 0.10 weight percent of the battery separator.

In some embodiments, the amount of metal or metal oxide particles present is such that if the battery separator is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions. It is to be understood that in this context and others described below, the term “battery separator” may, in certain embodiments, include all of the separator material for a given battery.

In some embodiments of this aspect and other battery separator aspects described herein the defined concentration is achieved when the battery separator is placed in 0.75 to 1.25 liters of a sulfuric acid solution with a specific gravity of 1.26 at 20° C. In some embodiments of this aspect and other battery separator aspects described herein the defined concentration is achieved when the battery separator is placed in about 1 liter of a sulfuric acid solution with a specific gravity of 1.26 at 20° C. In some embodiments of this aspect and other battery separator aspects described herein the defined concentration is the measured or predicted concentration that is achieved when all of the available metal ion is leached from the battery separator.

In some embodiments, the amount of metal or metal oxide particles present is such that if the battery separator is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various embodiments of the present invention present a method of making a lead acid battery separator including: combining metal or metal oxide particles with glass fibers, non-glass additive fibers and water to form a mixture, wherein the metal or metal oxide particles are electrostatically bound to the non-glass additive fibers in the mixture; and forming a battery separator from the mixture through a wet laid process.

In some embodiments, the non-glass additive fibers are selected from the group consisting of cellulose fibers, synthetic fibers and combinations thereof. In some embodiments, the non-glass additive fibers are negatively charged. In some embodiments, the mixture further includes a dispersant. In some embodiments, the dispersant is selected from the group consisting of polyacrylamides, polyethylene oxide, natural gums, alum, carboxymethylcellulose and combinations thereof. In some embodiments, the natural gum is guar gum.

In some embodiments, the metal or metal oxide particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the metal oxide particles are bismuth oxide particles that are present in an amount that is between about 0.02 weight percent and about 0.27 weight percent of the battery separator.

In some embodiments, the metal oxide particles are nickel oxide particles that are present in an amount that is between about 0.005 weight percent and about 0.06 weight percent of the battery separator.

In some embodiments, the metal oxide particles are tin oxide particles that are present in an amount that is between about 0.004 weight percent and about 0.05 weight percent of the battery separator.

In some embodiments, the metal oxide particles are antimony oxide particles that are present in an amount that is between about 0.008 weight percent and about 0.09 weight percent of the battery separator.

In some embodiments, the metal oxide particles are cobalt oxide particles that are present in an amount that is between about 0.01 weight percent and about 0.13 weight percent of the battery separator.

In some embodiments, the metal oxide particles are copper oxide particles that are present in an amount that is between about 0.006 weight percent and about 0.08 weight percent of the battery separator.

In some embodiments, the metal oxide particles are titanium oxide particles that are present in an amount that is between about 0.009 weight percent and about 0.10 weight percent of the battery separator.

In some embodiments, the amount of metal or metal oxide particles added to the mixture is such that if the battery separator is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the amount of metal or metal oxide particles added to the mixture is such that if the battery separator is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a lead-acid battery that includes a negative electrode, a positive electrode, a separator between the negative and positive electrodes, and an electrolyte in contact with the negative and positive electrodes, wherein the lead-acid battery includes a means for shifting the voltage at which hydrogen is produced at the negative electrode by between about 10 mV and about 120 mV.

In some embodiments, the means for shifting the voltage leaches metal ions selected from the group consisting of bismuth ions, nickel ions, tin ions, antimony ions, cobalt ions, copper ions, titanium ions and combinations thereof into the electrolyte.

In some embodiments, the means for shifting the voltage leaches metal ions into the electrolyte with a target metal ion concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the lead acid battery includes a means for shifting the voltage at which hydrogen is produced at the negative electrode by between about 30 mV and about 60 mV.

In some embodiments, the means for shifting the voltage leaches metal ions into the electrolyte with a target metal ion concentration selected from the group consisting of: between about 42.9 ppm and about 85.8 ppm of bismuth ions, between about 6.8 ppm and about 13.6 ppm of nickel ions, between about 6.8 ppm and about 13.6 ppm of tin ions, between about 13.8 ppm and about 27.6 ppm of antimony ions, between about 19.3 ppm and about 38.6 ppm of cobalt ions, between about 10.7 ppm and about 21.4 ppm of copper ions, and between about 10.7 ppm and about 21.4 ppm of titanium ions.

In some embodiments, the means for shifting the voltage includes a coating of a metal or metal oxide on the surface of a battery component wherein the surface is in contact with the battery electrolyte.

In some embodiments, the coating is a metal coating. In some embodiments, the coating is a metal oxide coating. In some embodiments, the metal or metal oxide are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the component is selected from the group consisting of a separator, a case, a positive electrode, a negative electrode and combinations thereof.

In some embodiments, the component has a coating of bismuth oxide and the coating thickness is between about 0.004 microns and about 0.48 microns thick. In some embodiments, the component has a coating of nickel oxide and the coating thickness is between about 0.001 microns and about 0.14 microns thick. In some embodiments, the component has a coating of tin oxide and the coating thickness is between about 0.001 microns and about 0.11 microns thick. In some embodiments, the component has a coating of antimony oxide and the coating thickness is between about 0.002 microns and about 0.26 microns thick. In some embodiments, the component has a coating of cobalt oxide and the coating thickness is between about 0.003 microns and about 0.34 microns thick. In some embodiments, the component has a coating of copper oxide and the coating thickness is between about 0.002 microns and about 0.19 microns thick. In some embodiments, the component has a coating of titanium oxide and the coating thickness is between about 0.003 microns and about 0.37 microns thick.

In some embodiments, the means for shifting the voltage includes metal or metal oxide particles that are electrostatically bound to non-glass additive fibers of a battery separator. In some embodiments, the non-glass additive fibers are selected from the group consisting of cellulose fibers, synthetic fibers and combinations thereof. In some embodiments, the non-glass additive fibers are negatively charged.

In some embodiments, the metal or metal oxide particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the metal oxide particles are bismuth oxide particles that are present in an amount that is between about 0.02 weight percent and about 0.27 weight percent of the battery separator.

In some embodiments, the metal oxide particles are nickel oxide particles that are present in an amount that is between about 0.005 weight percent and about 0.06 weight percent of the battery separator.

In some embodiments, the metal oxide particles are tin oxide particles that are present in an amount that is between about 0.004 weight percent and about 0.05 weight percent of the battery separator.

In some embodiments, the metal oxide particles are antimony oxide particles that are present in an amount that is between about 0.008 weight percent and about 0.09 weight percent of the battery separator.

In some embodiments, the metal oxide particles are cobalt oxide particles that are present in an amount that is between about 0.01 weight percent and about 0.13 weight percent of the battery separator.

In some embodiments, the metal oxide particles are copper oxide particles that are present in an amount that is between 0.006 weight percent and about 0.08 weight percent of the battery separator.

In some embodiments, the metal oxide particles are titanium oxide particles that are present in an amount that is between about 0.009 weight percent and about 0.10 weight percent of the battery separator.

In various aspects, the present invention provides a lead acid battery that includes a negative electrode, a positive electrode, a separator between the negative and positive electrodes, and an electrolyte in contact with the negative and positive electrodes, wherein the lead-acid battery includes a means for providing metal ions into the electrolyte with a target concentration in the electrolyte that is selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the lead-acid battery includes a means for providing metal ions into the electrolyte with a target concentration in the electrolyte that is selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a lead acid battery including the following components: a case, a negative electrode, a positive electrode, a separator, electrolyte in contact with the components, and a resin containing particles of a metal or metal compound coating a surface of at least one battery component wherein the surface is a surface that contacts the electrolyte within the battery.

In some embodiments, the resin contains particles of a metal.

In some embodiments, the resin contains particles of a metal oxide.

In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the particles are present in the resin in an amount sufficient to provide a target metal ion concentration in the electrolyte selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the particles are present in the resin in an amount sufficient to provide a target metal ion concentration in the electrolyte selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In some embodiments, the battery component is selected from the group consisting of a separator, a case, a positive electrode, a negative electrode and combinations thereof.

In some embodiments, the particles are bismuth oxide particles that are present in the resin in an amount sufficient to provide a target bismuth ion concentration in the electrolyte that is between about 14.3 ppm and about 172 ppm.

In some embodiments, the thickness of the resin coating is between about 1.4 microns and about 174.6 microns.

In some embodiments, the particles are nickel oxide particles that are present in the resin in an amount sufficient to provide a target nickel ion concentration in the electrolyte that is between about 2.3 ppm and about 27.2 ppm. In some embodiments, the thickness of the resin coating is between about 1.5 microns and about 183.9 microns.

In some embodiments, the particles are tin oxide particles that are present in the resin in an amount sufficient to provide a target tin ion concentration in the electrolyte that is between about 2.3 ppm and about 27.2 ppm. In some embodiments, the thickness of the resin coating is between about 1.2 microns and about 149.0 microns.

In some embodiments, the particles are antimony oxide particles that are present in the resin in an amount sufficient to provide a target antimony ion concentration in the electrolyte that is between about 4.6 ppm and about 55.1 ppm. In some embodiments, the thickness of the resin coating is between about 1.4 microns and about 348.4 microns.

In some embodiments, the particles are cobalt oxide particles that are present in the resin in an amount sufficient to provide a target cobalt ion concentration in the electrolyte that is between about 6.4 ppm and about 77.1 ppm. In some embodiments, the thickness of the resin coating is between about 1.4 microns and about 168.4 microns.

In some embodiments, the particles are copper oxide particles that are present in the resin in an amount sufficient to provide a target copper ion concentration in the electrolyte that is between about 3.6 ppm and about 42.9 ppm. In some embodiments, the thickness of the resin coating is between about 1.6 microns and about 187.5 microns.

In some embodiments, the particles are titanium oxide particles that are present in the resin in an amount sufficient to provide a target titanium ion concentration in the electrolyte that is between about 3.6 ppm and about 42.9 ppm. In some embodiments, the thickness of the resin coating is between about 1.5 microns and about 166.0 microns.

In various aspects, the present invention provides a lead acid battery according any of the above embodiments wherein the resin is selected from the group consisting of polyacrylate, polystyreneacrylate, styrene butadiene rubber, polyvinylidine chloride and combinations thereof.

In some embodiments, the particles have an average diameter in the range of between about 90 nm and about 210 nm.

In various embodiments of the present invention provides a lead acid battery component including a resin containing particles of a metal or metal compound coating a surface of the battery component wherein the surface is a surface that contacts the battery electrolyte within a battery.

In some embodiments, the component is defined by any of the embodiments described above.

In various aspects, the present invention provides a method of coating a lead acid battery component including coating a surface of a battery component with a resin containing particles of a metal or metal compound wherein the surface is a surface that contacts the battery electrolyte within a battery. In some embodiments, the resin is selected from the group consisting of polyacrylate, polystyreneacrylate, styrene butadiene rubber, polyvinylidine chloride and combinations thereof.

In some embodiments, the coating step includes spraying a resin solution containing the particles on the surface.

In some embodiments, the battery component is selected from the group consisting of a separator, a positive electrode, a negative electrode, a case and combinations thereof. In some embodiments, the resin contains particles of a metal. In some embodiments, the resin contains particles of a metal oxide.

In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, spraying results in a coating that is between about 1.4 microns and about 174.6 microns thick, and the particles are particles of bismuth oxide. In some embodiments, spraying results in a coating that is between about 1.5 microns and about 183.9 microns thick, and the particles are particles of nickel oxide. In some embodiments, spraying results in a coating that is between about 1.2 microns and about 149.0 microns thick, and the particles are particles of tin oxide. In some embodiments, spraying results in a coating that is between about 1.4 microns and about 348.4 microns thick, and the particles are particles of antimony oxide. In some embodiments, spraying results in a coating that is between about 1.4 microns and about 168.4 microns thick, and the particles are particles of cobalt oxide. In some embodiments, spraying results in a coating that is between about 1.6 microns and about 187.5 microns thick, and the particles are particles of copper oxide. In some embodiments, spraying results in a coating that is between about 1.5 microns and about 166.0 microns thick, and the particles are particles of titanium oxide.

In some embodiments, the amount of particles of metal or metal compound that are coated onto the lead acid battery component is such that if the lead acid battery component is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions. It is to be understood that in this context and others described below, the term “battery component” may, in certain embodiments, include more than one physical component (e.g., in the case of separators where a single lead-acid battery may include a plurality of separators, the term “battery component” may refer to a single separator, more than one separator or all of the separator material for a given battery; the same is true of the electrodes in a lead-acid battery).

In some embodiments of this aspect and other battery components aspects described herein, the defined concentration is achieved when the battery component is placed in 0.75 to 1.25 liters of a sulfuric acid solution with a specific gravity of 1.26 at 20° C. In some embodiments of this aspect and other battery component aspects described herein the defined concentration is achieved when the battery component is placed in about 1 liter of a sulfuric acid solution with a specific gravity of 1.26 at 20° C. In some embodiments of this aspect and other battery component aspects described herein the defined concentration is the measured or predicted concentration that is achieved when all of the available metal ion is leached from the battery component.

In some embodiments, the amount of particles of metal or metal compound that are coated onto the lead acid battery component is such that if the lead acid battery component is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a composition including a glass fiber coated with a resin layer that contains particles of a metal or metal compound, wherein the coated glass fiber further includes an intermediate layer including a sizing agent between the glass fiber and the resin layer.

In some embodiments, the resin layer includes between about 1 weight percent and about 11 weight percent of the coated glass fiber.

In some embodiments, the resin layer includes between about 3 weight percent and about 6 weight percent of the coated glass fiber.

In some embodiments, the resin layer includes between about 9 weight percent and about 11 weight percent of the coated glass fiber.

In some embodiments, the particles are particles of a metal. In some embodiments, the particles are particles of a metal oxide.

In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the particles are bismuth oxide particles that are present in an amount that is between about 0.6 weight percent and about 7.3 weight percent of the composition. In some embodiments, the particles are nickel oxide particles that are present in an amount that is between about 0.13 weight percent and about 1.6 weight percent of the composition. In some embodiments, the particles are tin oxide particles that are present in an amount that is between about 0.11 weight percent and about 1.3 weight percent of the composition. In some embodiments, the particles are antimony oxide particles that are present in an amount that is between about 0.21 weight percent and about 2.5 weight percent of the composition. In some embodiments, the particles are cobalt oxide particles that are present in an amount that is between about 0.29 weight percent and about 3.7 weight percent of the composition. In some embodiments, the particles are copper oxide particles that are present in an amount that is between about 0.16 weight percent and about 2.0 weight percent of the composition. In some embodiments, the particles are titanium oxide particles that are present in an amount that is between about 0.24 weight percent and about 2.7 weight percent of the composition.

In some embodiments, the sizing agent includes a silane. In some embodiments, the silane is selected from the group consisting of monoaminosilane, diaminosilane, and combinations thereof.

In some embodiments, the resin is selected from the group consisting of polyacrylate, polystyreneacrylate, styrene butadiene rubber, polyvinylidine chloride and combinations thereof.

In various aspects, the present invention provides a battery component including a composition of any of the embodiments described above. In some embodiments, the battery component is a separator.

In some embodiments, the particles are bismuth oxide particles that are present in an amount that is between about 0.09 weight percent and about 1.1 weight percent of the separator. In some embodiments, the particles are nickel oxide particles that are present in an amount that is between about 0.02 weight percent and about 0.24 weight percent of the separator. In some embodiments, the particles are tin oxide particles that are present in an amount that is between about 0.02 weight percent and about 0.20 weight percent of the separator. In some embodiments, the particles are antimony oxide particles that are present in an amount that is between about 0.03 weight percent and about 0.37 weight percent of the separator. In some embodiments, the particles are cobalt oxide particles that are present in an amount that is between about 0.04 weight percent and about 0.55 weight percent of the separator. In some embodiments, the particles are copper oxide particles that are present in an amount that is between about 0.02 weight percent and about 0.30 weight percent of the separator. In some embodiments, the particles are titanium oxide particles that are present in an amount that is between about 0.04 weight percent and about 0.40 weight percent of the separator.

In some embodiments, the amount of particles of metal or metal compound that are present in the battery component is such that if the battery component is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the amount of particles of metal or metal compound that are present in the battery component is such that if the battery component is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention present a method of making a coated glass fiber including: coating a formed glass fiber with a sizing agent; and then coating the formed glass fiber with a resin containing particles of a metal or metal compound.

In some embodiments, the particles are particles of a metal. In some embodiments, the particles are particles of a metal oxide. In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the particles are bismuth oxide particles that are present in an amount that is between about 0.6 weight percent and about 7.3 weight percent of the coated glass fiber. In some embodiments, the particles are nickel oxide particles that are present in an amount that is between about 0.13 weight percent and about 1.6 weight percent of the coated glass fiber. In some embodiments, the particles are tin oxide particles that are present in an amount that is between about 0.11 weight percent and about 1.3 weight percent of the coated glass fiber. In some embodiments, the particles are antimony oxide particles that are present in an amount that is between about 0.21 weight percent and about 2.5 weight percent of the coated glass fiber. In some embodiments, the particles are cobalt oxide particles that are present in an amount that is between about 0.29 weight percent and about 3.7 weight percent of the coated glass fiber. In some embodiments, the particles are copper oxide particles that are present in an amount that is between about 0.16 weight percent and about 2.0 weight percent of the coated glass fiber. In some embodiments, the particles are titanium oxide particles that are present in an amount that is between about 0.24 weight percent and about 2.7 weight percent of the coated glass fiber.

In some embodiments, the sizing agent includes a silane. In some embodiments, the silane is selected from the group consisting of monoaminosilane, diaminosilane, and combinations thereof. In some embodiments, the resin is selected from the group consisting of polyacrylate, polystyreneacrylate, styrene butadiene rubber, polyvinylidine chloride and combinations thereof.

In some embodiments, the method further includes incorporating a plurality of coated glass fibers into a battery component. In some embodiments, the battery component is a separator.

In various aspects, the present invention provides a resin filled battery separator including a mat of glass fibers and a resin, wherein the resin includes particles of a metal or metal compound.

In some embodiments, the resin is selected from the group consisting of polyacrylate, polystyreneacrylate, styrene butadiene rubber, polyvinylidine chloride and combinations thereof. In some embodiments, the resin contains particles of a metal.

In some embodiments, the resin contains particles of a metal oxide.

In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the particles are bismuth oxide particles that are present in an amount that is between about 0.03 weight percent and about 0.39 weight percent of the battery separator. In some embodiments, the particles are nickel oxide particles that are present in an amount that is between about 0.007 weight percent and about 0.08 weight percent of the battery separator. In some embodiments, the particles are tin oxide particles that are present in an amount that is between about 0.006 weight percent and about 0.07 weight percent of the battery separator. In some embodiments, the particles are antimony oxide particles that are present in an amount that is between about 0.01 weight percent and about 0.13 weight percent of the battery separator. In some embodiments the particles are cobalt oxide particles that are present in an amount that is between about 0.02 weight percent and about 0.19 weight percent of the battery separator. In some embodiments, the particles are copper oxide particles that are present in an amount that is between about 0.009 weight percent and about 0.11 weight percent of the battery separator. In some embodiments, the particles are titanium oxide particles that are present in an amount that is between about 0.01 weight percent and about 0.14 weight percent of the battery separator.

In some embodiments, the amount of particles of metal or metal compound that are present in the battery component is such that if the battery separator is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the amount of particles of metal or metal compound that are present in the battery component is such that if the battery separator is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a method of making a resin filled battery separator including: adding a resin containing particles of a metal or metal compound to a mat of glass fibers to form a filled mat and then drying the filled mat.

In some embodiments, the resin is selected from the group consisting of polyacrylate, polystyreneacrylate, styrene butadiene rubber, polyvinylidine chloride and combinations thereof.

In some embodiments, the resin contains particles of a metal. In some embodiments, the resin contains particles of a metal oxide. In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the particles are bismuth oxide particles that are present in an amount that is between about 0.03 weight percent and about 0.39 weight percent of the battery separator. In some embodiments, the particles are nickel oxide particles that are present in an amount that is between about 0.007 weight percent and about 0.08 weight percent of the battery separator. In some embodiments, the particles are tin oxide particles that are present in an amount that is between about 0.006 weight percent and about 0.07 weight percent of the battery separator. In some embodiments, the particles are antimony oxide particles that are present in an amount that is between about 0.01 weight percent and about 0.13 weight percent of the battery separator. In some embodiments, the particles are cobalt oxide particles that are present in an amount that is between about 0.02 weight percent and about 0.19 weight percent of the battery separator. In some embodiments, the particles are copper oxide particles that are present in an amount that is between about 0.009 weight percent and about 0.11 weight percent of the battery separator. In some embodiments, the particles are titanium oxide particles that are present in an amount that is between about 0.01 weight percent and about 0.14 weight percent of the battery separator.

In some embodiments, the amount of particles of metal or metal compound that are present in the battery component is such that if the battery separator is placed in 0.5 to 1.5 liters of a sulfuric acid solution with a specific gravity of 1.26 at 20° C. it leaches metal ions to a final concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the amount of particles of metal or metal compound that are present in the battery component is such that if the battery separator is placed in 0.5 to 1.5 liters of a sulfuric acid solution with a specific gravity of 1.26 at 20° C. it leaches metal ions to a final concentration selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

In various aspects, the present invention provides a lead acid battery that includes a negative electrode, a positive electrode, a separator between the negative and positive electrodes, and an electrolyte in contact with the negative and positive electrodes, wherein the lead-acid battery includes a means for shifting the voltage at which hydrogen is produced at the negative electrode by between about 10 mV and about 120 mV.

In some embodiments, the means for shifting the voltage leaches metal ions selected from the group consisting of bismuth ions, nickel ions, tin ions, antimony ions, cobalt ions, copper ions, titanium ions and combinations thereof into the electrolyte.

In some embodiments, the means for shifting the voltage leaches metal ions into the electrolyte with a target metal ion concentration selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the lead acid battery includes a means for shifting the voltage at which hydrogen is produced at the negative electrode by between about 30 mV and about 60 mV.

In some embodiments, the means for shifting the voltage leaches metal ions into the electrolyte with a target metal ion concentration selected from the group consisting of: between about 42.9 ppm and about 85.8 ppm of bismuth ions, between about 6.8 ppm and about 13.6 ppm of nickel ions, between about 6.8 ppm and about 13.6 ppm of tin ions, between about 13.8 ppm and about 27.6 ppm of antimony ions, between about 19.3 ppm and about 38.6 ppm of cobalt ions, between about 10.7 ppm and about 21.4 ppm of copper ions, and between about 10.7 ppm and about 21.4 ppm of titanium ions.

In some embodiments, the resin is selected from the group consisting of polyacrylate, polystyreneacrylate, styrene butadiene rubber, polyvinylidine chloride and combinations thereof. In some embodiments, the resin contains particles of a metal. In some embodiments, the resin contains particles of a metal oxide. In some embodiments, the particles are selected from the group consisting of particles of bismuth, nickel, tin, antimony, cobalt, copper, titanium, bismuth oxide, nickel oxide, tin oxide, antimony oxide, cobalt oxide, copper oxide, titanium oxide and combinations thereof.

In some embodiments, the means for shifting the voltage includes a resin coating containing particles of metal or a metal compound on the surface of a battery component wherein the surface is in contact with the battery electrolyte.

In some embodiments, the component is selected from the group consisting of a separator, a case, a positive electrode, a negative electrode and combinations thereof.

In some embodiments, the resin contains particles of bismuth oxide and the coating thickness is between about 1.4 microns and about 174.6 microns. In some embodiments, the resin contains particles of nickel oxide and the coating thickness is between about 1.5 microns and about 183.9 microns. In some embodiments, the resin contains particles of tin oxide and the coating thickness is between about 1.2 microns and about 149.0 microns. In some embodiments, the resin contains particles of antimony oxide and the coating thickness is between about 1.4 microns and about 348.4 microns. In some embodiments, the resin contains particles of cobalt oxide and the coating thickness is between about 1.4 microns and about 168.4. In some embodiments, the resin contains particles of copper oxide and the coating thickness is between about 1.5 microns and about 187.5 microns. In some embodiments, the resin contains particles of titanium oxide and the coating thickness is between about 1.4 microns and about 166.0 microns.

In some embodiments, the means for shifting the voltage includes a resin containing particles of a metal or metal compound in a resin filled separator.

In some embodiments, the separator includes between about 0.03 weight percent and about 0.39 weight percent of bismuth oxide, about 0.007 weight percent and about 0.08 weight percent of nickel oxide, about 0.006 weight percent and about 0.07 weight percent of tin oxide, about 0.01 weight percent and about 0.13 weight percent of antimony oxide, about 0.02 weight percent and about 0.19 weight percent of cobalt oxide, about 0.009 weight percent and about 0.11 weight percent of copper oxide or about 0.01 weight percent and about 0.14 weight percent of titanium oxide.

In some embodiments, the means for shifting the voltage includes a battery separator that includes glass fibers that are coated with a resin layer that contains particles of a metal or metal compound and an intermediate layer including a sizing agent between the glass fiber and the resin layer.

In some embodiments, the separator includes between about 0.09 weight percent and about 1.10 weight percent of bismuth oxide, about 0.02 weight percent and about 0.24 weight percent of nickel oxide, about 0.02 weight percent and about 0.20 weight percent of tin oxide, about 0.03 weight percent and about 0.37 weight percent of antimony oxide, about 0.04 weight percent and about 0.55 weight percent of cobalt oxide, about 0.02 weight percent and about 0.30 weight percent of copper oxide, or about 0.04 weight percent and about 0.40 weight percent of titanium oxide.

In some embodiments, the resin layer includes between about 1 weight percent and about 11 weight percent of the coated glass fiber.

In some embodiments, the resin layer includes between about 3 weight percent and about 6 weight percent of the coated glass fiber.

In some embodiments, the resin layer includes between about 9 weight percent and about 11 weight percent of the coated glass fiber.

In various aspects the present invention provides a lead acid battery that includes a negative electrode, a positive electrode, a separator between the negative and positive electrodes, and an electrolyte in contact with the negative and positive electrodes, wherein the lead-acid battery includes a means for providing metal ions into the electrolyte with a target concentration in the electrolyte that is selected from the group consisting of: between about 14.3 ppm and about 172 ppm of bismuth ions, between about 2.3 ppm and about 27.2 ppm of nickel ions, between about 2.3 ppm and about 27.2 ppm of tin ions, between about 4.6 ppm and about 55.1 ppm of antimony ions, between about 6.4 ppm and about 77.1 ppm of cobalt ions, between about 3.6 ppm and about 42.9 ppm of copper ions, and between about 3.6 ppm and about 42.9 ppm of titanium ions.

In some embodiments, the lead-acid battery includes a means for providing metal ions into the electrolyte with a target concentration in the electrolyte that is selected from the group consisting of: between about 42.9 ppm and about 85.8 ppm of bismuth ions, between about 6.8 ppm and about 18.2 ppm of nickel ions, between about 6.8 ppm and about 18.2 ppm of tin ions, between about 13.8 ppm and about 36.7 ppm of antimony ions, between about 19.3 ppm and about 51.4 ppm of cobalt ions, between about 10.7 ppm and about 28.5 ppm of copper ions, and between about 10.7 ppm and about 28.5 ppm of titanium ions.

### BRIEF DESCRIPTION OF THE DRAWING

The foregoing and other aspects of the invention will be apparent from the following more particular description of certain embodiments as illustrated in the accompanying drawing in which like reference characters refer to the same parts throughout the different views. The drawing is not necessarily to scale, with emphasis instead being placed upon illustrating the embodiments, principles and concepts.

FIG. 1 shows a cutaway diagram of an exemplary lead acid battery.

FIG. 2 shows a graph of the current profile of an exemplary lead acid battery during a recharging cycle.

FIG. 3 shows a graph of the voltage profile of an exemplary lead acid battery during a recharging cycle. The graph also plots the flow of hydrogen and oxygen gas flow vented from the battery during the cycle.

FIG. 4 shows a graph representing the voltage of the positive (upper) and negative (lower) electrodes during a recharging cycle.

FIG. 5 shows a graph which illustrates the effect of leached bismuth ions in the electrolyte solution on the negative electrode potential during a recharge cycle.

FIG. 6 shows a plot which illustrates the effect of different concentrations of leached bismuth ions in the electrolyte solution on the positive electrode plate potential compared to mercurous reference electrode during partial state of charge (“PSOC”) cycling.

FIG. 7 shows a graph comparing the cycling life of a lead acid battery with a standard glass fiber separator compared to an otherwise identical battery but with a separator composed of glass fibers containing leachable bismuth ions.

FIG. 8 shows a graph of different metal ion concentrations (ppm) that achieve a targeted hydrogen shift in an electrochemical compatibility test.

FIG. 9 shows graphs of the current profile of an exemplary lead acid test cell with a standard glass composition or a glass composition with leachable antimony after 3 days in sulfuric acid at room temperature.

FIG. 10 shows graphs of the current profile of an exemplary lead acid test cell with a standard composition or a glass composition with leachable antimony after 7 days in sulfuric acid at 70° C.

FIG. 11 shows graphs of the current profile of an exemplary lead acid test cell with a standard glass composition or a glass composition with leachable copper after 3 days in sulfuric acid at room temperature.

FIG. 12 shows graphs of the current profile of an exemplary lead acid test cell with a standard glass composition or a glass composition with leachable copper after 7 days in sulfuric acid at 70° C.

FIG. 13 shows a graph which compares the metal ion concentrations (ppm) that achieve a 50 mV shift in the onset of hydrogen production for various metal ions

FIG. 14 illustrates a process for making resin coated glass fibers.

### DETAILED DESCRIPTION OF CERTAIN EMBODIMENTS

The foregoing and other aspects of the invention will be apparent from the following more particular description of certain embodiments.

### 1. Lead Acid Batteries Generally

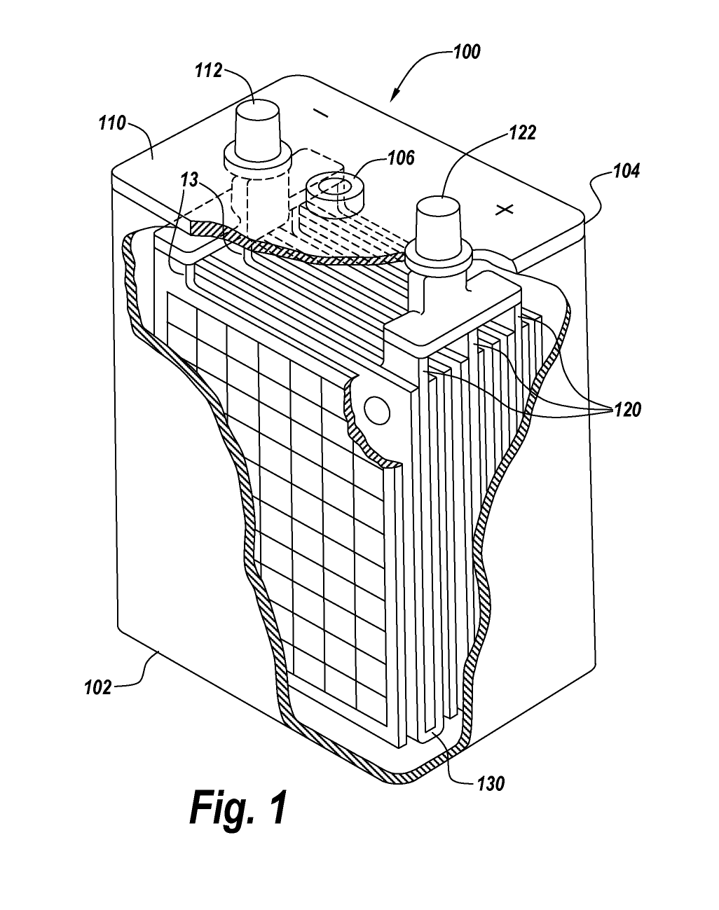

FIG. 1 shows an exemplary lead acid battery 100 including a case 102 with a top 104 having a boss 106 disposed therein. Case 102 contains anode plates 13 connected to a negative terminal 112, and cathode plates 120 connected to a positive terminal 122. Separators 130 are disposed between adjacent anode and cathode plates 110 and 120, respectively. Case 102 also contains sulfuric acid (e.g., an aqueous sulfuric acid solution).

The discharge reactions of a battery (e.g., a lead-acid battery) are well known:

Anode: Pb(s)+HSO₄⁻(aq)→PbSO₄(s)+H⁺+2e⁻ Eqn. 1

Cathode: PbO₂(s)+3H⁺(aq)+HSO₄⁻(aq)+2e⁻→PbSO₄(s)+2H₂O Eqn. 2

Net: Pb(s)+PbO₂(s)+2H⁺(aq)+2HSO₄⁻(aq)→2PbSO₄(s)+2H₂O Eqn. 3

Conversely, the reverse reactions for recharging the battery:

Anode: PbSO₄(s)+H⁺+2e⁻→Pb(s)+HSO₄⁻(aq) Eqn. 4

Cathode: PbSO₄(s)+2H₂O→PbO₂(s)+3H⁺(aq)+HSO₄⁻(aq)+2e⁻ Eqn. 5

Net: 2PbSO₄(s)+2H₂O→PbO₂(s)+Pb(s)+2H⁺(aq)+2HSO₄⁻(aq) Eqn. 6

Once the battery has reached full charge, an overcharging condition is present and the contents of the battery (e.g., water in the electrolyte) undergo the following reactions at the positive and negative electrode, respectively:

2H₂O→O₂+4H⁺+4e⁻(O₂ generation from the positive electrode) Eqn. 7

4H⁺+4e⁻→H₂(H₂ generation from the negative electrode) Eqn. 8

O₂+4H⁺+4e⁻→2H₂O(O₂ recombination at the negative electrode) Eqn. 9

Overcharge is the amount of extra charge needed to overcome inefficiencies in recharging the battery. The more efficient the battery is the less overcharge is required. Overcharge conditions in a battery can affect battery life and performance.

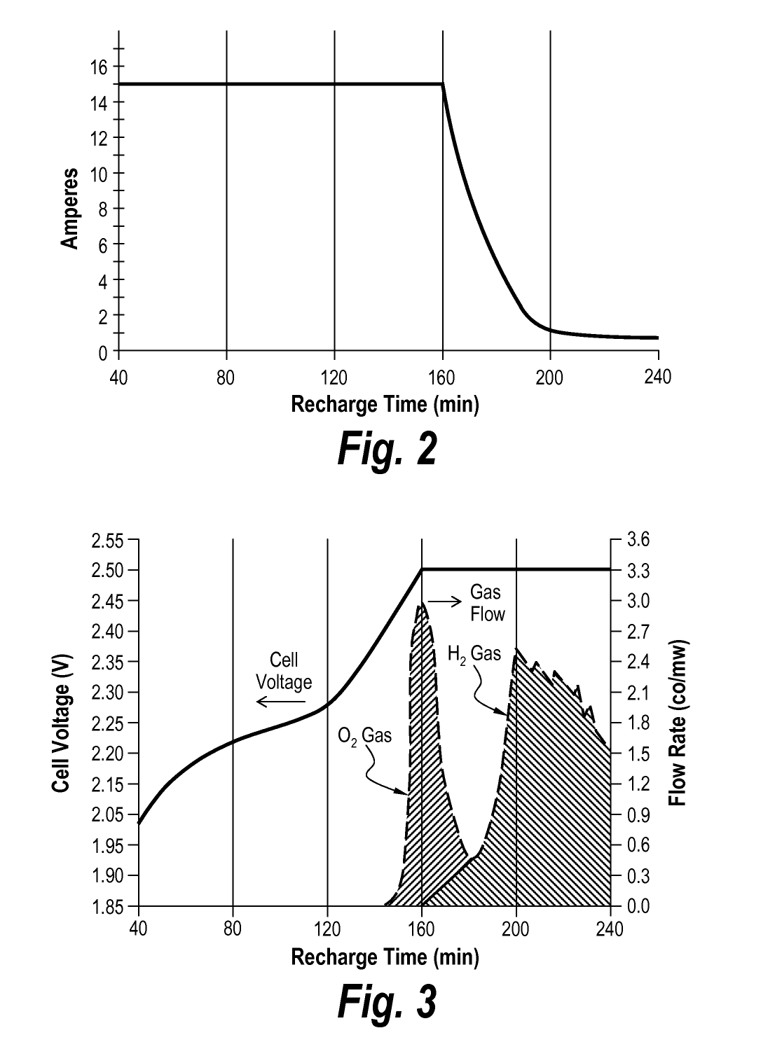

FIG. 2 shows the current profile during a charge or recharge cycle of an exemplary lead acid battery. Notably the current is constant until the time reaches a point just prior to 160 minutes, when the current drops. This drop corresponds to the end of the “bulk charging” period and the beginning of the overcharging condition. The overcharging period is a dynamic situation, as described above. FIG. 3 shows the voltage profile of a battery during charging or recharging alongside the gas flow that is developed and vented from the battery during the same period. FIG. 3 highlights the gas generation during the overcharging period. As the voltage stabilizes at about 2.50 volts, after nearly 160 minutes of charging, gas starts to vent from the cell. Gas analysis shows that the first spike in gas flow is mostly oxygen generated at the positive electrode (see Eqn. 7). The subsequent rapid decrease in vented oxygen is likely due to oxygen recombination reaction at the negative electrode (see Eqn. 9). The second spike in vented gas flow is from the hydrogen generated at the negative electrode (see Eqn. 8).

The prevention of oxygen and hydrogen formation in a lead acid battery governs several facets of battery performance and safety. Pure oxygen and hydrogen are explosive gases. They are generated in the final stages of recharge and a VRLA battery functions to minimize gas generation and water loss. Complete suppression of gassing is nearly impossible to achieve. In most systems, oxygen is entirely recombined, however, hydrogen is still vented as it is formed. Hydrogen generation and a low level of oxygen recombination also negatively affect the charge acceptance of the battery. Indeed, hydrogen production at the negative electrode is indicative of an exponentially rising negative electrode voltage. As discussed above, this negative electrode voltage is added to the positive electrode voltage to produce the battery voltage which must remain below a voltage lid. To keep the battery voltage under the voltage lid, current flow is reduced and, as a result, less charge can be accepted by the battery. Low levels of oxygen recombination lead to water loss (see Eqns. 7 & 9), which may also reduce cycle life (i.e., the number of charge-discharge cycles before a specific level of capacity is irreversibly lost).

### 2. Leachable Metal Ions and Surface-Side Reactions

Surface-side reactions, also called self discharge reactions or “local action”, at the surface of the negative electrode can be exploited to reduce hydrogen gassing. In various embodiments of the present invention, battery components are used which include a source of metal ions (e.g., bismuth ions, antimony ions, tin ions, etc.) that contribute favorably to these surface-side reactions. When the battery components are exposed to a battery electrolyte (e.g., sulfuric acid solution) the metal ions are released and leach into the electrolyte solution. The leached metal ions migrate to the surface of the electrodes, in particular the negative electrode and serve as initiators of the surface-side reactions.

In various embodiments of the present invention, battery components include metal oxides that leach into the electrolyte, where the oxides disassociate and the metal ions migrate to the negative electrode. The metal ions react at the negative electrode surface with sponge lead (Pb) to produce a lead ion. The lead ion in turn forms lead sulfate directly as a reaction with the sulfuric acid electrolyte:

2Pb(s)+O₂+2H₂SO₄→2PbSO₄(s)+2H₂O Eqn. 10

The production of lead sulfate at the surface provides reactant materials to be converted back to lead in the following electrochemical recharging reaction:

2PbSO₄(s)+4H⁺(aq)+4e⁻→2Pb(s)+2H₂SO₄ Eqn. 11

The recharging reaction also lowers the negative electrode's potential (i.e., makes the electrode more negative, or a higher voltage on an absolute basis). During typical overcharge the excess current normally produces hydrogen gas from water in the electrolyte by electrolysis (see Eqn. 8). However, when lead sulfate is available at the surface of the negative electrode, having been produced by the leached metal ions in the electrolyte, the excess current is consumed by the recharging reaction (Eqn. 11) thus preventing hydrogen from being produced at the negative electrode. The metal ions effectively decrease the state of charge of the negative electrode through the local action reactions, wherein metal ions in the structure of the negative electrode form internal electrochemical cells that consume charge converting sponge lead to lead sulfate. Because the lead sulfate is converted back to active sponge lead, during recharge (Eqn. 11), the impact of these metal ions can be expressed on an electrical current basis.

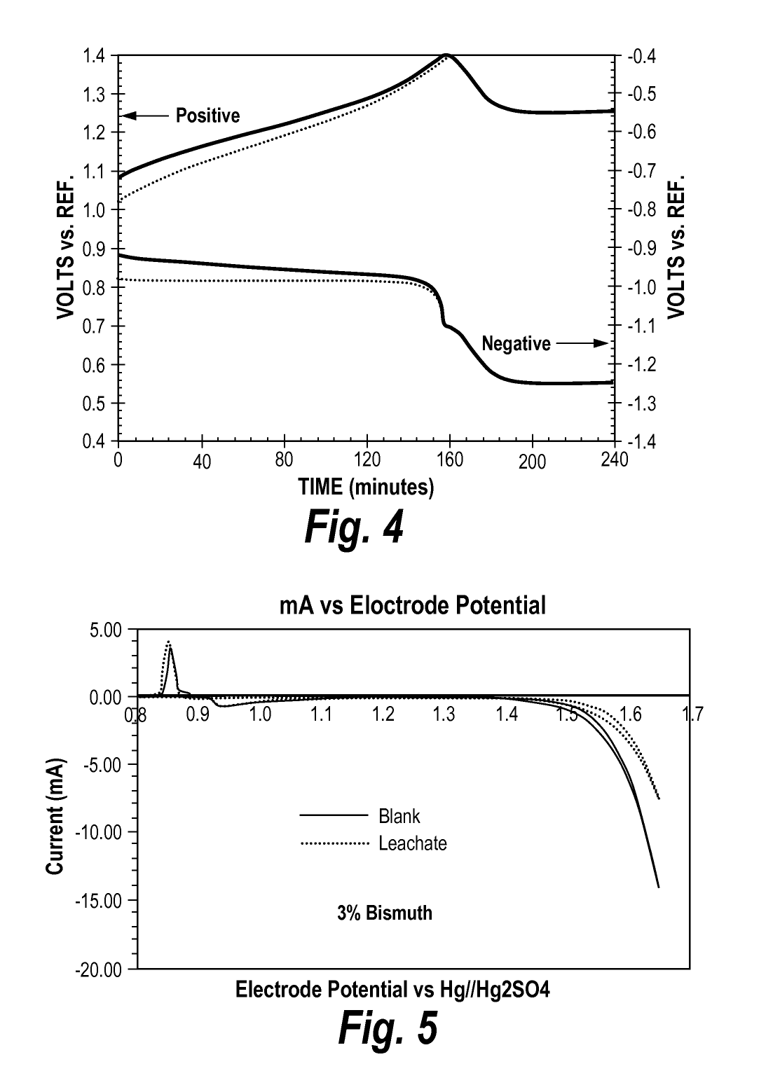

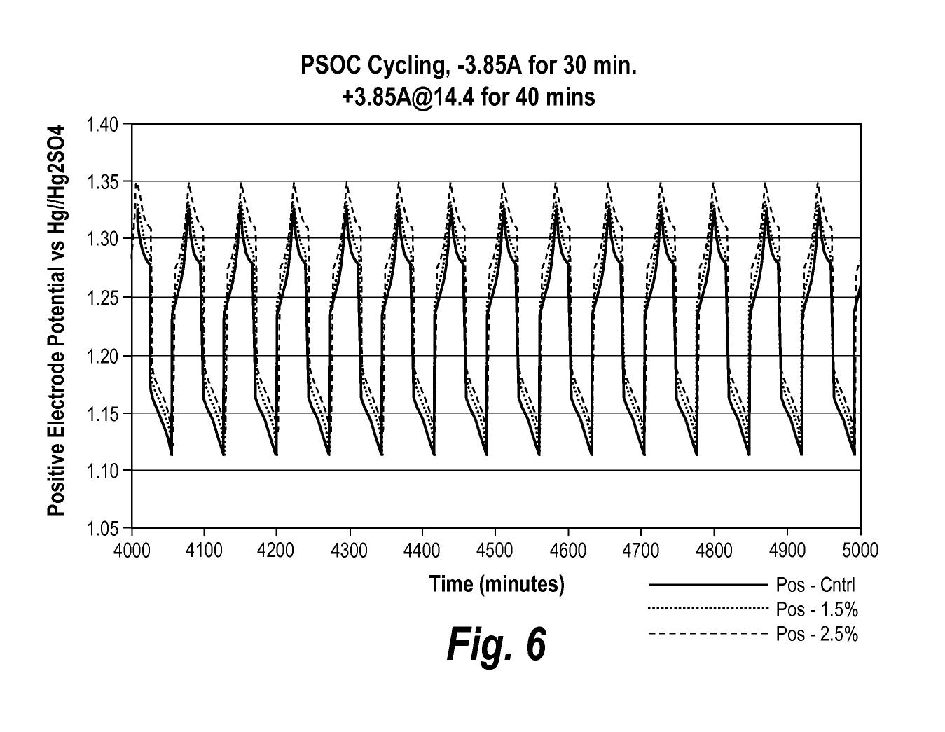

In addition to increasing the voltage at which hydrogen is produced at the negative electrode, the surface-side reactions produced by the leached metal ions can also affect positive and negative electrode polarization. Higher positive electrode polarization reduces oxidation, sulfation and grid corrosion at the positive electrode. High positive electrode polarization is also an indicator of superior cycling performance and longer battery life. FIG. 4 shows the response and relation of the individual electrodes in an exemplary lead acid battery during recharging. The positive potential increases in a linear fashion until the voltage lid (i.e., electrical limit of the systems) is obtained at about 160 minutes. In contrast, the negative electrode remains flat until an exponential rise occurs just prior to 160 minutes. Once the initial production of oxygen has been recombined (indicated by the irregularity in the negative voltage curve near 160 minutes and −1.15V), the negative electrode becomes highly polarized reaching about −1.25V. This high polarization of the negative electrode, in turn, causes a decline in the positive electrode potential due to the voltage lid. FIG. 4 shows a decrease from about 1.4V to about 1.25V in the positive electrode potential. Achieving a lower polarization for the negative electrode will lead to higher polarization for the positive electrode and a higher charge. See, for example FIG. 6, discussed below.

Similarly, when the negative electrode is fully charged but the positive plate is not fully charged, a charge imbalance situation results and the excess charge at the negative electrode produces hydrogen. The hydrogen production during charge imbalance circumstances is not easily solved. Although almost all of the oxygen generated at the positive electrode is recombined, the amount is not sufficient to equal hydrogen generation.

Referring to a specific example, the presence of a metal ion (e.g., a bismuth ion) in the electrolyte and deposition of it onto the negative electrode produces a shift in negative electrode behavior, as shown in the electrochemical test results shown in FIG. 5. The electrochemical test, described below, was designed to simulate the effect of the negative electrode surface-side reactions induced by the leached metal ions in a lead acid battery. The surface-side reactions are evidenced by measuring a shift in the voltage at which hydrogen is generated at the negative electrode. An exemplary test cell used lead dioxide positive and metallic lead negative electrodes and sulfuric acid electrolyte. The negative electrode voltage was driven by a mercurous sulfate reference electrode. A separator, or other delivery method of leachable metal ions, was simulated by adding ground glass particles containing metal oxide to the electrolyte. The voltage of the reference electrode was varied and the current through the test cell was measured. An increase in the measured current indicated that hydrogen production had started at the negative electrode. The higher the voltage at which hydrogen production begins the more efficiently the battery will recharge, up to the voltage at which side reaction dominate, and the battery is no longer charged.

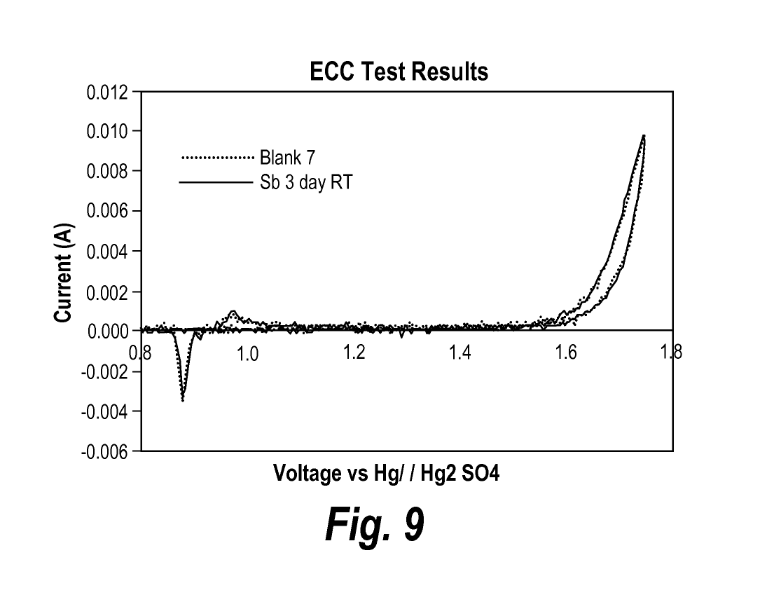

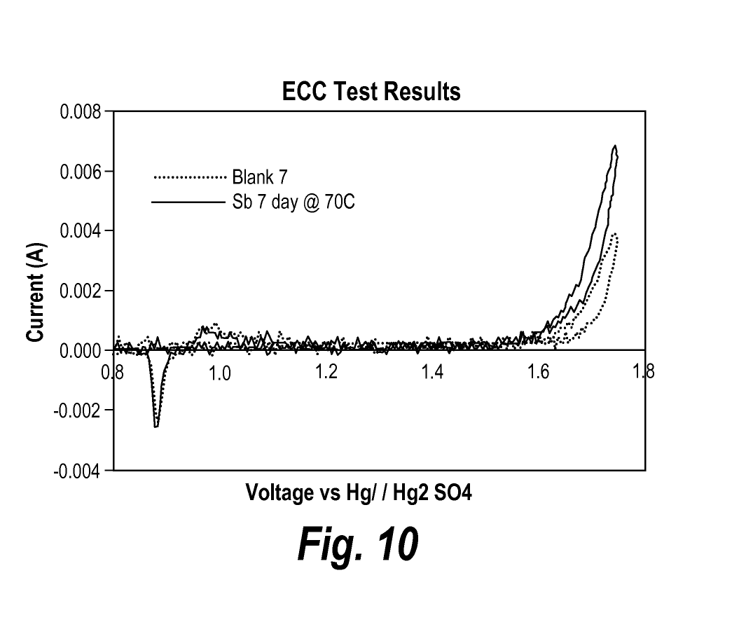

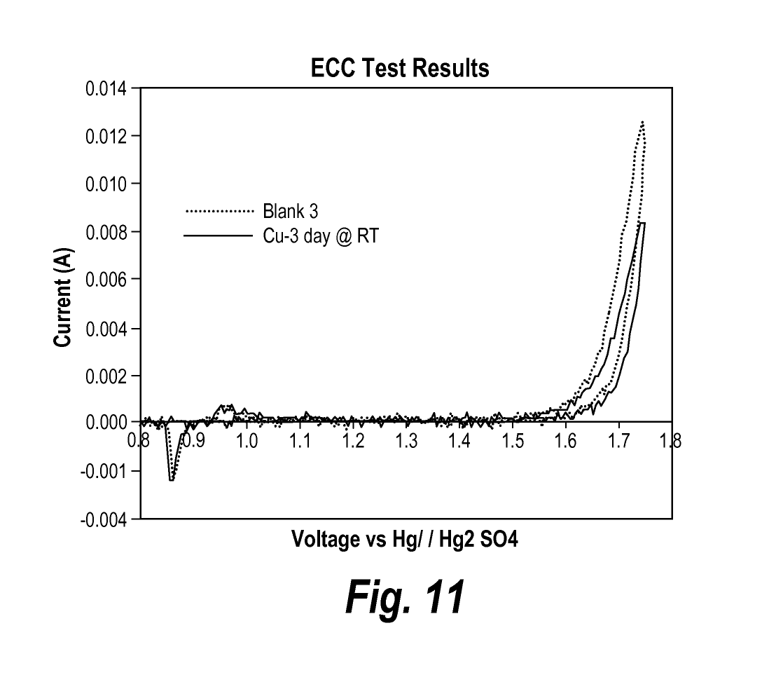

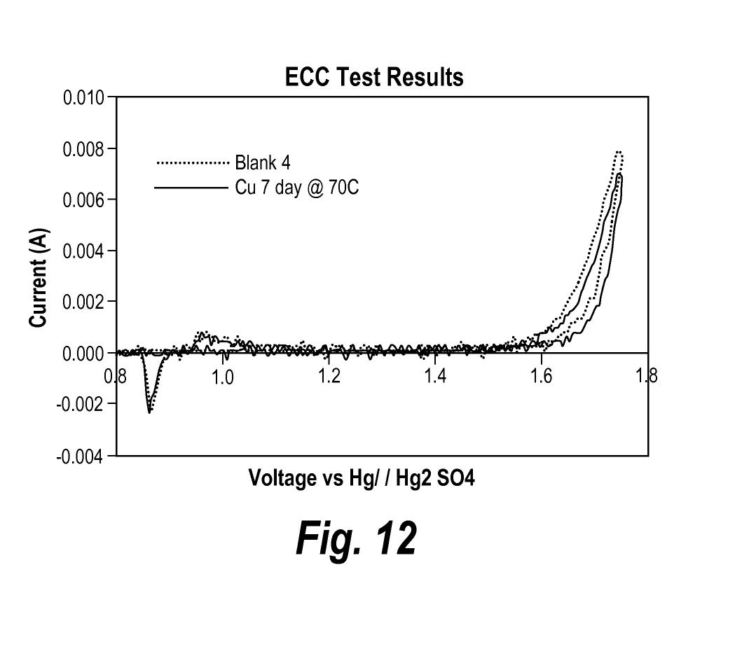

As shown in FIG. 5 and FIG. 9-FIG. 12, which are discussed in more detail in the Examples, the addition of particles (or other delivery methods) that are able to leach metal ions into the electrolyte results in a battery that begins producing hydrogen from the negative electrode at a higher voltage. These batteries are therefore more efficient and safer during recharge. The resulting difference in voltage is called the “hydrogen shift” herein.

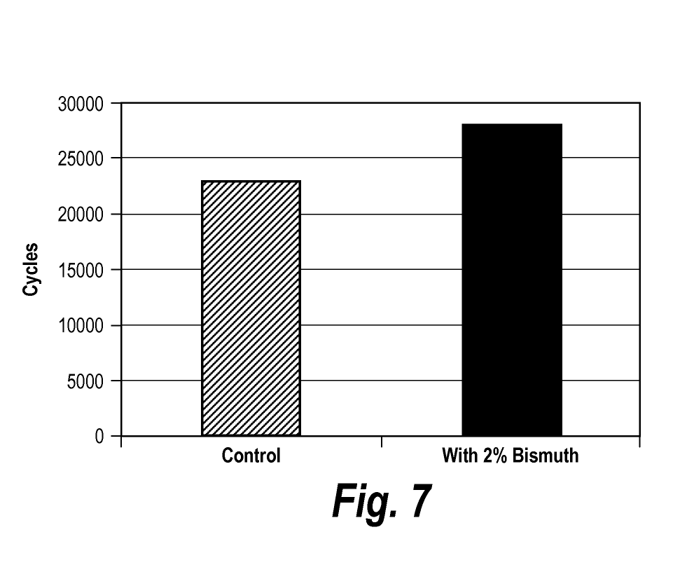

The delay in the rise of the negative electrode potential has several positive attributes for battery operation. First, as shown in FIG. 6, it allows higher positive electrode potential for good cycling performance. Second it reduces hydrogen gassing to reduce water loss and resulting improvements in battery life (see FIG. 7). Third it delays the onset of tapering current once the voltage lid is obtained, enabling higher charge input. The latter is influential in partial state of charge (“PSOC”) cycling applications employing sudden burst of current flow where high absorbance of this charge enables a higher level of battery state of charge and improves system operation efficiency (see FIG. 6)

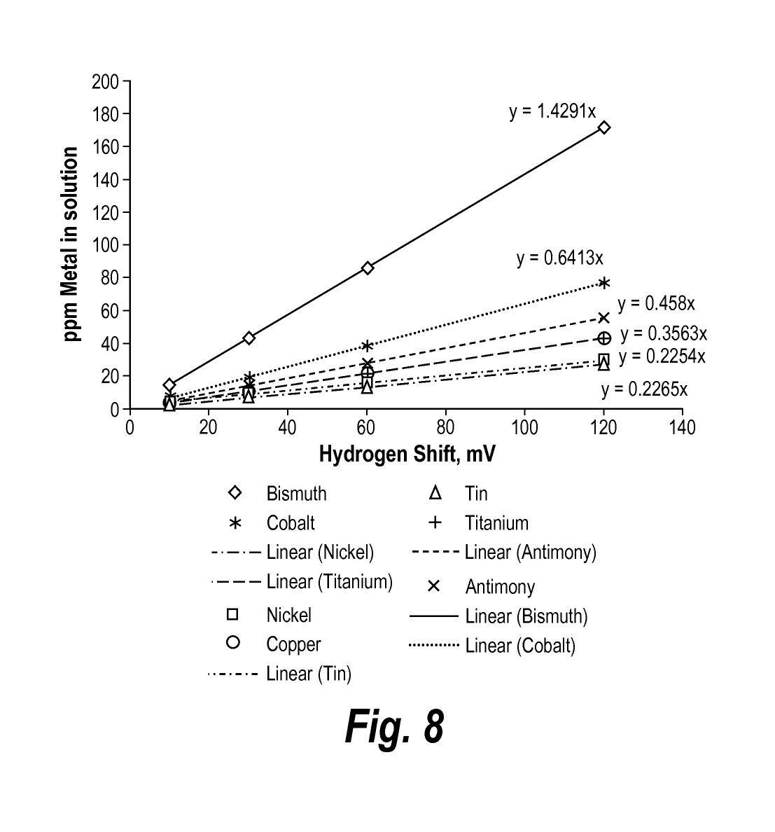

In certain embodiments, metal ions other than bismuth produce a similar effect on the negative electrode potential during recharge. Suitable metal ions can be selected by comparison of electrochemical potentials as discussed below. Metals near the potential of lead or greater than lead have the ability to shift the electrochemical balance by lowering the charging potential of the lead electrode. Metal ions with high positive electrochemical potentials (e.g., Sb, W, and Pt) more effectively discharge the negative active material, however, too high of a concentration of these ions, or any ions, can be detrimental to battery performance. In contrast, addition of metals with similar electrochemical potential as lead (i.e., −0.36V vs. H₂) allows the negative electrode charging potential to be shifted slightly to delay hydrogen gassing without adverse effects. FIG. 8 shows an example of how the concentration of different metal ions in the electrolyte solution affects the hydrogen shift, with higher concentrations producing a larger hydrogen shift.

### 3. Target Metal Ion Concentrations

For several metal ions, we have determined amounts of metal ions that produce a desirable shift in the hydrogen production when added to a defined electrolyte without adversely affecting battery performance. In particular, we have found that too low of an amount fails to produce an effect on hydrogen production while too high of an amount can be detrimental to battery performance. We have also determined that the desirable ranges vary quite significantly between different metal ions.

In order to normalize the amounts of metal ion needed across different cell types (in particular cells that have different electrolyte volumes or electrolyte densities) we refer more generally herein to a value that we call the “target concentration” of metal ion. This “target concentration” of metal ion (X, in parts per million or ppm) can be calculated according to this equation:

X=Y/(D*V) Eqn. 12

where Y is the target amount of metal ion (in mg) that needs to be added (leached) over time into the electrolyte in order to achieve the desired hydrogen shift, D is the electrolyte density (in g/cm³) and V is the electrolyte volume (in liters). As noted below, the calculations and values provided herein used a “reference cell” that includes 1 liter of 1.3 g/ml electrolyte so that Equation 12 becomes:

X=Y/1.3 Eqn. 13

For example, if 18.6 mg bismuth needs to be added into a “reference cell” in order to achieve a 10 mV hydrogen shift then this would correspond to a “target concentration” of bismuth of 14.3 ppm (where 14.3=18.6/1.3). In practice, the actual concentration of bismuth that might be observed in the electrolyte of a lead-acid battery that is set up to leach 18.6 mg bismuth into the electrolyte would not reach 14.3 ppm because the bismuth ions are removed from the electrolyte as a result of absorption and/or electrochemical reactions that lead to the desired electrochemical shift. It will therefore be appreciated from the foregoing that, as used herein, the term “target concentration” of metal ion does not correspond to an actual metal ion concentration that will be observed in the electrolyte of a lead-acid battery. Instead it provides a normalized measure of the amount of metal ion that needs to be added (leached) over time into an electrolyte (e.g., a “reference cell”) in order to achieve a desired hydrogen shift.

Conversely, if a battery component includes a known amount of available metal ion and the volume and density of the electrolyte are also known one can readily calculate the corresponding “target concentration” for that battery component and electrolyte according to Equation 12. For example, a battery component that includes 18.6 mg bismuth ion that is 100% available would have a corresponding bismuth ion “target concentration” of 14.3 ppm in 1 liter of 1.3 g/ml sulfuric acid. Similarly, a battery component that includes 37.2 mg bismuth ion that is 50% available (i.e., only 18.6 mg of the 37.2 mg bismuth ion present will reach the electrolyte) would also have a corresponding bismuth ion “target concentration” of 14.3 ppm in 1 liter of 1.3 g/ml sulfuric acid. Determining availability of metal ion sources in different situations is discussed in more detail below.

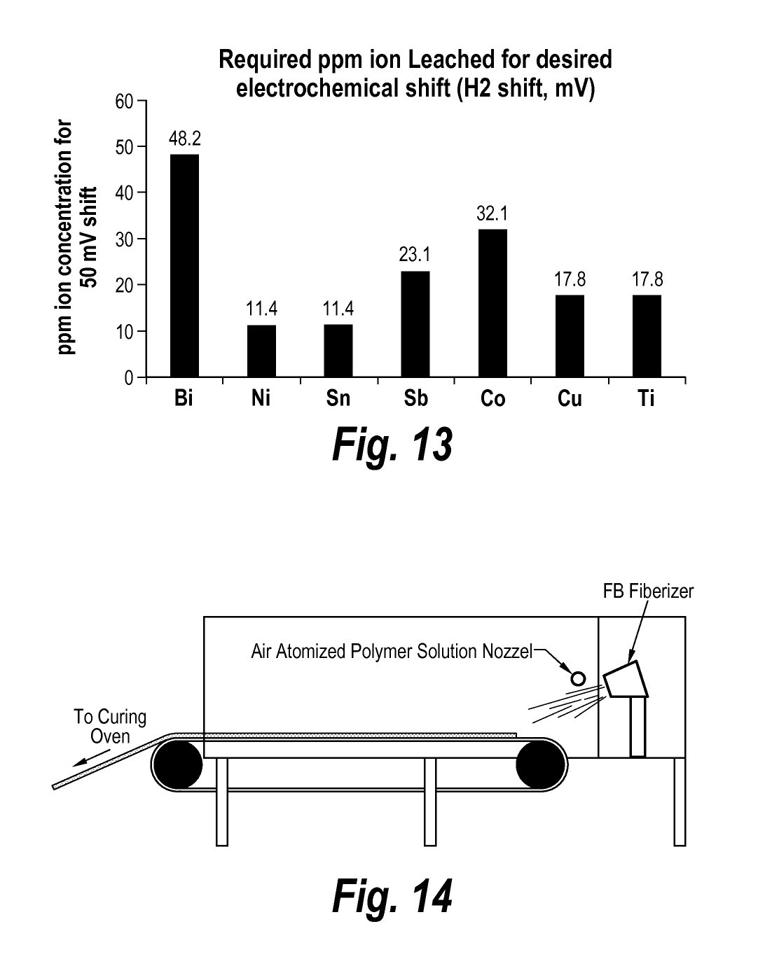

As noted above, for several metal ions, we have determined target concentrations (and therefore target amounts for a given electrolyte volume and density) of metal ions that produce a desirable shift in the hydrogen production when added to the electrolyte. We have also determined that the desirable ranges vary quite significantly between different metal ions. For example, we have found that for certain embodiments, the target concentration of metal ion that produces a 50 mV increase in the voltage at which hydrogen is produced are as follows: bismuth at about 71.5 ppm, nickel at about 11.4 ppm, tin at about 11.4 ppm, antimony at about 22.9 ppm, cobalt at about 32.1 ppm, copper at about 17.9 ppm and titanium at about 17.9 ppm (see FIG. 13).

It will be appreciated that the desired electrochemical effect need not be a 50 mV shift in hydrogen production, but can be any desired shift. The desired electrochemical effect can be a shift in the voltage at which hydrogen is produced, as compared to an otherwise identical control that does not contain the leachable metal ions. In some embodiments the desired hydrogen shift can be from about 10 mV to about 120 mV. In some embodiments, the desired hydrogen shift can be from about 10 mV to about 20 mV, from about 10 mV to about 30 mV, from about 10 mV to about 60 mV, from about 10 mV to about 120 mV, from about 20 mV to about 30 mV, from about 25 mV to about 50 mV, from about 30 mV to about 40 mV, from about 30 mV to about 60 mV, from about 30 mV to about 90 mV, from about 30 mV to about 120 mV, from about 40 mV to about 50 mV, from about 40 mV to about 60 mV, from about 50 mV to about 60 mV, from about 50 mV to about 75 mV, from about 60 mV to about 120 mV, from about 75 mV to about 100 mV. In some embodiments the desired shift can be at least about 10 mV, at least about 20 mV, at least about 25 mV, at least about 30 mV, at least about 40 mV, at least about 50 mV, at least about 75 mV, at least about 100 mV, at least about 110 mV. In some embodiments, the desired shift can be at most about 120 mV, at most about 100 mV, at most about 75 mV, at most about 50 mV, at most about 40 mV, at most about 30 mV, at most about 25 mV, at most about 20 mV or at most about 10 mV.

As the desired electrochemical effect changes so too does the target concentration of metal ions in the electrolyte. From leaching data and electrochemical tests, we have determined that the degree of hydrogen shift (in mV) can be expressed as a function of target metal ion concentration in the electrolyte. The correlations for each metal ion that we tested are as follows: bismuth 0.7 mV/ppm; nickel 4.4 mV/ppm; tin 4.4 mV/ppm; antimony 2.2 mV/ppm; cobalt 1.6 mV/ppm; copper 2.8 mV/ppm and titanium 2.8 mV/ppm. Applying these correlations to potentially desired hydrogen production shifts yields the data in Table 1 below:

TABLE 1
Target metal ion concentrations for various metal ions to obtain various hydrogen shifts

| | Hydrogen Shift (mV) | | | | | | | | | | | |
|---|---|---|---|---|---|---|---|---|---|---|---|---|
| Metal Ion | 10 | 20 | 30 | 40 | 50 | 60 | 70 | 80 | 90 | 100 | 110 | 120 |
| Bi (ppm) | 14.3 | 28.6 | 42.9 | 57.2 | 71.5 | 85.8 | 100 | 114 | 129 | 143 | 157 | 172 |
| Ni (ppm) | 2.3 | 4.6 | 6.8 | 9.1 | 11.4 | 13.6 | 15.9 | 18.2 | 20.4 | 22.7 | 25 | 27.2 |
| Sn (ppm) | 2.3 | 4.6 | 6.8 | 9.1 | 11.4 | 13.6 | 15.9 | 18.2 | 20.4 | 22.7 | 25 | 27.2 |
| Sb (ppm) | 4.6 | 9.2 | 13.8 | 18.4 | 22.9 | 27.6 | 32.1 | 36.7 | 41.3 | 45.9 | 50.5 | 55.1 |
| Co (ppm) | 6.4 | 12.9 | 19.3 | 25.7 | 32.1 | 38.6 | 45 | 51.4 | 57.8 | 64.3 | 70.7 | 77.1 |
| Cu (ppm) | 3.6 | 7.1 | 10.7 | 14.3 | 17.9 | 21.4 | 25 | 28.5 | 32.1 | 35.7 | 39.3 | 42.9 |
| Ti (ppm) | 3.6 | 7.1 | 10.7 | 14.3 | 17.9 | 21.4 | 25 | 28.5 | 32.1 | 35.7 | 39.3 | 42.9 |

In some embodiments, the target concentration of metal ions in the electrolyte is in the range of from about 1.9 ppm to about 193 ppm. In some embodiments, the target concentration can be in a range from about 1.9 ppm to about 6.4 ppm, from about 3.2 ppm to about 16.1 ppm, from about 6.4 ppm to about 32.1 ppm, from about 16.1 ppm to about 48.2 ppm, from about 32.1 ppm to about 64.3 ppm, from about 32.1 ppm to about 129 ppm, from about 64.3 ppm to about 96.4 ppm from about 64.3 ppm to about 129 ppm, from about 96.4 ppm to about 129 ppm, from about 96.4 ppm to about 161 ppm, or from about 161 ppm to about 193 ppm. In some embodiments, the target concentration is at least about 6.4 ppm, at least about 16.1 ppm, at least about 32.1 ppm, at least about 48.2 ppm, at least about 64.3 ppm, at least about 129 ppm, or at least about 161 ppm. In some embodiments, the target concentration is at most about 193 ppm, at most about 161 ppm, at most about 129 ppm, at most about 64.3 ppm, at most about 48.2 ppm, at most about 32.1 ppm, at most about 16.1 ppm.

It will be appreciated that in order to achieve a given hydrogen shift, one can use a single metal ion source (e.g., 85.8 ppm bismuth for a 60 mV shift) or more than one metal ion source (e.g., 42.9 ppm bismuth and 6.8 ppm nickel for a 60 mV shift). It will also be appreciated that, the amount of metal ion added to the electrolyte may come from a single battery component (e.g., all from metal oxide in a resin coating on a separator) or from more than one battery component (e.g., a portion from metal oxide in a resin coating on a separator and another portion from metal oxide in a resin coating on the battery case).

In some embodiments, the target concentration of bismuth ion in the electrolyte is in the range from about 14.3 ppm to about 172 ppm, from about 14.3 ppm to about 28.6 ppm, from about 14.3 ppm to about 42.9 ppm, from about 14.3 ppm to about 57.2 ppm, from about 14.3 ppm to about 71.5 ppm, from about 14.3 ppm to about 85.8 ppm, from about 14.3 ppm to about 100 ppm, from about 14.3 ppm to about 114 ppm, from about 14.3 ppm to about 129 ppm, from about 14.3 ppm to about 143 ppm, from about 14.3 ppm to about 157 ppm, from about 28.6 ppm to about 42.9 ppm, from about 28.6 ppm to about 57.2 ppm, from about 28.6 ppm to about 71.5 ppm, from about 28.6 ppm to about 85.8 ppm, from about 28.6 ppm to about 100 ppm, from about 28.6 ppm to about 114 ppm, from about 28.6 ppm to about 129 ppm, from about 28.6 ppm to about 143 ppm, from about 28.6 ppm to about 157 ppm, from about 28.6 ppm to about 172 ppm, from about 42.9 ppm to about 57.2 ppm, from about 42.9 ppm to about 71.5 ppm, from about 42.9 ppm to about 85.8 ppm, from about 42.9 ppm to about 100 ppm, from about 42.9 ppm to about 114 ppm, from about 42.9 ppm to about 129 ppm, from about 42.9 ppm to about 143 ppm, from about 42.9 ppm to about 157 ppm, from about 42.9 ppm to about 172 ppm, from about 57.2 ppm to about 71.5 ppm, from about 57.2 ppm to about 85.8 ppm, from about 57.2 ppm to about 100 ppm, from about 57.2 ppm to about 114 ppm, from about 57.2 ppm to about 129 ppm, from about 57.2 ppm to about 143 ppm, from about 57.2 ppm to about 157 ppm, from about 57.2 ppm to about 172 ppm, from about 71.5 ppm to about 85.8 ppm, from about 71.5 ppm to about 100 ppm, from about 71.5 ppm to about 114 ppm, from about 71.5 ppm to about 129 ppm, from about 71.5 ppm to about 143 ppm, from about 71.5 ppm to about 157 ppm, from about 71.5 ppm to about 172 ppm, from about 85.8 ppm to about 100 ppm, from about 85.8 ppm to about 114 ppm, from about 85.8 ppm to about 129 ppm, from about 85.8 ppm to about 143 ppm, from about 85.8 ppm to about 157 ppm, from about 85.8 ppm to about 172 ppm, from about 100 ppm to about 114 ppm, from about 100 ppm to about 129 ppm, from about 100 ppm to about 143 ppm, from about 100 ppm to about 157 ppm, from about 100 ppm to about 172 ppm, from about 114 ppm to about 129 ppm, from about 114 ppm to about 143 ppm, from about 114 ppm to about 157 ppm, from about 114 ppm to about 172 ppm, from about 129 ppm to about 143 ppm, from about 129 ppm to about 157 ppm, from about 129 ppm to about 172 ppm, from about 143 ppm to about 157 ppm, from about 143 ppm to about 172 ppm, from about 157 ppm to about 172 ppm.

In some embodiments, the target concentration of nickel ion in the electrolyte is in the range from about 2.3 ppm to about 27.2 ppm, from about 2.3 ppm to about 4.6 ppm, from about 2.3 ppm to about 6.8 ppm, from about 2.3 ppm to about 9.1 ppm, from about 2.3 ppm to about 11.4 ppm, from about 2.3 ppm to about 13.6 ppm, from about 2.3 ppm to about 15.9 ppm, from about 2.3 ppm to about 18.2 ppm, from about 2.3 ppm to about 20.4 ppm, from about 2.3 ppm to about 22.7 ppm, from about 2.3 ppm to about 25 ppm, from about 4.6 ppm to about 6.8 ppm, from about 4.6 ppm to about 9.1 ppm, from about 4.6 ppm to about 11.4 ppm, from about 4.6 ppm to about 13.6 ppm, from about 4.6 ppm to about 15.9 ppm, from about 4.6 ppm to about 18.2 ppm, from about 4.6 ppm to about 20.4 ppm, from about 4.6 ppm to about 22.7 ppm, from about 4.6 ppm to about 25 ppm, from about 4.6 ppm to about 27.2 ppm, from about 6.8 ppm to about 9.1 ppm, from about 6.8 ppm to about 11.4 ppm, from about 6.8 ppm to about 13.6 ppm, from about 6.8 ppm to about 15.9 ppm, from about 6.8 ppm to about 18.2 ppm, from about 6.8 ppm to about 20.4 ppm, from about 6.8 ppm to about 22.7 ppm, from about 6.8 ppm to about 25 ppm, from about 6.8 ppm to about 27.2 ppm, from about 9.1 ppm to about 11.4 ppm, from about 9.1 ppm to about 13.6 ppm, from about 9.1 ppm to about 15.9 ppm, from about 9.1 ppm to about 18.2 ppm, from about 9.1 ppm to about 20.4 ppm, from about 9.1 ppm to about 22.7 ppm, from about 9.1 ppm to about 25 ppm, from about 9.1 ppm to about 27.2 ppm, from about 11.4 ppm to about 13.6 ppm, from about 11.4 ppm to about 15.9 ppm, from about 11.4 ppm to about 18.2 ppm, from about 11.4 ppm to about 20.4 ppm, from about 11.4 ppm to about 22.7 ppm, from about 11.4 ppm to about 25 ppm, from about 11.4 ppm to about 27.2 ppm, from about 13.6 ppm to about 15.9 ppm, from about 13.6 ppm to about 18.2 ppm, from about 13.6 ppm to about 20.4 ppm, from about 13.6 ppm to about 22.7 ppm, from about 13.6 ppm to about 25 ppm, from about 13.6 ppm to about 27.2 ppm, from about 15.9 ppm to about 18.2 ppm, from about 15.9 ppm to about 20.4 ppm, from about 15.9 ppm to about 22.7 ppm, from about 15.9 ppm to about 25 ppm, from about 15.9 ppm to about 27.2 ppm, from about 18.2 ppm to about 20.4 ppm, from about 18.2 ppm to about 22.7 ppm, from about 18.2 ppm to about 25 ppm, from about 18.2 ppm to about 27.2 ppm, from about 20.4 ppm to about 22.7 ppm, from about 20.4 ppm to about 25 ppm, from about 20.4 ppm to about 27.2 ppm, from about 22.7 ppm to about 25 ppm, from about 22.7 ppm to about 27.2 ppm, from about 25 ppm to about 27.2 ppm.

In some embodiments, the target concentration of tin ion in the electrolyte is in the range from about 2.3 ppm to about 27.2 ppm, from about 2.3 ppm to about 4.6 ppm, from about 2.3 ppm to about 6.8 ppm, from about 2.3 ppm to about 9.1 ppm, from about 2.3 ppm to about 11.4 ppm, from about 2.3 ppm to about 13.6 ppm, from about 2.3 ppm to about 15.9 ppm, from about 2.3 ppm to about 18.2 ppm, from about 2.3 ppm to about 20.4 ppm, from about 2.3 ppm to about 22.7 ppm, from about 2.3 ppm to about 25 ppm, from about 4.6 ppm to about 6.8 ppm, from about 4.6 ppm to about 9.1 ppm, from about 4.6 ppm to about 11.4 ppm, from about 4.6 ppm to about 13.6 ppm, from about 4.6 ppm to about 15.9 ppm, from about 4.6 ppm to about 18.2 ppm, from about 4.6 ppm to about 20.4 ppm, from about 4.6 ppm to about 22.7 ppm, from about 4.6 ppm to about 25 ppm, from about 4.6 ppm to about 27.2 ppm, from about 6.8 ppm to about 9.1 ppm, from about 6.8 ppm to about 11.4 ppm, from about 6.8 ppm to about 13.6 ppm, from about 6.8 ppm to about 15.9 ppm, from about 6.8 ppm to about 18.2 ppm, from about 6.8 ppm to about 20.4 ppm, from about 6.8 ppm to about 22.7 ppm, from about 6.8 ppm to about 25 ppm, from about 6.8 ppm to about 27.2 ppm, from about 9.1 ppm to about 11.4 ppm, from about 9.1 ppm to about 13.6 ppm, from about 9.1 ppm to about 15.9 ppm, from about 9.1 ppm to about 18.2 ppm, from about 9.1 ppm to about 20.4 ppm, from about 9.1 ppm to about 22.7 ppm, from about 9.1 ppm to about 25 ppm, from about 9.1 ppm to about 27.2 ppm, from about 11.4 ppm to about 13.6 ppm, from about 11.4 ppm to about 15.9 ppm, from about 11.4 ppm to about 18.2 ppm, from about 11.4 ppm to about 20.4 ppm, from about 11.4 ppm to about 22.7 ppm, from about 11.4 ppm to about 25 ppm, from about 11.4 ppm to about 27.2 ppm, from about 13.6 ppm to about 15.9 ppm, from about 13.6 ppm to about 18.2 ppm, from about 13.6 ppm to about 20.4 ppm, from about 13.6 ppm to about 22.7 ppm, from about 13.6 ppm to about 25 ppm, from about 13.6 ppm to about 27.2 ppm, from about 15.9 ppm to about 18.2 ppm, from about 15.9 ppm to about 20.4 ppm, from about 15.9 ppm to about 22.7 ppm, from about 15.9 ppm to about 25 ppm, from about 15.9 ppm to about 27.2 ppm, from about 18.2 ppm to about 20.4 ppm, from about 18.2 ppm to about 22.7 ppm, from about 18.2 ppm to about 25 ppm, from about 18.2 ppm to about 27.2 ppm, from about 20.4 ppm to about 22.7 ppm, from about 20.4 ppm to about 25 ppm, from about 20.4 ppm to about 27.2 ppm, from about 22.7 ppm to about 25 ppm, from about 22.7 ppm to about 27.2 ppm, from about 25 ppm to about 27.2 ppm.

In some embodiments, the target concentration of antimony ion in the electrolyte is in the range from about 4.6 ppm to about 55.1 ppm, from about 4.6 ppm to about 9.2 ppm, from about 4.6 ppm to about 13.8 ppm, from about 4.6 ppm to about 18.4 ppm, from about 4.6 ppm to about 22.9 ppm, from about 4.6 ppm to about 27.6 ppm, from about 4.6 ppm to about 32.1 ppm, from about 4.6 ppm to about 36.7 ppm, from about 4.6 ppm to about 41.3 ppm, from about 4.6 ppm to about 45.9 ppm, from about 4.6 ppm to about 50.5 ppm, from about 9.2 ppm to about 13.8 ppm, from about 9.2 ppm to about 18.4 ppm, from about 9.2 ppm to about 22.9 ppm, from about 9.2 ppm to about 27.6 ppm, from about 9.2 ppm to about 32.1 ppm, from about 9.2 ppm to about 36.7 ppm, from about 9.2 ppm to about 41.3 ppm, from about 9.2 ppm to about 45.9 ppm, from about 9.2 ppm to about 50.5 ppm, from about 9.2 ppm to about 55.1 ppm, from about 13.8 ppm to about 18.4 ppm, from about 13.8 ppm to about 22.9 ppm, from about 13.8 ppm to about 27.6 ppm, from about 13.8 ppm to about 32.1 ppm, from about 13.8 ppm to about 36.7 ppm, from about 13.8 ppm to about 41.3 ppm, from about 13.8 ppm to about 45.9 ppm, from about 13.8 ppm to about 50.5 ppm, from about 13.8 ppm to about 55.1 ppm, from about 18.4 ppm to about 22.9 ppm, from about 18.4 ppm to about 27.6 ppm, from about 18.4 ppm to about 32.1 ppm, from about 18.4 ppm to about 36.7 ppm, from about 18.4 ppm to about 41.3 ppm, from about 18.4 ppm to about 45.9 ppm, from about 18.4 ppm to about 50.5 ppm, from about 18.4 ppm to about 55.1 ppm, from about 22.9 ppm to about 27.6 ppm, from about 22.9 ppm to about 32.1 ppm, from about 22.9 ppm to about 36.7 ppm, from about 22.9 ppm to about 41.3 ppm, from about 22.9 ppm to about 45.9 ppm, from about 22.9 ppm to about 50.5 ppm, from about 22.9 ppm to about 55.1 ppm, from about 27.6 ppm to about 32.1 ppm, from about 27.6 ppm to about 36.7 ppm, from about 27.6 ppm to about 41.3 ppm, from about 27.6 ppm to about 45.9 ppm, from about 27.6 ppm to about 50.5 ppm, from about 27.6 ppm to about 55.1 ppm, from about 32.1 ppm to about 36.7 ppm, from about 32.1 ppm to about 41.3 ppm, from about 32.1 ppm to about 45.9 ppm, from about 32.1 ppm to about 50.5 ppm, from about 32.1 ppm to about 55.1 ppm, from about 36.7 ppm to about 41.3 ppm, from about 36.7 ppm to about 45.9 ppm, from about 36.7 ppm to about 50.5 ppm, from about 36.7 ppm to about 55.1 ppm, from about 41.3 ppm to about 45.9 ppm, from about 41.3 ppm to about 50.5 ppm, from about 41.3 ppm to about 55.1 ppm, from about 45.9 ppm to about 50.5 ppm, from about 45.9 ppm to about 55.1 ppm, from about 50.5 ppm to about 55.1 ppm.

In some embodiments, the target concentration of cobalt ion in the electrolyte is in the range from about 6.4 ppm to about 77.1 ppm, from about 6.4 ppm to about 12.9 ppm, from about 6.4 ppm to about 19.3 ppm, from about 6.4 ppm to about 25.7 ppm, from about 6.4 ppm to about 32.1 ppm, from about 6.4 ppm to about 38.6 ppm, from about 6.4 ppm to about 45.0 ppm, from about 6.4 ppm to about 51.4 ppm, from about 6.4 ppm to about 57.8 ppm, from about 6.4 ppm to about 64.3 ppm, from about 6.4 ppm to about 70.7 ppm, from about 12.9 ppm to about 19.3 ppm, from about 12.9 ppm to about 25.7 ppm, from about 12.9 ppm to about 32.1 ppm, from about 12.9 ppm to about 38.6 ppm, from about 12.9 ppm to about 45.0 ppm, from about 12.9 ppm to about 51.4 ppm, from about 12.9 ppm to about 57.8 ppm, from about 12.9 ppm to about 64.3 ppm, from about 12.9 ppm to about 70.7 ppm, from about 12.9 ppm to about 77.1 ppm, from about 19.3 ppm to about 25.7 ppm, from about 19.3 ppm to about 32.1 ppm, from about 19.3 ppm to about 38.6 ppm, from about 19.3 ppm to about 45.0 ppm, from about 19.3 ppm to about 51.4 ppm, from about 19.3 ppm to about 57.8 ppm, from about 19.3 ppm to about 64.3 ppm, from about 19.3 ppm to about 70.7 ppm, from about 19.3 ppm to about 77.1 ppm, from about 25.7 ppm to about 32.1 ppm, from about 25.7 ppm to about 38.6 ppm, from about 25.7 ppm to about 45.0 ppm, from about 25.7 ppm to about 51.4 ppm, from about 25.7 ppm to about 57.8 ppm, from about 25.7 ppm to about 64.3 ppm, from about 25.7 ppm to about 70.7 ppm, from about 25.7 ppm to about 77.1 ppm, from about 32.1 ppm to about 38.6 ppm, from about 32.1 ppm to about 45.0 ppm, from about 32.1 ppm to about 51.4 ppm, from about 32.1 ppm to about 57.8 ppm, from about 32.1 ppm to about 64.3 ppm, from about 32.1 ppm to about 70.7 ppm, from about 32.1 ppm to about 77.1 ppm, from about 38.6 ppm to about 45.0 ppm, from about 38.6 ppm to about 51.4 ppm, from about 38.6 ppm to about 57.8 ppm, from about 38.6 ppm to about 64.3 ppm, from about 38.6 ppm to about 70.7 ppm, from about 38.6 ppm to about 77.1 ppm, from about 45.0 ppm to about 51.4 ppm, from about 45.0 ppm to about 57.8 ppm, from about 45.0 ppm to about 64.3 ppm, from about 45.0 ppm to about 70.7 ppm, from about 45.0 ppm to about 77.1 ppm, from about 51.4 ppm to about 57.8 ppm, from about 51.4 ppm to about 64.3 ppm, from about 51.4 ppm to about 70.7 ppm, from about 51.4 ppm to about 77.1 ppm, from about 57.8 ppm to about 64.3 ppm, from about 57.8 ppm to about 70.7 ppm, from about 57.8 ppm to about 77.1 ppm, from about 64.3 ppm to about 70.7 ppm, from about 64.3 ppm to about 77.1 ppm, from about 70.7 ppm to about 77.1 ppm.

In some embodiments, the target concentration of copper ion in the electrolyte is in the range from about 3.6 ppm to about 42.9 ppm, from about 3.6 ppm to about 7.1 ppm, from about 3.6 ppm to about 10.7 ppm, from about 3.6 ppm to about 14.3 ppm, from about 3.6 ppm to about 17.9 ppm, from about 3.6 ppm to about 21.4 ppm, from about 3.6 ppm to about 25 ppm, from about 3.6 ppm to about 28.5 ppm, from about 3.6 ppm to about 32.1 ppm, from about 3.6 ppm to about 35.7 ppm, from about 3.6 ppm to about 39.3 ppm, from about 7.1 ppm to about 10.7 ppm, from about 7.1 ppm to about 14.3 ppm, from about 7.1 ppm to about 17.9 ppm, from about 7.1 ppm to about 21.4 ppm, from about 7.1 ppm to about 25 ppm, from about 7.1 ppm to about 28.5 ppm, from about 7.1 ppm to about 32.1 ppm, from about 7.1 ppm to about 35.7 ppm, from about 7.1 ppm to about 39.3 ppm, from about 7.1 ppm to about 42.9 ppm, from about 10.7 ppm to about 14.3 ppm, from about 10.7 ppm to about 17.9 ppm, from about 10.7 ppm to about 21.4 ppm, from about 10.7 ppm to about 25 ppm, from about 10.7 ppm to about 28.5 ppm, from about 10.7 ppm to about 32.1 ppm, from about 10.7 ppm to about 35.7 ppm, from about 10.7 ppm to about 39.3 ppm, from about 10.7 ppm to about 42.9 ppm, from about 14.3 ppm to about 17.9 ppm, from about 14.3 ppm to about 21.4 ppm, from about 14.3 ppm to about 25 ppm, from about 14.3 ppm to about 28.5 ppm, from about 14.3 ppm to about 32.1 ppm, from about 14.3 ppm to about 35.7 ppm, from about 14.3 ppm to about 39.3 ppm, from about 14.3 ppm to about 42.9 ppm, from about 17.9 ppm to about 21.4 ppm, from about 17.9 ppm to about 25 ppm, from about 17.9 ppm to about 28.5 ppm, from about 17.9 ppm to about 32.1 ppm, from about 17.9 ppm to about 35.7 ppm, from about 17.9 ppm to about 39.3 ppm, from about 17.9 ppm to about 42.9 ppm, from about 21.4 ppm to about 25 ppm, from about 21.4 ppm to about 28.5 ppm, from about 21.4 ppm to about 32.1 ppm, from about 21.4 ppm to about 35.7 ppm, from about 21.4 ppm to about 39.3 ppm, from about 21.4 ppm to about 42.9 ppm, from about 25 ppm to about 28.5 ppm, from about 25 ppm to about 32.1 ppm, from about 25 ppm to about 35.7 ppm, from about 25 ppm to about 39.3 ppm, from about 25 ppm to about 42.9 ppm, from about 28.5 ppm to about 32.1 ppm, from about 28.5 ppm to about 35.7 ppm, from about 28.5 ppm to about 39.3 ppm, from about 28.5 ppm to about 42.9 ppm, from about 32.1 ppm to about 35.7 ppm, from about 32.1 ppm to about 39.3 ppm, from about 32.1 ppm to about 42.9 ppm, from about 35.7 ppm to about 39.3 ppm, from about 35.7 ppm to about 42.9 ppm, from about 39.3 ppm to about 42.9 ppm.

In some embodiments, the target concentration of titanium ion in the electrolyte is in the range from about 3.6 ppm to about 42.9 ppm, from about 3.6 ppm to about 7.1 ppm, from about 3.6 ppm to about 10.7 ppm, from about 3.6 ppm to about 14.3 ppm, from about 3.6 ppm to about 17.9 ppm, from about 3.6 ppm to about 21.4 ppm, from about 3.6 ppm to about 25 ppm, from about 3.6 ppm to about 28.5 ppm, from about 3.6 ppm to about 32.1 ppm, from about 3.6 ppm to about 35.7 ppm, from about 3.6 ppm to about 39.3 ppm, from about 7.1 ppm to about 10.7 ppm, from about 7.1 ppm to about 14.3 ppm, from about 7.1 ppm to about 17.9 ppm, from about 7.1 ppm to about 21.4 ppm, from about 7.1 ppm to about 25 ppm, from about 7.1 ppm to about 28.5 ppm, from about 7.1 ppm to about 32.1 ppm, from about 7.1 ppm to about 35.7 ppm, from about 7.1 ppm to about 39.3 ppm, from about 7.1 ppm to about 42.9 ppm, from about 10.7 ppm to about 14.3 ppm, from about 10.7 ppm to about 17.9 ppm, from about 10.7 ppm to about 21.4 ppm, from about 10.7 ppm to about 25 ppm, from about 10.7 ppm to about 28.5 ppm, from about 10.7 ppm to about 32.1 ppm, from about 10.7 ppm to about 35.7 ppm, from about 10.7 ppm to about 39.3 ppm, from about 10.7 ppm to about 42.9 ppm, from about 14.3 ppm to about 17.9 ppm, from about 14.3 ppm to about 21.4 ppm, from about 14.3 ppm to about 25 ppm, from about 14.3 ppm to about 28.5 ppm, from about 14.3 ppm to about 32.1 ppm, from about 14.3 ppm to about 35.7 ppm, from about 14.3 ppm to about 39.3 ppm, from about 14.3 ppm to about 42.9 ppm, from about 17.9 ppm to about 21.4 ppm, from about 17.9 ppm to about 25 ppm, from about 17.9 ppm to about 28.5 ppm, from about 17.9 ppm to about 32.1 ppm, from about 17.9 ppm to about 35.7 ppm, from about 17.9 ppm to about 39.3 ppm, from about 17.9 ppm to about 42.9 ppm, from about 21.4 ppm to about 25 ppm, from about 21.4 ppm to about 28.5 ppm, from about 21.4 ppm to about 32.1 ppm, from about 21.4 ppm to about 35.7 ppm, from about 21.4 ppm to about 39.3 ppm, from about 21.4 ppm to about 42.9 ppm, from about 25 ppm to about 28.5 ppm, from about 25 ppm to about 32.1 ppm, from about 25 ppm to about 35.7 ppm, from about 25 ppm to about 39.3 ppm, from about 25 ppm to about 42.9 ppm, from about 28.5 ppm to about 32.1 ppm, from about 28.5 ppm to about 35.7 ppm, from about 28.5 ppm to about 39.3 ppm, from about 28.5 ppm to about 42.9 ppm, from about 32.1 ppm to about 35.7 ppm, from about 32.1 ppm to about 39.3 ppm, from about 32.1 ppm to about 42.9 ppm, from about 35.7 ppm to about 39.3 ppm, from about 35.7 ppm to about 42.9 ppm, from about 39.3 ppm to about 42.9 ppm.

### 4. Availability of Metal Ion Source

In the following sections we describe various approaches for providing metal ions to a battery electrolyte. For each approach we also provide exemplary amounts of metal ion source that will yield the aforementioned target metal ion concentrations in the battery electrolyte. In certain embodiments, the amount of metal ion source required will depend in part on the location and accessibility of the metal ion source (e.g., a metal ion source that is coated on the surface of a battery component will be more accessible to the electrolyte than a metal ion source that is embedded within a battery component such as a resin filled separator). A convenient term to use when describing metal ion sources that are not readily accessible to the electrolyte is “availability” which provides a measure of whether the full amount of metal ion is free (available) to leach into the electrolyte. “Availability” of a metal ion source is a factor of the materials of construction of the relevant battery component and its physical dimensions. Availability influences the amount of metal ion source (e.g., metal oxides) necessary for the desired electrochemical effect and must be factored to leach the appropriate amount of metal ions into the electrolyte.

In certain embodiments, availability may be measured by empirical methods. Typically this might involve adding a known amount of metal ion source (e.g., metal oxide) to the test material (e.g., in a resin coating on a separator) and then subjecting the test material to a leaching test using the electrolyte of interest. The results of the leaching test would then be used to determine the percentage of metal ion present in the test material that was leached. For example, if the test material was known to include 37.2 mg of the metal ion and only the equivalent of 18.6 mg of the metal ion was leached in the test then the metal ion source was only 50% available. In certain embodiments the leaching test may be performed by exposing the test material to the electrolyte (e.g., in an inert container) for a period of time sufficient to allow the metal ion concentration to reach a substantially constant value or “final concentration” (or a point where the amount available can be estimated with reasonable accuracy). In some embodiments, this substantially constant value may be reached after the test material has been exposed to the electrolyte for 3 days at room temperature. In some embodiments, a longer period of time may be required (e.g., 5, 8, 10, 20, 25 or more days). In some embodiments, the metal ion concentration in the electrolyte may be measured at regular intervals, e.g., every day until it remains substantially constant. In some embodiments, “substantially constant” may mean that the metal ion concentration does not increase by more than 5% from one day to the next. In some embodiments, the measured metal ion concentrations may be used to extrapolate the substantially constant value (e.g., by fitting the measured metal ion concentrations using function fitting software). In some embodiments, the electrolyte is sulfuric acid. Specific variations (i.e., specific gravity) of sulfuric acid are described below (e.g., in certain embodiments the electrolyte is 1.3 g/ml sulfuric acid).

In certain embodiments, availability may depend on battery operation. For example, a metal ion source that is included in an electrode grid may only become available when battery operation causes the electrode grid to corrode and thereby release portions of the grid (including the source of metal ion) into the electrolyte. In such embodiments, it may be necessary to assess availability based on the level of corrosion that is observed for the electrode grid instead of based on a standard leaching test. In certain embodiments, the level of corrosion is defined as the amount of grid corrosion that occurs between onset of battery use and the battery reaching 80% of its initial capacity (or nominal capacity if the battery does not achieve its nominal capacity until later in life). For example, if the metal ion source is uniformly distributed within the electrode grid and the electrode grid exhibits (or is predicted to exhibit) 40% corrosion within this timeframe then the metal ion would be 40% available. In certain embodiments, the level of corrosion within this defined timeframe may be determined experimentally. In certain embodiments these experiments may include some form of extrapolation from corrosion levels that are measured before the battery reaches 80% of its initial capacity, e.g., based on known or predicted behavior of a particular electrode grid (or type of electrode grid) and optionally the use of function fitting software. In certain embodiments, the amount of grid corrosion may be predicted or approximated based on the known or predicted behavior of a particular electrode grid (or type of electrode grid) (i.e., without any experimentation).

In certain embodiments, adjusting for the availability of the leachable metal ion source within a battery component (e.g., metal oxide within the resin coating of a separator, etc.) may be accomplished by first calculating a percent availability as compared to an ideal, identical battery component (e.g., an identical battery component with a fully exposed and therefore available metal oxide coating). The amount needed in the ideal battery component is then converted to an amount needed in the actual battery component based on the relative percent availability of the actual battery component. For example, a battery component with 50% availability will require double the amount of metal oxide, as compared to the same battery component with 100% availability. In some embodiments, the availability of the battery component is between about 10% and about 20%, between about 10% and about 25%, between about 20% and about 30%, between about 25% and about 35%, between about 30% and about 40%, between about 35% and about 45%, between about 40% and about 50%, between about 45% and about 55%, between about 50% and about 60%, between about 55% and about 65%, between about 60% and about 70%, between about 65% and about 75%, between about 70% and about 80%, between about 75% and about 85%, between about 80% and about 90% or between about 90% and about 99%. Many of the amounts of metal ion source that are described herein are for battery components with 100% availability. Those skilled in the art will be able to convert those values for situations involving battery components that have less than 100% availability. It will also be appreciated that values (e.g., amounts or weight percentages of a given metal ion or metal ion source) that are provided herein for a given percentage availability (e.g., 25% availability) can be generalized to other availabilities by referring to the provided values as values that are defined on an “availability basis” (e.g., if 20 mg metal oxide was needed on a “25% availability basis” it should be understood to mean that only 10 mg metal oxide would be needed for an otherwise identical scenario where the availability is increased to 50%). Alternatively, values that are provided herein for a given percentage availability (e.g., 25% availability) can be converted to 100% availability and generalized to other availabilities by referring to the new value being on a “100% availability basis” (e.g., if 20 mg metal oxide was needed on a “25% availability basis” this could also be referred to as 5 mg metal oxide on a 100% availability basis). It is also to be understood that the concept of an “availability basis” can be combined with the concept of a “reference cell” in order to normalize values based on both availability and electrolyte volume (and optionally the dimensions of the cell).

For purposes of illustration a few examples of availability and target concentration calculations are presented below.

In a first example, the battery component is a battery separator that is (a) known to include a resin coating with a total amount of 37.2 mg metal ion and (b) designed for use with 1 liter of 1.3 g/ml sulfuric acid as the electrolyte. The availability of the metal ion is initially determined by placing the battery separator within an inert container that includes 1 liter of 1.3 g/ml sulfuric acid at room temperature. The amount of metal ion in the electrolyte is measured after 1, 3 and 5 days and found to have reached a substantially constant value of 18.6 mg by 3 days. The availability of the metal ion source is therefore determined to be 50% (i.e., 18.6 mg leached/37.2 mg present). The target concentration of the metal ion is then calculated to be 14.3 ppm using Equation 12, i.e., (37.2*50%)/(1*1.3).

In a second example, the battery includes two components that include a metal ion source (in this example the same metal ion; however, as discussed herein it could be a different metal ion). The first component is the same resin coated battery separator that was discussed in the first example. The second component is the battery case and is known to be coated with a resin that includes a total amount of 100 mg metal ion. The two battery components are again designed for use in a battery with 1 liter of 1.3 g/ml sulfuric acid as the electrolyte. The availability of the metal ion source in the battery case is initially determined by placing 1 liter of 1.3 g/ml sulfuric acid in the battery case at room temperature. The amount of metal ion in the electrolyte is measured after 1, 3 and 5 days and by plotting the measured values and fitting to a curve the substantially constant value it estimated to be 25 mg. The availability of the metal ion source is therefore determined to be 25% (i.e., 25 mg leached/100 mg present). The target concentration of the metal ion is then calculated to be 33.5 ppm using Equation 12, i.e., [(37.2*50%+100*25%)]/(1*1.3)=(18.6+25)/1.3=43.6/1.3. This second example shows that a particular target concentration (in this case 33.5 ppm) can be achieved by combining two different metal ion sources (in this case a resin coated separator that provides 18.6 mg and an resin coated batter case that provides 25 mg for a total of 43.6 mg).

In a third example, the battery component is an electrode grid metal alloy that is (a) known to include 100 mg of metal ion and (b) designed for use with 1 liter of 1.3 g/ml sulfuric acid as the electrolyte. In one version of this example the availability of the metal ion source is initially determined by operating the battery until the capacity of the battery reaches 80% of its initial capacity (or nominal capacity if the battery does not achieve its nominal capacity until later in life). In another version of this example the availability of the metal ion source is predicted based on results obtained with similar electrode grid metal alloys. For purposes of this example we assume that the electrode grid metal alloy was 40% corroded within this timeframe. The availability of the metal ion source is therefore determined to be 40%. The target concentration of the metal ion is then calculated to be 30.8 ppm using Equation 12, i.e., (100*40%)/(1*1.3).

### 5. Metal Ion Sources—Generally

In general, the metal ions are delivered to the electrolyte from a battery component that is exposed to the electrolyte when placed within a battery (e.g., lead acid battery). The metal ions may be from a source that is either a metal compound (e.g., metal oxide, metal phosphate metal sulfate, etc.) or a pure component metal. While metal oxides are used and referred to herein for simplicity as an exemplary source of metal ions it is to be understood that pure metals or other metal compounds can be substituted and amounts adjusted based on differences in molar weights.

In a first aspect, a source of metal ions (e.g., metal oxide) is included in a coating on the surface of a battery component. As discussed in more detail below, in certain embodiments, the battery component is an electrode plate, a battery case, a separator, glass fibers used to make a separator or other battery component, pasting paper, an electrode grid, etc. In certain embodiments, the coating is a resin coating that is applied to the surface of a battery component, e.g., by spraying, by dipping, etc. In certain embodiments, the coating is a metal oxide coating that is applied to the surface of a battery component by chemical vapor deposition (e.g., metalorganic CVD, plasma enhanced CVD, combustion CVD), by sputter deposition, or by thermal spraying (e.g., flame spraying, plasma spraying, etc.).

In a second aspect, a source of metal ions (e.g., metal oxide) is integrated into the structure of a battery component instead of being coated on a surface. As discussed in more detail below, in certain embodiments, the battery component may be an electrode grid, a resin filled battery separator, a separator made with glass fibers that are associated with metal oxide particles added during a wet-laid production process, etc. In certain embodiments, the source of metal ions is included as an ingredient in the metal alloy used to make an electrode grid. In certain embodiments, the source of metal ions is included as part of the resin in a resin filled separator. In certain embodiments, metal oxide particles are associated to separator fibers during a wet-laid process. For example, the metal oxide particles may be added to the beater mix tank with glass fibers and non-glass additive fibers (e.g., cellulose fibers such as the fibers from red cedar wood pulp) that the metal oxide particles are affixed to as well as further optional additives that may enhance the bonding between the non-glass additive fibers and the metal oxide particles.

Each of the foregoing metal ion sources is described in more detail in the following sections. In addition, for each metal ion source we have provided some exemplary amounts of metal ion source to be used in order to achieve different target metal ion concentrations in the electrolyte (and therefore different hydrogen shifts).

We begin by describing embodiments of the first aspect where a resin coating is applied to the surface of a battery component such as an electrode plate, a battery case, a separator, etc. Under the same heading we then describe embodiments of the first aspect where a resin coating is applied to glass fibers used to make a separator or other battery component. Under a separate heading we then describe embodiments from the first aspect where the coating is a metal oxide coating that is applied to the surface of a battery component by chemical vapor deposition (e.g., metal organic CVD, plasma enhanced CVD, combustion CVD), by sputter deposition, by thermal spraying (e.g., flame spraying, plasma spraying), etc.

### 6. Metal Ion Sources—Resin Coatings Containing Metal Oxides

As noted above, in embodiments of the first aspect, a source of metal ions (e.g., metal oxide) is included in a coating on the surface of a battery component. As discussed in more detail below, in certain embodiments, the battery component is an electrode plate, a battery case, a separator, pasting paper, an electrode grid, glass fibers used to make a separator or other battery component, etc.

a. Resin Coatings on Battery Components—Generally

In certain embodiments, a source of metal ions (e.g., metal oxide) is included within a resin coating on the surface of a battery component. For example, during manufacturing of a battery separator or pasting paper (e.g., using a wet-laid manufacturing process such as a paper making process), the separator or pasting paper can be sprayed with a resin containing metal oxide using a spray bar or similar equipment. While the following description focuses on spraying methods and wet laid forming methods, it is to be understood that similar results can be obtained using other coating methods, e.g., dipping, pasting, etc. and other forming methods, e.g., air laid, dry laid, etc. The resulting product (e.g., separator or pasting paper) would have a resin coating containing metal oxide. Upon exposure to the internal battery environment, the electrolyte (e.g., sulfuric acid) will leach the metal ions from the metal oxide in the resin coating.

In certain embodiments, a battery component (e.g., a battery case, an electrode grid, a separator, pasting paper, etc.) may be sprayed with a resin containing metal oxide compounds after it has been manufactured. For example, resin spraying may involve using one or more air atomized polymer spray nozzles mounted on a spray bar above a separator or pasting paper sheet to spray directly on the separator or pasting paper. This could be done before or after drying the separator or pasting paper. This could also be done off-line.

In certain embodiments, the resin is an organic resinous or plastic material. In certain embodiments, the resin is a polyacrylate (Acrylic), polystyreneacrylate (STYACR), styrene butadiene rubber (SBR), or polyvinylidine chloride (PVDC). Mixtures of the above can also be used. In certain embodiments, the resin is a latex. The resin may also contain additives such as wetting agents, thickeners, catalysts, accelerators, guar gum and polyacrylamides. In some embodiments, the resin solution is aqueous or uses an organic solvent. In some embodiments, the resin makes up between about 1 weight percent and about 35 weight percent of the bath or resin solution. In some embodiments, the additives are present in an amount between about 0 weight percent and about 20 weight percent of the resin weight in the solution or bath.

The metal oxide may, in certain embodiments, be added to the resin in the form of particles. In certain embodiments, the particles are nanometer sized, i.e., with an average diameter of less than 1 micron, e.g., in the range of about 50 nm to about 700 nm, about 50 nm to about 500 nm, about 50 nm to about 300 nm, about 100 nm to about 700 nm, about 100 nm to about 500 nm, about 100 nm to about 300 nm, about 200 nm to about 700 nm, about 200 nm to about 500 nm, about 200 nm to about 300 nm, etc. In certain embodiments, the particles are micron sized, i.e., with an average diameter of at least 1 micron, e.g., in the range of about 1 micron to about 2 microns, about 2 microns to about 5 microns, about 5 microns to about 25 microns, about 25 microns to about 100 microns, etc.

The amount of resin sprayed onto a particular battery component will depend on the geometry and size of the battery component, the desired hydrogen shift, the nature and concentration of the metal ion source in the resin and the availability of the metal ion source to the electrolyte (which will depend in part on the porosity of the resin coating).

In certain embodiments, the present disclosure refers to a “reference cell.” As used herein a “reference cell” is, at a minimum, a cell that contains 1 liter of sulfuric acid solution which has a density of 1.3 g/ml (or 1.3 g/cm³). In certain embodiments, when the dimensions of the cell are relevant (e.g., when considering the thickness of coating needed which depends in part on available surface area) the “reference cell” may be further defined to include a 7″×6.5″×2″ battery case which results in an interior surface area (available for coating) of 91 inches² or 587 cm²; thirteen 6″×6″ electrode plates (36 inches² on each side of the electrode plate); and twelve 6″×6″ separators separating these electrode plates (again 36 inches² on each side of the separator). The total surface area of the electrode plates would be 36 inches²×13 plates×2 surfaces=936 inches² or 6,039 cm². The total surface area of the separator would be 36 inches²×12 separators×2 surfaces=864 in² or 5,574 cm². The available surface area for coating on the separators or electrode plates is therefore quite similar and greater than the available surface area for coating the inside of the battery case (about 10-fold greater). As a result, coatings with a given resin on the battery case would have to be about 10 times thicker than the coatings on the electrode plates and/or separators to achieve the same results (e.g., a 50 mV hydrogen shift). Those skilled in the art will be able to scale these calculations for cells that differ from this “reference cell” (e.g., because coatings are on alternative battery components and/or the battery components have different geometries and/or sizes, etc.).

As noted above, the porosity of the resin will also affect the availability of the leachable metal ion source to the electrolyte. Generally the higher the porosity of the resin the more electrolyte will be in contact with the metal ion source within the resin and thus the more effective the leachable metal ion source. For example, a 50% available resin coating renders the leachable metal ion source 50% effective—therefore twice the theoretical amount of leachable metal ion source should be added to the resin coating (where the theoretical amount is the amount predicted or measured for a 100% available metal ion source, e.g., a pure metal oxide coating). In general, a resin coating would be expected to have an availability in the range of about 10% to about 90%. For example, in certain embodiments, a resin coating may have an availability in the range of about 10% to about 25%, about 20% to about 50%, about 10% to about 40%, about 25% to about 50%, about 25% to about 75%, about 40% to about 70%, about 50% to about 70%, about 50% to about 75%, about 50% to about 90%, about 70% to about 90%, about 60% to about 90% or about 70% to about 90%. In certain embodiments, a resin coating may have an availability that is about 25%. This would mean that only 25% of the theoretical amount of metal oxide added to the battery component is accessible to electrolyte to leach out the metal ions. As a result, four times the theoretical amount of metal oxide particles would need to be added to the coating in order to impart the desired electrochemical effect (where the theoretical amount is again the amount predicted or measured for a 100% available metal ion source, e.g., a pure metal oxide coating).

In the following section we describe specific examples and embodiments using resin coatings on different battery components.

b. Resin Coatings on Battery Components—Target Metal Ion Amounts

Using resin coating methods to deliver metal oxide to battery components can result in a variety of ultimate target metal ion concentrations in the electrolyte. Any of the metal ion concentrations described above can be achieved depending on the quantity of metal oxide coated on the battery component. The resin coating applied will vary based on the particular metal ion, target electrolyte concentration of the metal ion and choice of battery component. The values given below are based on a range of hydrogen shifts (from 10 mV to 120 mV) and the reference cell that was defined previously. For all calculations, it was also assumed that the reference cell contained: (a) 1 liter of 1.3 g/ml density sulfuric acid (i.e., the same as in previous calculations), (b) 92 g of separator (i.e., about 7.7 g per separator), and (c) that the metal oxide had 25% availability once incorporated into the resin coating on the separator. As described in more detail below it is to be understood that these “reference cell basis” values can be readily scaled down for batteries with smaller cell sizes (and/or different numbers of plates and separators) and scaled up for larger multi-cell batteries. It is also to be understood that these “reference cell basis” values can be readily scaled up for batteries that include a less dense sulfuric acid as the electrolyte or scaled up for batteries that include a more dense sulfuric acid as the electrolyte. The same is true for batteries that include a different electrolyte volume from the one used to calculate the “reference cell basis” values.

To produce a hydrogen shift of 10 mV, a bismuth target ion concentration of about 14.3 ppm in the electrolyte should be provided (see Table 1). Next we calculate the amount of bismuth oxide that would be needed in order to achieve this target concentration in a reference lead-acid battery cell assuming 100% availability (i.e., if the metal oxide were provided as a pure coating on the relevant battery component) using the following equation:

Y=1.3*X*1.0*(molar mass of metal oxide/molar mass of metal ion) Eqn. 14

where Y is weight of metal oxide (in mg), X is target concentration in parts per million (ppm), 1.3 is the density of the solution (in g/cm³), and 1.0 is the volume of the cell (in liters). Naturally, this factor will change based on sulfuric acid solutions with different densities. In this embodiment, the coating thickness was calculated by converting the target weight of metal oxide to a volume based on the oxide density. That metal oxide volume is then used to calculate the volume of resin required based on the volumetric concentration of metal oxide in the resin solution, giving a total volume of the resin coating required. This total resin volume is then divided by the surface area of the component being coated to determine the thickness of the coating. This process can be summarized by the following equation:

T=Y*(1/D)*(1/V)*(1/A)*10000 Eqn. 15

where T is the thickness (in microns), Y is the target amount of metal oxide (in mg); D is density of the metal oxide (in g/cm³); V is volume percent of metal oxide in the resin solution; and A (in cm²) is the surface area of the component. The result is multiplied by 10000 to convert centimeters to microns.

Using 14.3 ppm for target concentration we obtain a target amount of bismuth oxide (Bi₂O₃) that is equal to 20.9 mg. Next we take into account the actual availability of the metal oxide in the resin that will be used. For example, for a resin with 25% availability we would adjust the amount upwards by a factor of 4 to give about 84 mg. For example this could be accomplished by adding nanoscale (e.g., about 210 nm average diameter) bismuth oxide particles to the resin solution and coating a battery component such that about 84 mg of the bismuth oxide particles are added in each cell, based on a reference cell as defined above. A cell that is half the size would require half that amount. A battery with multiple cells would require a larger amount (scaled based on relative electrolyte volumes).

The coating depth in microns to provide this amount of bismuth oxide will depend in part on the available surface area of the battery component being coated. For example, while about 14.6 microns of a bismuth oxide containing resin layer might be needed to provide about 84 mg of bismuth oxide when the inside of a reference cell battery case is being coated (91 inches² or 587 cm² of available surface area), a coating of about 1.4 microns would be needed when the electrode plates are being coated (936 inches² or 6,039 cm² of available surface area), and a coating of about 1.5 microns would be needed when the separators are being coated (864 inches² or 5,574 cm² of available surface area).

To produce a hydrogen shift of 30 mV, a bismuth target ion concentration of about 43 ppm in the electrolyte should be provided (see Table 1). Based on the same example as above the amount of bismuth oxide added would need to be about 251 mg per cell, based on a reference cell as defined above. Again, the coating depth will vary based on the component selected, for example, about 43.7 microns of a bismuth oxide containing resin layer might be needed to provide about 251 mg of bismuth oxide when the inside of a reference cell battery case is being coated (91 inches² or 587 cm² of available surface area), a coating of about 4.2 microns would be needed when the electrode plates are being coated (936 inches² or 6,039 cm² of available surface area), and a coating of about 4.4 microns would be needed when the separators are being coated (864 inches² or 5,574 cm² of available surface area).

To produce a hydrogen shift of 60 mV, a bismuth target ion concentration of about 86 ppm in the electrolyte should be provided (see Table 1). Based on the same example as above the amount of bismuth oxide added would need to be about 501 mg per cell, based on a reference cell as defined above. Again, the coating depth will vary based on the component selected, for example, about 87.2 microns of a bismuth oxide containing resin layer might be needed to provide about 501 mg of bismuth oxide when the inside of a reference battery case is being coated (91 inches² or 587 cm² of available surface area), a coating of about 8.5 microns would be needed when the electrode plates are being coated (936 inches² or 6,039 cm² of available surface area), and a coating of about 8.9 microns would be needed when the separators are being coated (864 inches² or 5,574 cm² of available surface area).

To produce a hydrogen shift of 120 mV, a bismuth target ion concentration of about 172 ppm in the electrolyte should be provided (see Table 1). Based on the same example as above the amount of bismuth oxide added would need to be about 1,004 mg per cell, based on a reference cell as defined above. Again, the coating depth will vary based on the component selected, for example, about 174.6 microns of a bismuth oxide containing resin layer might be needed to provide about 1,004 mg of bismuth oxide when the inside of a reference battery case is being coated (91 inches² or 587 cm² of available surface area), a coating of about 17.0 microns would be needed when the electrode plates are being coated (936 inches² or 6,039 cm² of available surface area), and a coating of about 17.8 microns would be needed when the separators are being coated (864 inches² or 5,574 cm² of available surface area).

These exemplary amounts and coating depths (i.e., for a reference cell using bismuth oxide particles) are summarized in Table 2 below.

TABLE 2
Amount and Coating Depth of Bismuth Oxide (Reference Cell)

| | Hydrogen Shift (mV) | | | |
|---|---|---|---|---|
| | 10 | 30 | 60 | 120 |
| Amount of Bi₂O₃ in mg | 84 | 251 | 501 | 1,004 |
| Bi₂O₃ coating in microns (case) | 14.6 | 43.7 | 87.2 | 174.6 |
| Bi₂O₃ coating in microns (plates) | 1.4 | 4.2 | 8.5 | 17.0 |
| Bi₂O₃ coating in microns (separators) | 1.5 | 4.4 | 8.9 | 17.8 |

Other metal oxide particles can be added into the resin solution instead of bismuth oxide particles. Exemplary amounts needed for different hydrogen shifts (assuming 25% availability) are outlined in Table 3 below. The weight % and volume % of metal oxide particles in the resin solution is dependent on the density of the metal oxide (shown in parentheses in Table 3 for each metal oxide) and availability. Thus, for bismuth oxide, the resin solution contains 10.9 weight % or 1.1 volume % bismuth oxide particles. For NiO₂, the resin solution contains 2.4 weight % or 0.3 volume % NiO₂ particles. For SnO₂, the resin solution contains 2.0 weight % or 0.3 volume % SnO₂ particles. For Sb₂O₃, the resin solution contains 3.7 weight % or 0.6 volume % Sb₂O₃ particles. For CoO, the resin solution contains 5.5 weight % or 0.8 volume % CoO particles. For CuO, the resin solution contains 3.0 weight % or 0.4 volume % CuO particles. For TiO₂, the resin solution contains 4.0 weight % or 0.9 volume % TiO₂ particles. The different metal oxides yield different thickness in resin coatings. As discussed elsewhere, thinner coatings could be used if the concentration of metal oxide were increased. One skilled in the art could readily calculate the metal oxide concentrations needed for a range of thicknesses. The values described below are again for a reference lead-acid battery cell as defined above.

TABLE 3
Amount and Resin Coating Depth of Various Metal Oxides
(Reference Cell)

| | Hydrogen Shift (mV) | | | |
|---|---|---|---|---|
| | 10 | 30 | 60 | 120 |
| Amount of NiO₂ in mg (6.72 g/cm3) | 18.6 | 54.6 | 109.1 | 217.6 |
| NiO₂ coating in microns (case) | 15.7 | 46.1 | 92.2 | 183.9 |
| NiO₂ coating in microns (plates) | 1.5 | 4.5 | 9.0 | 17.0 |
| NiO₂ coating in microns (separators) | 1.6 | 4.7 | 9.4 | 18.7 |
| Amount of SnO₂ in mg (6.85 g/cm3) | 15.2 | 44.7 | 89.9 | 179.8 |
| SnO₂ coating in microns (case) | 12.6 | 37.0 | 74.5 | 149.0 |
| SnO₂ coating in microns (plates) | 1.2 | 3.6 | 7.2 | 14.5 |
| SnO₂ coating in microns (separators) | 1.3 | 3.8 | 7.6 | 15.2 |
| Amount of Sb₂O₃ in mg (5.58 g/cm3) | 28.7 | 85.2 | 171.4 | 342.4 |
| Sb₂O₃ coating in microns (case) | 14.6 | 86.7 | 174.4 | 348.4 |
| Sb₂O₃ coating in microns (plates) | 1.4 | 8.4 | 17.0 | 33.9 |
| Sb₂O₃ coating in microns (separators) | 1.5 | 8.8 | 17.7 | 35.4 |
| Amount of CoO in mg (6.44 g/cm3) | 42.2 | 127.2 | 254.3 | 509.2 |
| CoO coating in microns (case) | 14.0 | 42.0 | 84.1 | 168.4 |
| CoO coating in microns (plates) | 1.4 | 4.1 | 8.2 | 16.4 |
| CoO coating in microns (separators) | 1.4 | 4.3 | 8.5 | 17.1 |
| Amount of CuO in mg (6.31 g/cm3) | 23.5 | 69.6 | 139.2 | 277.8 |
| CuO coating in microns (case) | 15.9 | 47.0 | 93.9 | 187.5 |
| CuO coating in microns (plates) | 1.5 | 4.6 | 9.1 | 18.2 |
| CuO coating in microns (separators) | 1.6 | 4.8 | 9.5 | 19.1 |
| Amount of TiO₂ in mg (4.23 g/cm3) | 31.4 | 92.7 | 185.5 | 371.0 |
| TiO₂ coating in microns (case) | 14.0 | 41.5 | 83.0 | 166.0 |
| TiO₂ coating in microns (plates) | 1.4 | 4.0 | 8.1 | 16.1 |
| TiO₂ coating in microns (separators) | 1.4 | 4.2 | 8.4 | 16.9 |

In the following sections we provide some exemplary ranges of amounts of different metal oxides that can be added on a reference cell basis (as defined above) using a resin (e.g., latex) which has about 25% availability. It will be appreciated that these ranges can be scaled downward for cells that are smaller than a reference cell or upward for cells that are larger than a reference cell (based on the relative electrolyte volumes). Typically these non-reference cells will have electrolyte volumes that are between about 75% and about 125%, e.g., about 80% and about 120% of the electrolyte volume in a reference cell. Similarly, these ranges can be scaled downward for resins that have a percent availability that is more than about 25% availability and upward for resins that have a percent availability that is less than about 25% availability. Typically the percent availability of the metal oxide will be between about 10% and about 40%, e.g., between about 20% and about 30%. Furthermore, the ranges can be scaled based on different density electrolyte (e.g., sulfuric acid solution). Typically the electrolyte has a density between about 1.1 g/cm³ and about 1.5 g/cm³, e.g., between about 1.2 g/cm³ and about 1.4 g/cm³.

In some embodiments, the metal oxide is bismuth, the resin coating has an availability of about 25% and the amount of metal oxide added on a reference cell basis (as defined above) through the resin coating is in the range of about 84.0 mg to about 1004.0 mg, about 84.0 mg to about 251.0 mg, about 84.0 mg to about 501.0 mg, about 251.0 mg to about 501.0 mg, about 251.0 mg to about 1004.0 mg or about 501.0 mg to about 1004.0 mg.

In some embodiments, the metal oxide is nickel, the resin coating has an availability of about 25% and the amount of metal oxide added on a reference cell basis (as defined above) through the resin coating is in the range of about 18.6 mg to about 217.6 mg, about 18.6 mg to about 54.6 mg, about 18.6 mg to about 109.1 mg, about 54.6 mg to about 109.1 mg, about 54.6 mg to about 217.6 mg or about 109.1 mg to about 217.6 mg.

In some embodiments, the metal oxide is tin, the resin coating has an availability of about 25% and the amount of metal oxide added on a reference cell basis (as defined above) through the resin coating is in the range of about 15.2 mg to about 179.8 mg, about 15.2 mg to about 44.7 mg, about 15.2 mg to about 89.9 mg, about 44.7 mg to about 89.9 mg, about 44.7 mg to about 179.8 mg or about 89.9 mg to about 179.8 mg.

In some embodiments, the metal oxide is antimony, the resin coating has an availability of about 25% and the amount of metal oxide added on a reference cell basis (as defined above) through the resin coating is in the range of about 28.7 mg to about 342.4 mg, about 28.7 mg to about 85.2 mg, about 28.7 mg to about 171.4 mg, about 85.2 mg to about 171.4 mg, about 85.2 mg to about 342.4 mg or about 171.4 mg to about 342.4 mg.

In some embodiments, the metal oxide is cobalt, the resin coating has an availability of about 25% and the amount of metal oxide added on a reference cell basis (as defined above) through the resin coating is in the range of about 42.2 mg to about 509.2 mg, about 42.2 mg to about 127.2 mg, about 42.2 mg to about 254.3 mg, about 127.2 mg to about 254.3 mg, about 127.2 mg to about 509.2 mg or about 254.3 mg to about 509.2 mg.

In some embodiments, the metal oxide is copper, the resin coating has an availability of about 25% and the amount of metal oxide added on a reference cell basis (as defined above) through the resin coating is in the range of about 23.5 mg to about 277.8 mg, about 23.5 mg to about 69.6 mg, about 23.5 mg to about 139.2 mg, about 69.6 mg to about 139.2 mg, about 69.6 mg to about 277.8 mg or about 139.2 mg to about 277.8 mg.

In some embodiments, the metal oxide is titanium, the resin coating has an availability of about 25% and the amount of metal oxide added on a reference cell basis (as defined above) through the resin coating is in the range of about 31.4 mg to about 371.0 mg, about 31.4 mg to about 92.7 mg, about 31.4 mg to about 185.5 mg, about 92.7 mg to about 185.5 mg, about 92.7 mg to about 371.0 mg or about 185.5 mg to about 371.0 mg.

c. Resin Coatings on Glass Fibers—Generally

In certain embodiments, instead of coating the battery components (e.g., separators, battery case, etc.), a constituent that is used to make a battery component may be coated with a resin that includes a metal ion source. In particular, chopped strand glass fibers or other types of glass fibers that are sometimes used to make separators or pasting paper can be coated with resins containing a metal ion source.

In some embodiments, coated chopped strand glass fibers are prepared as follows. The glass is initially formed into continuous filaments and drawn to a preferred size (e.g., about 6.5 to about 13 micron average diameter although other sizes may be used). After cooling, the glass filaments are drawn through a bath that includes a sizing agent solution. The sizing agent is a coating, or primer, which both helps protect the glass filaments for processing/manipulation as well as ensure proper bonding to the resin matrix. Sizing agent solutions consist of mainly silane and optionally a coupling agent and lubricant. The sizing agent helps to improve both the protection of glass fibers and forms a bond between the glass fibers and matrix polymers. In certain embodiments, the silane is a monoaminosilane or a diaminosilane. After the silane has dried onto the glass filaments, they are fed into a bath that includes a resin solution with a metal ion source (e.g., bismuth oxide or other metal oxide particles). In certain embodiments, the coated filaments are drawn from the bath vertically to allow the excess resin solution to drain back into the bath for future use. The coated filaments are then passed through a drying and curing oven (optionally in a vertical orientation) after which they are fed into a horizontal chopper which chops them into standard lengths such as 0.25, 0.5 or 1 inch lengths.

In certain embodiments, the resin is an organic resinous or plastic material. In certain embodiments, the resin is a polyacrylate (Acrylic), polystyreneacrylate (STYACR), styrene butadiene rubber (SBR), or polyvinylidine chloride (PVDC). Mixtures of the above can also be used. In certain embodiments, the resin is a latex. The resin may also contain wetting agents, thickeners, catalysts, accelerators, guar gum and polyacrylamides. In some embodiments, the resin solution is aqueous or uses an organic solvent. In some embodiments, the resin makes up between about 1 weight percent and about 35 weight percent of the bath or resin solution. In some embodiments, the additives are present in an amount between about 0 weight percent and about 20 weight percent of the resin weight in the solution or bath. In certain embodiments the resin coating comprises between about 7% and about 93% by weight resin, e.g., about 15% to about 85%, about 25% to about 75%, about 35% to about 65%, or about 45% to about 55%. The resin may comprise between about 1% to about 11% of the coated fiber weight. In certain embodiments, the resin comprises between about 3% and about 9% of the coated fiber weight or between about 5% and about 7% of the coated fiber weight. In certain embodiments, the resin comprises between about 3% and about 6% of the coated fiber weight, between about 9% and about 11% of the coated fiber weight. The weight percent depends in part on the type of glass fiber coated (i.e., in some embodiments, the coating of coated chopped strand fibers will be a higher weight percentage of whole fiber, as compared to the coating of a coated microglass fiber).

As noted above, the metal oxide may, in certain embodiments, be added to the resin in the form of particles. In certain embodiments, the particles are nanometer sized, i.e., with an average diameter of less than 1 micron, e.g., in the range of about 50 nm to about 700 nm, about 50 nm to about 500 nm, about 50 nm to about 300 nm, about 100 nm to about 700 nm, about 100 nm to about 500 nm, about 100 nm to about 300 nm, about 200 nm to about 700 nm, about 200 nm to about 500 nm, about 200 nm to about 300 nm, etc. In certain embodiments, the particles are micron sized, i.e., with an average diameter of at least 1 micron, e.g., in the range of about 1 micron to about 2 microns, about 2 microns to about 5 microns, about 5 microns to about 25 microns, about 25 microns to about 100 microns, etc.

As noted above, chopped strand fibers are not the sole type of glass fibers that can be used to make a battery separator or pasting paper. For example, micro fiberglass and glass fibers produced by a CAT process, a non-CAT process, a flame attenuated process or a rotary process are also commonly used in battery separators and pasting paper. In some embodiments, during the fiberization process the fibers are simply sprayed with a resin solution containing a metal ion source just prior to collection, giving enough time to dry. For example, in some embodiments, a flame attenuated process may be used where the fiberizer is located before an enclosed forming belt, the fibers are passed through an opening directly in front of the fiberization zone and the opening being large enough to admit an entire fiber (see FIG. 14). In certain embodiments, one or more air atomized resin nozzles directed at the incoming fiber would be located beyond the opening within the forming zone (e.g., behind the wall the separates the fiberizer from the forming belt, on the forming belt side). The resin would coat the incoming fiber and flash dry during the process. In certain embodiments, the forming belt would have a vacuum on the fan side, under a collection belt, to aid in the collection of fibers and the formation of a fiber sheet. After collection the fibers would be transferred by another carrier belt for additional curing in a separate oven. In certain embodiments the coated fibers could be chopped in a subsequent step.

The amount of resin sprayed onto a particular glass fiber will depend on the amount of glass fiber in the battery component, the geometry and size of the glass fiber, the desired hydrogen shift, the nature and concentration of the metal ion source in the resin and the availability of the metal ion source to the electrolyte.

In the following section we describe specific examples and embodiments using resin coatings on different glass fibers.

d. Resin Coatings on Chopped Strand Glass Fibers—Target Metal Ion Amounts

Chopped strand glass fibers typically make up a sizeable portion of the glass fiber separators that are commonly used in lead-acid batteries (e.g., about 15% by weight). These glass fibers can therefore be used as a convenient source of metal ions. Using resin coating methods to deliver metal oxide to chopped strand glass fibers can result in a variety of ultimate target metal ion concentrations in the electrolyte. Any of the metal ion concentrations described herein can be achieved depending on the quantity of metal oxide coated on the glass fibers and the amount of glass fibers in the battery component (e.g., but not limited to a separator). In particular, the resin coating applied will vary based inter alia on the particular glass fiber, metal ion, target electrolyte concentration of the metal ion and choice of battery component.

The values given below are based on a range of hydrogen shifts (from 10 mV to 120 mV) and the reference cell that was defined previously. For all calculations, it was also assumed that the reference cell contained: (a) 1 liter of 1.3 g/ml density sulfuric acid (i.e., the same as in previous calculations), (b) 92 g of separator (i.e., about 7.7 g per separator), (c) that the coated chopped strand fibers comprise 15% by weight (i.e., 13.8 g) of the separator, (d) that the metal oxide had 25% availability once coated onto the glass fibers and located in the separator and (e) that the coating comprises about 11% by weight of the coated fiber.

As discussed previously, it is to be understood that the “reference cell basis” values that are provided below using these reference cell assumptions can be readily scaled up or down when different electrolyte volumes or electrolyte strengths are used or when different amounts of separator and/or different amounts of glass fiber in the separator are used. As in previous sections, our calculations are initially presented for bismuth oxide as the source of metal ion and then for other metal ion sources.

To produce a hydrogen shift of 10 mV, a bismuth target ion concentration of about 14.3 ppm in the electrolyte should be provided (see Table 1). As per Equation 14 above, this concentration is equivalent to 20.9 mg of bismuth oxide in the electrolyte of a reference cell. To determine the corresponding quantity of bismuth oxide required in the separator, this target weight is multiplied by 4 to account for the availability of the separator with coated fibers. Thus 84 mg of bismuth oxide in the separator is the target weight. This can be accomplished by adding bismuth oxide particles (e.g., about 90-210 nm average diameter particles) into the resin solution and coating the glass filaments that are chopped and then used in the battery separator such that the separator contains about 0.09 weight percent bismuth oxide (i.e., about 84 mg bismuth oxide).

In one embodiment, chopped strand glass fibers account for 13.8 g (i.e., 15 weight percent) of the separator weight. Because the coated chopped strand glass fibers are the source of the oxide, they should contain about 0.61 weight percent bismuth oxide to provide the overall target amount of bismuth oxide in the separator.

To coat the fibers a resin bath containing about 5.6 weight percent bismuth oxide (or about 0.56 volume percent) can be used to produce coated chopped strand glass fibers with the target amount of bismuth oxide. This percentage is based on the target coating weight percentage of 11% of the final coated glass fiber. (i.e., 0.61=5.6*0.11).

To produce a hydrogen shift of 30 mV, a bismuth target ion concentration of about 43 ppm in the electrolyte should be provided (see Table 1). This can be accomplished by adding bismuth oxide particles (e.g., about 90-210 nm average diameter particles) into the resin solution and coating the glass filaments that are chopped and then used in the battery separator such that the separator contains about 0.27 weight percent bismuth oxide (i.e., about 251 mg bismuth oxide), based on the calculations described above. In one embodiment, chopped strand glass fibers account for 13.8 g of the separator weight, i.e., the coated chopped strand glass fibers should contain about 1.8 weight percent bismuth oxide to provide the overall target amount of bismuth oxide in the separator. A resin bath solution containing about 16.5 weight percent bismuth oxide (or about 1.7 volume percent) can be used to produce coated chopped strand glass fibers with the target amount of bismuth oxide. This coating (resin and bismuth oxide) will still account for about 11 weight percent of the fiber. This would give a coating of the fiber of the same thickness as the 10 mV example but with a higher loading of bismuth oxide.

To produce a hydrogen shift of 60 mV, a bismuth target ion concentration of about 86 ppm in the electrolyte should be provided (see Table 1). This can be accomplished by adding bismuth oxide particles (e.g., about 90-210 nm average diameter particles) into the resin solution and coating the glass filaments that are chopped and then used in the battery separator such that the separator contains about 0.54 weight percent bismuth oxide (i.e., about 501 mg bismuth oxide). In one embodiment, chopped strand glass fibers account for 13.8 g of the separator weight, i.e., the coated chopped strand glass fibers should contain about 3.6 weight percent bismuth oxide to provide the overall target amount of bismuth oxide in the separator. A resin bath solution containing about 33.0 weight percent bismuth oxide (or about 3.3 volume percent) can be used to produce coated chopped strand glass fibers with the target amount of bismuth oxide. This coating (resin and bismuth oxide) will still account for about 11 weight percent of the fiber. This would give a coating of the fiber of the same thickness as the 10 mV example but with a higher loading of bismuth oxide.

To produce a hydrogen shift of 120 mV, a bismuth target ion concentration of about 172 ppm in the electrolyte should be provided (see Table 1). This can be accomplished by adding bismuth oxide particles (e.g., about 90-210 nm average diameter particles) into the resin solution and coating the glass filaments that are chopped and then used in the battery separator such that the separator contains about 1.1 weight percent bismuth oxide (i.e., about 1,004 mg bismuth oxide). In one embodiment, chopped strand glass fibers account for 13.8 g of the separator weight, i.e., the coated chopped strand glass fibers should contain about 7.3 weight percent bismuth oxide to provide the overall target amount of bismuth oxide in the separator. A resin bath solution containing about 66.2 weight percent bismuth oxide (or about 6.7 volume percent) can be used to produce coated chopped strand glass fibers with the target amount of bismuth oxide. This coating (resin and bismuth oxide) will still account for about 11 weight percent of the fiber. This would give a coating of the fiber of the same thickness as the 10 mV example but with a higher loading of bismuth oxide.

The amounts of bismuth oxide at different stages of these Exemplary processes are summarized in Table 4 below. The density of the bismuth oxide is provided in parentheses and was used to calculate the volume percent of particles in the resin solution bath.

TABLE 4
Concentrations of Bismuth Oxide in a Resin Coating on Chopped Strand Fiber
Component of a Battery Separator (Reference Cell)

| | Hydrogen Shift (mV) | | | |
|---|---|---|---|---|
| | 10 | 30 | 60 | 120 |
| Target weight of Bi₂O₃ in electrolyte | 20.9 | 63 | 125 | 251 |
| per reference cell (mg) (density = 8.9 g/cm3) | | | | |
| Target Bi₂O₃ weight (mg) per cell in | 84 | 251 | 501 | 1,004 |
| resin coating to achieve corresponding | | | | |
| amount in electrolyte in row immediately | | | | |
| above | | | | |
| Weight percent Bi₂O₃ particles in resin | 0.09 | 0.27 | 0.54 | 1.10 |
| coating as a total of separator weight | | | | |
| Weight percent Bi₂O₃ particles in resin | 0.61 | 1.8 | 3.6 | 7.3 |
| on chopped strand fibers | | | | |
| Weight percent Bi₂O₃ particles in resin | 5.6 | 16.5 | 33.0 | 66.2 |
| solution for coating on chopped strand | | | | |
| fibers to achieve weight percent in | | | | |
| preceding row, based on 11 weight | | | | |
| percent of resin coating for coated fibers | | | | |
| Volume percent Bi₂O₃ particles in resin | 0.6 | 1.7 | 3.3 | 6.7 |
| solution equivalent to weight percentage | | | | |
| in row immediately above | | | | |

Other metal oxide particles can be added into the resin solution bath instead of bismuth oxide particles. Exemplary amounts needed for different hydrogen shifts are outlined in Table 5 below. The densities of the metal oxides are provided in parentheses and were used to calculate the volume percent of particles in the resin solution bath.

TABLE 5
Concentrations of Various Metal Oxides in a Coating on Chopped Strand Glass
Fiber Component of a Battery Separator (Reference Cell)

| | Hydrogen Shift (mV) | | | |
|---|---|---|---|---|
| | 10 | 30 | 60 | 120 |
| Target weight of NiO₂ in electrolyte per | 18.6 | 54.6 | 109.1 | 217.6 |
| reference cell (mg) (density = 6.72 g/cm3) | | | | |
| Weight percent NiO₂ particles in resin coating | 0.02 | 0.06 | 0.12 | 0.24 |
| as a total of separator weight | | | | |
| Weight percent NiO₂ on chopped strand | 0.13 | 0.40 | 0.80 | 1.57 |
| Weight percent NiO₂ particles in resin solution for | 1.21 | 3.63 | 7.27 | 14.30 |
| coating on chopped strand fibers to achieve | | | | |
| weight percent in preceding row, based on 11 | | | | |
| weight percent of resin coating for coated fibers | | | | |
| Volume percent NiO₂ particles in resin solution | 0.16 | 0.49 | 0.98 | 1.92 |
| equivalent to weight percentage in row | | | | |
| immediately above | | | | |
| Target weight of SnO₂ in electrolyte per | 15.2 | 44.7 | 89.9 | 179.8 |
| reference cell (mg) (density = 6.85 g/cm3) | | | | |
| Weight percent SnO₂ particles in resin coating | 0.02 | 0.05 | 0.10 | 0.20 |
| as a total of separator weight | | | | |
| Weight percent SnO₂ on chopped strand | 0.11 | 0.32 | 0.64 | 1.31 |
| Weight percent SnO₂ particles in resin solution for | 0.97 | 2.91 | 5.82 | 11.88 |
| coating on chopped strand fibers to achieve | | | | |
| weight percent in preceding row, based on 11 | | | | |
| weight percent of resin coating for coated fibers | | | | |
| Volume percent SnO₂ particles in resin solution | 0.13 | 0.38 | 0.77 | 1.56 |
| equivalent to weight percentage in row | | | | |
| immediately above | | | | |
| Target weight of Sb₂O₃ in electrolyte per | 28.7 | 85.2 | 171.4 | 342.4 |
| reference cell (mg) (density = 5.58 g/cm3) | | | | |
| Weight percent Sb₂O₃ particles in resin coating | 0.03 | 0.09 | 0.19 | 0.37 |
| as a total of separator weight | | | | |
| Weight percent Sb₂O₃ on chopped strand | 0.21 | 0.61 | 1.25 | 2.48 |
| Weight percent Sb₂O₃ particles in resin solution | 1.94 | 5.58 | 11.39 | 22.55 |
| for coating on chopped strand fibers to achieve | | | | |
| weight percent in preceding row, based on 11 | | | | |
| weight percent of resin coating for coated fibers | | | | |
| Volume percent Sb₂O₃ particles in resin solution | 0.31 | 0.90 | 1.84 | 3.65 |
| equivalent to weight percentage in row | | | | |
| immediately above | | | | |
| Target weight of CoO in electrolyte per | 42.2 | 127.2 | 254.3 | 509.2 |
| reference cell (mg) (density = 6.44 g/cm3) | | | | |
| Weight percent CoO particles in resin coating | 0.04 | 0.14 | 0.28 | 0.55 |
| as a total of separator weight | | | | |
| Weight percent CoO on chopped strand | 0.29 | 0.93 | 1.84 | 3.68 |
| Weight percent CoO particles in resin solution for | 2.67 | 8.49 | 16.73 | 33.46 |
| coating on chopped strand fibers to achieve | | | | |
| weight percent in preceding row, based on 11 | | | | |
| weight percent of resin coating for coated fibers | | | | |
| Volume percent CoO in resin solution | 0.37 | 1.19 | 2.34 | 4.70 |
| Target weight of CuO in electrolyte per | 23.5 | 69.6 | 139.2 | 277.8 |
| reference cell (mg) (density = 6.31 g/cm3) | | | | |
| Weight percent CuO particles in resin coating | 0.02 | 0.08 | 0.15 | 0.30 |
| as a total of separator weight | | | | |
| Weight percent CuO on chopped strand | 0.16 | 0.51 | 1.01 | 2.03 |
| Weight percent CuO particles in resin solution for | 1.46 | 4.61 | 9.21 | 18.42 |
| coating on chopped strand fibers to achieve | | | | |
| weight percent in preceding row, based on 11 | | | | |
| weight percent of resin coating for coated fibers | | | | |
| Volume percent CuO particles in resin solution | 0.21 | 0.66 | 1.32 | 2.64 |
| equivalent to weight percentage in row | | | | |
| immediately above | | | | |
| Target weight of TiO₂ in electrolyte per | 31.4 | 92.7 | 185.5 | 371.0 |
| reference cell (mg) (density = 4.23 g/cm3) | | | | |
| Weight percent TiO₂ particles in resin coating | 0.04 | 0.10 | 0.20 | 0.40 |
| as a total of separator weight | | | | |
| Weight percent TiO₂ on chopped strand | 0.24 | 0.67 | 1.33 | 2.69 |
| Weight percent TiO₂ particles in resin solution for | 2.18 | 6.06 | 12.12 | 24.49 |
| coating on chopped strand fibers to achieve | | | | |
| weight percent in preceding row, based on 11 | | | | |
| weight percent of resin coating for coated fibers | | | | |
| Volume percent TiO₂ particles in resin solution | 0.46 | 1.29 | 2.59 | 5.24 |
| equivalent to weight percentage in row | | | | |
| immediately above | | | | |

e. Resin Coatings on Micro-Glass Fibers—Target Metal Ion Amounts

In addition to chopped strand fibers, other types of glass fibers can also be coated prior to use in making a glass fiber separator. For example, microglass fibers can also make up a sizeable portion of the glass fiber separators that are commonly used in lead-acid batteries (e.g., greater than about 25% by weight, e.g., greater than 85% by weight, 100% by weight). These microglass fibers can therefore also be used as a convenient source of metal ions. Using resin coating methods to deliver metal oxide to microglass fibers can result in a variety of ultimate target metal ion concentrations in the electrolyte. Any of the metal ion concentrations described herein can be achieved depending on the quantity of metal oxide coated on the microglass fibers and the amount of microglass fibers in battery component (e.g., but not limited to a separator). In particular, the resin coating applied will vary based inter alia on the particular microglass fiber, metal ion, target electrolyte concentration of the metal ion and choice of battery component.

The values given below are based on a range of hydrogen shifts (from 10 mV to 120 mV) and the reference cell that was defined previously. For all calculations, it was also assumed that the reference cell contained: (a) 1 liter of 1.3 g/ml density sulfuric acid (i.e., the same as in previous calculations), (b) 92 g of separator (i.e., about 7.7 g per separator), (c) that the coated microglass fibers comprise 100% by weight (though in practice the value can be between 80 and 100% by weight) of the separator, (d) that the metal oxide had 25% availability once coated onto the glass fibers and located in the separator and (e) that the coating comprises about 3% by weight of the coated fiber.

As discussed previously, it is to be understood that the “reference cell basis” values that are provided below using these reference cell assumptions can be readily scaled up or down when different electrolyte volumes or electrolyte strengths are used or when different amounts of separator and/or different amounts of microglass fiber in the separator are used. As in previous sections, our calculations are initially presented for bismuth oxide as the source of metal ion and then for other metal ion sources. Further, as described above for a chopped strand fiber, the calculations to determine target amounts of metal oxide, weight percentage of metal oxide in the separator, and weight percentage in the resin bath are similar, but with two differences. First, in certain embodiments, the separator are made of 100 percent microglass, thus 100 percent coated microglass fibers. Second, the resin coating makes up only 3 percent by weight of the coated fiber, as compared to the examples above. Again, these values are assumed for the calculations below, and can be scaled according to different conditions.

To produce a hydrogen shift of 10 mV, a bismuth target ion concentration of about 14.3 ppm in the electrolyte should be provided (see Table 1). This can be accomplished by adding bismuth oxide particles (e.g., about 90-210 nm average diameter particles) into the resin solution and coating the microglass fibers that are then used in the battery separator such that the separator contains about 0.09 weight percent bismuth oxide (i.e., about 84 mg bismuth oxide). As noted above, the following calculations were made for an embodiment where these microglass fibers account for 100% of the separator weight. A resin bath solution containing about 3.1 weight percent bismuth oxide (or about 0.32 volume percent) can be used to produce coated microglass fibers with the target amount of bismuth oxide. This coating (resin and bismuth oxide) will account for about 3 weight percent of the fiber.

To produce a hydrogen shift of 30 mV, a bismuth target ion concentration of about 43 ppm in the electrolyte should be provided (see Table 1). This can be accomplished by adding bismuth oxide particles (e.g., about 90-210 nm average diameter particles) into the resin solution and coating the microglass fibers that are then used in the battery separator such that the separator contains about 0.27 weight percent bismuth oxide (i.e., about 251 mg bismuth oxide). As noted above, the following calculations were made for an embodiment where these microglass fibers account for 100% of the separator weight. A resin bath solution containing about 9.1 weight percent bismuth oxide (or about 1.00 volume percent) can be used to produce coated microglass fibers with the target amount of bismuth oxide. This coating (resin and bismuth oxide) will still account for about 3 weight percent of the fiber. This would give a coating of the fiber of the same thickness as the 10 mV example but with a higher loading of bismuth oxide.

To produce a hydrogen shift of 60 mV, a bismuth target ion concentration of about 86 ppm in the electrolyte should be provided (see Table 1). This can be accomplished by adding bismuth oxide particles (e.g., about 90-210 nm average diameter particles) into the resin solution and coating the microglass fibers that are then used in the battery separator such that the separator contains about 0.54 weight percent bismuth oxide (i.e., about 501 mg bismuth oxide). As noted above, the following calculations were made for an embodiment where these microglass fibers account for 100% of the separator weight. A resin bath solution containing about 18.13 weight percent bismuth oxide (or about 2.19 volume percent) can be used to produce coated microglass fibers with the target amount of bismuth oxide. This coating (resin and bismuth oxide) will still account for about 3 weight percent of the fiber. This would give a coating of the fiber of the same thickness as the 10 mV example but with a higher loading of bismuth oxide.

To produce a hydrogen shift of 120 mV, a bismuth target ion concentration of about 172 ppm in the electrolyte should be provided (see Table 1). This can be accomplished by adding bismuth oxide particles (e.g., about 90-210 nm average diameter particles) into the resin solution and coating the microglass fibers that are then used in the battery separator such that the separator contains about 1.09 weight percent bismuth oxide (i.e., about 1,004 mg bismuth oxide). As noted above, the following calculations were made for an embodiment where these microglass fibers account for 100% of the separator weight. A resin bath solution containing about 36.40 weight percent bismuth oxide (or about 5.47 volume percent) can be used to produce coated microglass fibers with the target amount of bismuth oxide. This coating (resin and bismuth oxide) will still account for about 3 weight percent of the fiber. This would give a coating of the fiber of the same thickness as the 10 mV example but with a higher loading of bismuth oxide.

The amounts of bismuth oxide at different stages of these Exemplary processes are summarized in Table 6 below. The density of the bismuth oxide is provided in parentheses and was used to calculate the volume percent of particles in the resin solution bath.

TABLE 6
Concentrations of Bismuth Oxide in a Resin Coating on Microglass Fiber
Component of a Battery Separator (Reference Cell)

| | Hydrogen Shift (mV) | | | |
|---|---|---|---|---|
| | 10 | 30 | 60 | 120 |
| Target weight of Bi₂O₃ in electrolyte per | 20.9 | 63 | 125 | 251 |
| reference cell (mg) (density = 8.9 g/cm3) | | | | |
| Target Bi₂O₃ weight (mg) per cell in resin | 84 | 251 | 501 | 1,004 |
| coating to achieve corresponding amount in | | | | |
| electrolyte in row immediately above | | | | |
| Weight percent Bi₂O₃ particles in resin | 0.09 | 0.27 | 0.54 | 1.09 |
| coating as a total of separator weight | | | | |
| Weight percent Bi₂O₃ particles in resin solution | 3.07 | 9.07 | 18.13 | 36.40 |
| for coating on microglass fibers to achieve | | | | |
| weight percent in preceding row, based on 3 | | | | |
| weight percent of resin coating for coated fibers | | | | |
| Volume percent Bi₂O₃ particles in resin solution | 0.32 | 1.00 | 2.19 | 5.47 |
| equivalent to weight percentage in row | | | | |
| immediately above | | | | |

Other metal oxide particles can be added into the resin solution bath instead of bismuth oxide particles. Exemplary amounts needed for different hydrogen shifts are outlined in Table 7 below. The densities of the metal oxides are provided in parentheses and were used to calculate the volume percent of particles in the resin solution bath.

TABLE 7
Concentrations of Various Oxides in a Resin Coating on Microglass Fiber
Component of a Battery Separator (Reference Cell)

| | Hydrogen Shift (mV) | | | |
|---|---|---|---|---|
| | 10 | 30 | 60 | 120 |
| Target weight of NiO₂ in electrolyte per | 18.6 | 54.6 | 109.1 | 217.6 |
| reference cell (mg) (6.72 g/cm3) | | | | |
| Weight percent NiO₂ particles in resin | 0.02 | 0.06 | 0.12 | 0.24 |
| coating as a total of separator weight | | | | |
| Weight Percent NiO₂ particles in resin | 0.67 | 2.00 | 4.00 | 7.87 |
| solution for coating on microglass fibers to | | | | |
| achieve weight percent in preceding row, | | | | |
| based on 3 weight percent of resin coating for | | | | |
| coated fibers | | | | |
| Volume Percent NiO₂ particles in resin | 0.09 | 0.27 | 0.56 | 1.13 |
| solution equivalent to weight percentage in row | | | | |
| immediately above | | | | |
| Target weight of SnO₂ in electrolyte per | 15.2 | 44.7 | 89.9 | 179.8 |
| reference cell (mg) (6.85 g/cm3) | | | | |
| Weight percent SnO₂ particles in resin | 0.02 | 0.05 | 0.10 | 0.20 |
| coating as a total of separator weight | | | | |
| Weight percent SnO₂ particles in resin | 0.53 | 1.60 | 3.20 | 6.53 |
| solution for coating on microglass fibers to | | | | |
| achieve weight percent in preceding row, | | | | |
| based on 3 weight percent of resin coating | | | | |
| for coated fibers | | | | |
| Volume Percent SnO₂ particles in resin | 0.07 | 0.21 | 0.43 | 0.91 |
| solution equivalent to weight percentage in | | | | |
| row immediately above | | | | |
| Target weight of Sb₂O₃ in electrolyte per | 28.7 | 85.2 | 171.4 | 342.4 |
| reference cell (mg) (5.58 g/cm3) | | | | |
| Weight percent Sb₂O₃ particles in resin | 0.03 | 0.09 | 0.19 | 0.37 |
| coating as a total of separator weight | | | | |
| Weight percent Sb₂O₃ particles in resin | 1.07 | 3.07 | 6.27 | 12.40 |
| solution for coating on microglass fibers to | | | | |
| achieve weight percent in preceding row, | | | | |
| based on 3 weight percent of resin coating | | | | |
| for coated fibers | | | | |
| Volume Percent Sb₂O₃ particles in resin | 0.17 | 0.51 | 1.07 | 2.23 |
| solution equivalent to weight percentage in | | | | |
| row immediately above | | | | |
| Target weight of CoO in electrolyte per | 42.2 | 127.2 | 254.3 | 509.2 |
| reference cell (mg) (6.44 g/cm3) | | | | |
| Weight percent CoO particles in resin | 0.04 | 0.14 | 0.28 | 0.55 |
| coating as a total of separator weight | | | | |
| Weight percent CoO particles in resin | 1.47 | 4.67 | 9.20 | 18.40 |
| solution for coating on microglass fibers to | | | | |
| achieve weight percent in preceding row, | | | | |
| based on 3 weight percent of resin coating | | | | |
| for coated fibers | | | | |
| Volume Percent CoO particles in resin | 0.21 | 0.68 | 1.40 | 3.06 |
| solution equivalent to weight percentage in | | | | |
| row immediately above | | | | |
| Target weight of CuO in electrolyte per | 23.5 | 69.6 | 139.2 | 277.8 |
| reference cell (mg) (6.31 g/cm3) | | | | |
| Weight percent CuO particles in resin | 0.02 | 0.08 | 0.15 | 0.30 |
| coating as a total of separator weight | | | | |
| Weight percent CuO particles in resin | 0.80 | 2.53 | 5.07 | 10.13 |
| solution for coating on microglass fibers to | | | | |
| achieve weight percent in preceding row, | | | | |
| based on 3 weight percent of resin coating | | | | |
| for coated fibers | | | | |
| Volume Percent CuO particles in resin | 0.12 | 0.37 | 0.76 | 1.58 |
| solution equivalent to weight percentage in | | | | |
| row immediately above | | | | |
| Target weight of TiO₂ in electrolyte per | 31.4 | 92.7 | 185.5 | 371.0 |
| reference cell (mg) (4.23 g/cm3) | | | | |
| Weight percent TiO₂ particles in resin | 0.04 | 0.10 | 0.20 | 0.40 |
| coating as a total of separator weight | | | | |
| Weight percent TiO₂ particles in resin | 1.20 | 3.33 | 6.67 | 13.47 |
| solution for coating on microglass fibers to | | | | |
| achieve weight percent in preceding row, | | | | |
| based on 3 weight percent of resin coating | | | | |
| for coated fibers | | | | |
| Volume Percent TiO₂ particles in resin | 0.26 | 0.73 | 1.50 | 3.21 |
| solution equivalent to weight percentage in | | | | |
| row immediately above | | | | |

### 7. Metal Ion Sources—Metal Oxide Coatings

As noted above, in other embodiments of the first aspect, a coating of metal oxide is coated on the surface of a battery component by chemical vapor deposition (e.g., metal organic CVD, plasma enhanced CVD, combustion CVD), by sputter deposition, by thermal spraying (e.g., flame spraying, plasma spraying), etc. The coating of metal oxide then serves as the source of metal ions. As discussed in more detail below, in certain embodiments, the battery component is an electrode plate, a battery case, a separator, pasting paper, an electrode grid, etc. Upon exposure to the internal battery environment, the electrolyte (e.g., sulfuric acid) will leach the metal ions from the metal oxide in the coating.

a. Metal Oxide Coatings on Battery Components—Chemical Vapor Deposition

In some embodiments, the metal oxide coating is created on the surface of a battery component (e.g., pasting paper, separator, battery case, etc.) surface by chemical vapor deposition (“CVD”). CVD is a commonly used process to produce thin films in the field of semiconductor processing (e.g., nanometer scale, though some coatings can be microns thick). In some CVD embodiments, the coating can be up to about 1, 2, 3, 4 or even 5 microns in thickness. In some embodiments the coating is less than 1 micron in thickness. In some embodiments the coating thickness is in the range of about 10 nm to about 100 nm, e.g., about 50 nm to about 100 nm, about 50 nm to about 1000 nm, about 100 nm to about 1000 nm, about 500 nm to about 1000 nm, about 500 nm to about 2000 nm, about 1000 nm to about 2000 nm, about 1000 nm to about 3000 nm, about 1000 nm to about 4000 nm, about 2000 nm to about 4000 nm or about 3000 nm to about 5000 nm.

In a typical CVD process a substrate (e.g. battery component) is placed in a reaction chamber where it is exposed to one or more volatile precursors which react and/or decompose on the surface of the substrate to produce the desired deposit (e.g., a coating of metal oxide). By-products produced by the process are removed by inert gas flow through the reaction chamber.

CVD processes operate at a variety of pressures ranging from atmospheric to ultrahigh vacuum (e.g., 10⁻⁸ torr). CVD processes may also involve a variety of vapors of precursors, including aerosol assisted vapors in which the precursor is transported by means of a liquid-gas aerosol. In other instances, direct liquid injection is used in which the precursors in liquid form are injected to a vaporization chamber, where they vaporize and are then transported to the substrate for reaction/deposition.

CVD processes may also involve the use of plasma. The plasma can enhance chemical reaction rates of the precursors and may reduce the overall temperatures required for the depositions. Some plasma assisted CVD methods can be performed at room temperature (e.g., remote plasma-enhanced CVD).

Other methods of CVD that can be employed to coat battery components include, but are not limited to, atom layer CVD, combustion CVD, hot wire CVD, metalorganic CVD, hybrid physical-chemical CVD, rapid thermal CVD and vapor phase epitaxy.

In some embodiments, metal organic CVD (“MOCVD”) is used to create the metal oxide coating on a battery component. Generally, MOCVD is a thin film generation method that uses the reaction of organic compounds (i.e., metalorganics and/or metal hydrides) which react on the surface of the substrate to be coated. MOCVD techniques are typically performed under vacuum with an inert atmosphere (e.g., about 0.2 torr) and at elevated temperature (e.g., about 400° C.). The temperature varies depending on the metalorganic source and the desired product.

The metalorganic compound is present in a vessel, called a bubbler. In some embodiments, an inert carrier gas (e.g., argon) is bubbled through the metalorganic compound, though a reactive gas (e.g., O₂ or H₂) can also be used as the carrier gas. The metalorganic compound is usually a liquid. The metalorganic is carried by the gas to the reaction chamber. Oxygen or hydrogen are mixed with the metalorganic gas in the reaction chamber. The metalorganic and the added gas react at the substrate's surface to form a thin layer of the metal hydride or metal oxide.

In some embodiments, the metalorganic compound is a methylated metal. In some embodiments, the metal organic compound is a trimethyl compound, e.g., trimethyl bismuth, trimethyl antimony, trimethyl tin. In some embodiments, the metalorganic is a triisopropyl compound.

The MOCVD process, in some embodiments, can lead to the production of metal oxide nanowires, as opposed to the continuous thin layers described above. The nanowires can have a diameter ranging from about 30 nm to about 90 nm, e.g., about 30 nm to about 70 nm, about 30 nm to about 50 nm, about 50 nm to about 90 nm, about 50 nm to about 70 nm. The length of the nanowires can be as much as several micrometers. Typically, the surface to be coated with nanowires is first coated with a thin layer of sputtered gold.

b. Metal Oxide Coatings on Battery Components—Sputter Deposition

In some embodiments, sputter deposition is used to create the metal oxide coatings on a battery component. Sputter deposition, also well known, involves the use of a target containing the material to be deposited on the substrate. Ions are ejected from the target (e.g., by bombardment or excitation) and these ions are then deposited on the substrate to form the coating. The ions may diffuse to the substrate after ejection or may be a projectile (i.e., travel in a straight line) and impact the substrate. Variations in temperature, pressure and materials used in the sputter deposition process modify the method of transport of ions within the reaction chamber. For example most efficient sputtering involves a sputtering gas with an atomic weight similar to that of the ejected ions.

In some embodiments, an inert gas is used in the sputtering process. In some embodiments, a reactive gas is used. When a reactive gas is used the ejected ions may react with the gas, either on the target surface (i.e., at ejection), in flight, or at the surface of the substrate. The composition of the resulting coating on the substrate can be controlled by varying the pressures of the inert and reactive gases.

Known sputter deposition processes applicable to the present invention include, but are not limited to ion-beam sputtering, reactive sputtering, ion-assisted deposition, high target utilization sputtering, high power impulse magnetron sputtering and gas flow sputtering.

c. Metal Oxide Coatings on Battery Components—Thermal Spraying

Thermal spraying techniques can also be used to produce coatings on battery components. As compared to CVD techniques described above, thermal spraying techniques can provide thicker coatings (e.g., up to about 15 millimeters) over larger areas in a shorter amount of time. Deposition rates for thermal spraying techniques can be up to about 60 kilograms per hour. Thermal spraying also affords a wider variety of materials that can be sprayed onto a substrate, including but not limited to metals, alloys, ceramics, plastics and composites. Typically, coating materials are fed to a spraying device in powder or wire form, heated to a molten or semi-molten state and accelerated toward the substrate. The spray is composed of many micrometer sized particles and the resulting coating is formed by accumulation of these particles. Although the spraying device may require heat, either from combustion or an electrical source, the substrate does not experience a substantial temperature increase.

In some embodiments, the spraying methods include, but are not limited to, plasma spraying, flame spraying, detonation spraying, wire arc spraying, high velocity oxy-fuel coating spraying, warm spraying and cold spraying.

In some embodiments, plasma spraying techniques are used to coat the battery component. In plasma spraying, the coating material is provided as a wire, powder, liquid or suspension. The plasma source is typically a plasma torch, which uses an electric arc to create a plasma from gas forced through a nozzle. The plasma forms as the gas exits the nozzle.

The feed is introduced into the plasma. The temperature of the jet can be as high as 10,000 K, which causes the material to melt, form droplets and propels the material to the substrate. Upon impact with the substrate, the coating materials flatten and cool, forming a deposited coating. The processes can be varied and controlled by changing the plasma temperature, coating material, distance between the substrate and the plasma torch, flow rates and cooling rates.

Plasma spraying includes several variations which are applicable to coating battery components. These can be based on classification of the method of plasma jet generation (e.g., direct current, induction), the plasma forming medium (e.g., gas stabilized plasma, water stabilized plasma, or hybrid), and the spraying equipment (e.g., air plasma spraying, control atmosphere plasma spraying, high pressure plasma spraying and underwater plasma spraying). Plasma spraying may also include vacuum plasma spraying.

In flame spraying or spray pyrolysis techniques, the heat from the plasma is replaced by the combustion of fuel, typically, oxygen and a gas fuel (e.g., acetylene, propane). The heat from combustion melts the feed material, and the jet from combustion, or a jet from other compressed gases forms droplets and propels the melted coating material to the substrate. The feed material can be either a powder or a wire fed directing to the flame. If the feed material is a powder, it may be carried to the combustion nozzle by compressed air or an inert gas, though in some embodiments the powder is transported to the combustion nozzle by the venture effect of the combustion gas fuel and/or oxygen. In wire feed processes the wire material is fed through the center of a combustion nozzle. The combustion heats the wire and the combustion gases accelerate the melted wire particles to the substrate. This process may be aided by compressed air being fed to or around the nozzle, which aides in atomizing the melted wire particles.

Flame spraying processes can be varied and controlled by changing the combustion temperature, gas and feed flow rates and distance between the combustion nozzle and the substrate. Changes in process variables can result in changes in the coating quality, coating rate and bonding strength.

d. Metal Oxide Coatings on Battery Components—Target Amount in Reference Cell

Using thin film methods (e.g., CVD, MOCVD, sputter deposition) or thermal spraying methods (e.g., plasma or spray pyrolysis) to deliver metal oxide to battery components can result in a variety of ultimate target metal ion concentrations in the electrolyte. Any of the metal ion concentrations described above can be achieved depending on the quantity of metal oxide applied to the battery component. The composition and dimensions of the metal oxide coatings applied will vary inter alia based on the metal ion, the target electrolyte concentration of the metal ion and the choice of battery component.

The values given below are based on a reference lead-acid battery cell and can be scaled for non-reference cell sized and multiplied for multi-cell batteries. The description below is exemplary of a typical cell and target concentrations. The values given below are based on a range of hydrogen shifts (from 10 mV to 120 mV) and the reference cell that was defined previously. For all calculations, it was also assumed that the reference cell contained: (a) 1 liter of 1.3 g/ml density sulfuric acid (i.e., the same as in previous calculations), (b) 92 g of separator (i.e., about 7.7 g per separator) and (c) that the metal oxide had 100% availability once coated onto the battery component and located in the battery.

To produce a hydrogen shift of 10 mV, a bismuth target ion concentration of about 14.3 ppm in the electrolyte should be provided. This can be accomplished by coating a battery component with a bismuth oxide coating such that about 20.9 mg of bismuth oxide is present in a given cell. The coating depth in microns to provide the adequate amount required for the various components will depend on the available surface area. For example, while about 0.04 microns of a bismuth oxide coating might be needed to provide about 20.9 mg of bismuth oxide when the inside of a reference battery case is being coated (91 inches² or 587 cm² of available surface area), a coating of about 0.004 microns would be needed when the electrode plates are being coated (936 inches² or 6,039 cm² of available surface area), and a coating of about 0.004 microns would be needed when the separators are being coated (864 inches² or 5,574 cm² of available surface area). In this example, the 0.04 micron coating thickness was calculated by first determining the volume of metal oxide based on the target weight (20.9 mg) and the density of the oxide. This volume is then converted to a thickness based on the surface area of the component to be coated. Equation 16 below provides the method for calculation.

T=Y*(1/D)*(1/A)*10000 Eqn. 16
where T is the thickness (in micron), Y is the target weight of metal oxide (in mg); D is density (in g/cm³); and A (in cm²) is the surface area of the component. The result is multiplied by 10000 to convert centimeters to microns. It is to be appreciated that the units of measure should be factored to provide consistent values (e.g., conversions of milligrams to grams and centimeters to microns, as necessary).

To provide a hydrogen shift of 30 mV, a bismuth target ion concentration of about 43 ppm in the electrolyte should be provided. This can be accomplished by coating a battery component with a bismuth oxide coating such that about 56 mg of bismuth oxide per cell is added to the battery to leach into the electrolyte. Again, the coating depth will vary based on the component selected, for example, about 0.11 microns of a bismuth oxide coating might be needed to provide about 56 mg of bismuth oxide when the inside of a reference battery case is being coated (91 inches² or 587 cm² of available surface area), a coating of about 0.01 microns would be needed when the electrode plates are being coated (936 inches² or 6,039 cm² of available surface area), and a coating of about 0.01 microns would be needed when the separators are being coated (864 inches² or 5,574 cm² of available surface area).

To provide a hydrogen shift of 60 mV, a bismuth target ion concentration of about 86 ppm in the electrolyte should be provided. This can be accomplished by coating a battery component with a bismuth oxide coating such that about 125 mg of bismuth oxide per cell are added to the battery to leach into the electrolyte. Again, the coating depth will vary based on the component selected, for example, about 0.24 microns of a bismuth oxide coating might be needed to provide about 125 mg of bismuth oxide when the inside of a reference battery case is being coated (91 inches² or 587 cm² of available surface area), a coating of about 0.02 microns would be needed when the electrode plates are being coated (936 inches² or 6,039 cm² of available surface area), and a coating of about 0.02 microns would be needed when the separators are being coated (864 inches² or 5,574 cm² of available surface area).

To provide a hydrogen shift of 120 mV, a bismuth target ion concentration of about 172 ppm in the electrolyte should be provided. This can be accomplished by coating a battery component with a bismuth oxide coating such that about 251 mg of bismuth oxide per cell are added to the battery to leach into the electrolyte. Again, the coating depth will vary based on the component selected, for example, about 0.48 microns of a bismuth oxide coating might be needed to provide about 251 mg of bismuth oxide when the inside of a reference battery case is being coated (91 inches² or 587 cm² of available surface area), a coating of about 0.05 microns would be needed when the electrode plates are being coated (936 inches² or 6,039 cm² of available surface area), and a coating of about 0.05 microns would be needed when the separators are being coated (864 inches² or 5,574 cm² of available surface area).

TABLE 8
Amount and Coating Depths of Bismuth Oxide, per
reference cell, in a metal oxide coating

| | Hydrogen Shift (mV) | | | |
|---|---|---|---|---|
| | 10 | 30 | 60 | 120 |
| Target amount of Bi₂O₃ (mg) (8.9 g/cm3) | 20.9 | 56 | 125 | 251 |
| Weight percent of Bi₂O₃ to provide target amount | 0.02 | 0.06 | 0.14 | 0.27 |
| of oxide in immediately preceding row, in a | | | | |
| separator assuming a weight of 92 g for the | | | | |
| separator | | | | |
| Coating depth on a reference battery container to | 0.04 | 0.11 | 0.24 | 0.48 |
| provide target amount (from above) of metal | | | | |
| oxide. | | | | |
| Coating depth on the reference battery plates to | 0.004 | 0.01 | 0.02 | 0.05 |
| provide target amount (from above) of metal | | | | |
| oxide. | | | | |
| Coating depth on a reference battery separator to | 0.004 | 0.01 | 0.02 | 0.05 |
| provide target amount (from above) of metal | | | | |
| oxide. | | | | |

Other metal oxide particles can produce a hydrogen shift of 10, 30, 60 and 120 mV in place of the bismuth oxide particles as outlined in Table 9 below.

TABLE 9
Amount and Coating Depths of Various Metal Oxides, per cell, in a Coating

| | Hydrogen Shift (mV) | | | |
|---|---|---|---|---|
| | 10 | 30 | 60 | 120 |
| Target amount of NiO₂ (mg) (6.72 g/cm3) | 4.6 | 13.6 | 27.3 | 54.4 |
| Weight percent of NiO₂ to provide target amount | 0.005% | 0.02% | 0.03% | 0.06% |
| of oxide in immediately preceding row, in a | | | | |
| separator assuming a weight of 92 g for the | | | | |
| separator | | | | |
| Coating depth on a reference battery container to | 0.01 | 0.03 | 0.07 | 0.14 |
| provide target amount (from above) of metal oxide. | | | | |
| Coating depth on the reference battery plates to | 0.001 | 0.003 | 0.01 | 0.01 |
| provide target amount (from above) of metal oxide. | | | | |
| Coating depth on a reference battery separator to | 0.001 | 0.003 | 0.01 | 0.01 |
| provide target amount (from above) of metal oxide. | | | | |
| Target amount of SnO₂ (mg) (6.85 g/cm3) | 3.8 | 11.2 | 22.5 | 44.9 |
| Weight percent of SnO₂ to provide target amount | 0.004% | 0.01% | 0.02% | 0.05% |
| of oxide in immediately preceding row, in a | | | | |
| separator assuming a weight of 92 g for the | | | | |
| separator | | | | |
| Coating depth on a reference battery container to | 0.01 | 0.03 | 0.06 | 0.11 |
| provide target amount (from above) of metal oxide. | | | | |
| Coating depth on the reference battery plates to | 0.001 | 0.003 | 0.006 | 0.01 |
| provide target amount (from above) of metal oxide. | | | | |
| Coating depth on a reference battery separator to | 0.001 | 0.003 | 0.006 | 0.01 |
| provide target amount (from above) of metal oxide. | | | | |
| Target amount of Sb₂O₃ (mg) (5.58 g/cm3) | 7.2 | 21.3 | 42.9 | 85.6 |
| Weight percent of Sb₂O₃ to provide target amount | 0.008% | 0.02% | 0.05% | 0.09% |
| of oxide in immediately preceding row, in a | | | | |
| separator assuming a weight of 92 g for the | | | | |
| separator | | | | |
| Coating depth on a reference battery container to | 0.02 | 0.07 | 0.13 | 0.26 |
| provide target amount (from above) of metal oxide. | | | | |
| Coating depth on the reference battery plates to | 0.002 | 0.006 | 0.01 | 0.03 |
| provide target amount (from above) of metal oxide. | | | | |
| Coating depth on a reference battery separator to | 0.002 | 0.006 | 0.01 | 0.03 |
| provide target amount (from above) of metal oxide. | | | | |
| Target amount of CoO (mg) (6.44 g/cm3) | 10.6 | 31.8 | 63.6 | 127.3 |
| Weight percent of CoO to provide target amount of | 0.011% | 0.04% | 0.07% | 0.14% |
| oxide in immediately preceding row, in a separator | | | | |
| assuming a weight of 92 g for the separator | | | | |
| Coating depth on a reference battery container to | 0.03 | 0.08 | 0.17 | 0.34 |
| provide target amount (from above) of metal oxide. | | | | |
| Coating depth on the reference battery plates to | 0.003 | 0.01 | 0.02 | 0.03 |
| provide target amount (from above) of metal oxide. | | | | |
| Coating depth on a reference battery separator to | 0.003 | 0.01 | 0.02 | 0.03 |
| provide target amount (from above) of metal oxide. | | | | |
| Target amount of CuO (mg) (6.31 g/cm3) | 5.9 | 17.4 | 34.8 | 69.5 |
| Weight percent of CuO to provide target amount of | 0.006% | 0.02% | 0.04% | 0.08% |
| oxide in immediately preceding row, in a separator | | | | |
| assuming a weight of 92 g for the separator | | | | |
| Coating depth on a reference battery container to | 0.02 | 0.05 | 0.09 | 0.19 |
| provide target amount (from above) of metal oxide. | | | | |
| Coating depth on the reference battery plates to | 0.002 | 0.005 | 0.01 | 0.02 |
| provide target amount (from above) of metal oxide. | | | | |
| Coating depth on a reference battery separator to | 0.002 | 0.005 | 0.01 | 0.02 |
| provide target amount (from above) of metal oxide. | | | | |
| Target amount of TiO₂ (mg) (4.23 g/cm3) | 7.8 | 23.2 | 46.4 | 92.7 |
| Weight percent of TiO₂ to provide target amount of | 0.009% | 0.03% | 0.05% | 0.10% |
| oxide in immediately preceding row, in a separator | | | | |
| assuming a weight of 92 g for the separator | | | | |
| Coating depth on a reference battery container to | 0.03 | 0.09 | 0.19 | 0.37 |
| provide target amount (from above) of metal oxide. | | | | |
| Coating depth on the reference battery plates to | 0.003 | 0.01 | 0.02 | 0.04 |
| provide target amount (from above) of metal oxide. | | | | |
| Coating depth on a reference battery separator to | 0.003 | 0.01 | 0.02 | 0.04 |
| provide target amount (from above) of metal oxide. | | | | |

In the following sections we provide some exemplary ranges of amounts of different metal oxides that can be added on a reference cell basis (as defined above). It will be appreciated that these ranges can be scaled downward for cells that are smaller than a reference cell or upward for cells that are larger than a reference cell (based on the relative electrolyte volumes).

In some embodiments, the metal oxide is bismuth, and the amount of metal oxide added on a reference cell basis (as defined above) by the oxide coating is in the range of about 20.9 mg to about 251.0 mg, about 20.9 mg to about 61.0 mg, about 20.9 mg to about 125.0 mg, about 61.0 mg to about 125.0 mg, about 61.0 mg to about 251.0 mg or about 125.0 mg to about 251.0 mg.

In some embodiments, the metal oxide is nickel, and the amount of metal oxide added on a reference cell basis (as defined above) by the oxide coating is in the range of about 4.6 mg to about 54.4 mg, about 4.6 mg to about 13.6 mg, about 4.6 mg to about 27.3 mg, about 13.6 mg to about 27.3 mg, about 13.6 mg to about 54.4 mg or about 27.3 mg to about 54.4 mg.

In some embodiments, the metal oxide is tin, and the amount of metal oxide added on a reference cell basis (as defined above) by the oxide coating is in the range of about 3.8 mg to about 44.9 mg, about 3.8 mg to about 11.2 mg, about 3.8 mg to about 22.5 mg, about 11.2 mg to about 22.5 mg, about 11.2 mg to about 44.9 mg or about 22.5 mg to about 44.9 mg.

In some embodiments, the metal oxide is antimony, and the amount of metal oxide added on a reference cell basis (as defined above) by the oxide coating is in the range of about 7.2 mg to about 85.6 mg, about 7.2 mg to about 21.3 mg, about 7.2 mg to about 42.9 mg, about 21.3 mg to about 42.9 mg, about 21.3 mg to about 85.6 mg or about 42.9 mg to about 85.6 mg.

In some embodiments, the metal oxide is cobalt, and the amount of metal oxide added on a reference cell basis (as defined above) by the oxide coating is in the range of about 10.6 mg to about 127.3 mg, about 10.6 mg to about 31.8 mg, about 10.6 mg to about 63.6 mg, about 31.8 mg to about 63.6 mg, about 31.8 mg to about 127.3 mg or about 63.6 mg to about 127.3 mg.

In some embodiments, the metal oxide is copper, and the amount of metal oxide added on a reference cell basis (as defined above) by the oxide coating is in the range of about 5.9 mg to about 69.5 mg, about 5.9 mg to about 17.4 mg, about 5.9 mg to about 34.8 mg, about 17.4 mg to about 34.8 mg, about 17.4 mg to about 69.5 mg or about 34.8 mg to about 69.5 mg.

In some embodiments, the metal oxide is titanium, and the amount of metal oxide added on a reference cell basis (as defined above) by the oxide coating is in the range of about 7.8 mg to about 92.7 mg, about 7.8 mg to about 23.2 mg, about 7.8 mg to about 46.4 mg, about 23.2 mg to about 46.4 mg, about 23.2 mg to about 92.7 mg or about 46.4 mg to about 92.7 mg.

e. Metal Oxide Coatings on Battery Components—Target Amount in Low Plate Count Battery

In some embodiments, the lead acid battery has a low-plate count, e.g., the battery has 9 electrode plates as opposed to the 12 plates in the reference cell described previously. It is to be understood alternative batteries with low plate count may include as few as 4, 5, 6, 7, 8, 9, 10 or 11 plates. The lower plate count results in a change in the quantity of electrolyte and mass of the separator per cell, and thus changes the amount of metal oxide required to achieve a particular concentration of metal ions in the electrolyte. In one embodiment, the separator in a low plate count battery has a mass of 129 grams and the cell contains 1.24 liters of sulfuric acid. As described above, the sulfuric acid has a density of 1.3 g/ml.

The dimensions of a typical cell in a low plate count battery are the same as described above: the case confining the cell measures 7″×6.5″×2″ resulting in an interior surface area of 91 inches² or 587 cm² for coating the container. Each battery cell contains only nine plates, which measure 6″×6″ (36 inches² on each side of the electrode plate). The plates are spaced with a 6″×6″ separator (36 inches²). Contact surface area of the plates would be 36 inches²×9 plates×2 surfaces=648 inches² or 4181 cm². The surface area of the separators would be 36 inches²×8 separators×2 surfaces=576 inches² or 3716 cm².

As in previous sections, our calculations are initially presented for bismuth oxide as the source of metal ion and then for other metal ion sources.

To produce a hydrogen shift of 10 mV, a bismuth target ion concentration of about 14.3 ppm in the electrolyte should be provided. This can be accomplished by coating a battery component with a bismuth oxide coating such that about 23.1 mg of bismuth oxide is present in a given cell with the larger quantity of electrolyte (1.24 liters). Determining the target amount of bismuth oxide is similar to the process outlined in Equation 12, however, the different volume of the reference cell changes the calculation, by adding a multiplier of 1.24 to account for the larger cell volume. Equation 12 is therefore modified to:

Y=1.3*1.24*X*(molar mass of metal oxide/molar mass of metal ion) Eqn. 17

where Y is the target weight (in mg), X is the target concentration (in ppm), 1.3 is the density of the solution (in g/ml), and 1.24 is the volume of the cell (in liters).

The coating depth in microns to provide the adequate amount required for the various components will depend on the available surface area. For example, about 0.05 microns of a bismuth oxide coating might be needed to provide about 26.0 mg of bismuth oxide when the inside of a reference battery case is being coated (91 inches² or 587 cm² of available surface area), a coating of about 0.007 microns would be needed when the electrode plates are being coated (648 inches² or 4181 cm² of available surface area), and a coating of about 0.008 microns would be needed when the separators are being coated (576 inches² or 3716 cm² of available surface area).

To provide a hydrogen shift of 30 mV, a bismuth target ion concentration of about 43 ppm in the electrolyte should be provided. This can be accomplished by coating a battery component with a bismuth oxide coating such that about 77.9 mg of bismuth oxide per cell is added to the battery to leach into the electrolyte. Again, the coating depth will vary based on the component selected, for example, about 0.15 microns of a bismuth oxide coating might be needed to provide about 77.9 mg of bismuth oxide when the inside of a reference battery case is being coated (91 inches² or 587 cm² of available surface area), a coating of about 0.02 microns would be needed when the electrode plates are being coated (648 inches² or 4181 cm² of available surface area), and a coating of about 0.02 microns would be needed when the separators are being coated (576 inches² or 3716 cm² of available surface area).

To provide a hydrogen shift of 60 mV, a bismuth target ion concentration of about 86 ppm in the electrolyte should be provided. This can be accomplished by coating a battery component with a bismuth oxide coating such that about 155.4 mg of bismuth oxide per cell are added to the battery to leach into the electrolyte. Again, the coating depth will vary based on the component selected, for example, about 0.30 microns of a bismuth oxide coating might be needed to provide about 155.4 mg of bismuth oxide when the inside of a reference battery case is being coated (91 inches² or 587 cm² of available surface area), a coating of about 0.04 microns would be needed when the electrode plates are being coated (648 inches² or 4181 cm² of available surface area), and a coating of about 0.05 microns would be needed when the separators are being coated (576 inches² or 3716 cm² of available surface area).

To provide a hydrogen shift of 120 mV, a bismuth target ion concentration of about 172 ppm in the electrolyte should be provided. This can be accomplished by coating a battery component with a bismuth oxide coating such that about 311.1 mg of bismuth oxide per cell are added to the battery to leach into the electrolyte. Again, the coating depth will vary based on the component selected, for example, about 0.60 microns of a bismuth oxide coating might be needed to provide about 311.1 mg of bismuth oxide when the inside of a reference battery case is being coated (91 inches² or 587 cm² of available surface area), a coating of about 0.08 microns would be needed when the electrode plates are being coated (648 inches² or 4181 cm² of available surface area), and a coating of about 0.09 microns would be needed when the separators are being coated (576 inches² or 3716 cm² of available surface area).

TABLE 10
Amount and Coating Depths of Bismuth Oxide for a Low Plate
Count Battery in Bismuth Oxide Coating (Non-Reference Cell)

| | Hydrogen Shift (mV) | | | |
|---|---|---|---|---|
| | 10 | 30 | 60 | 120 |
| Target amount of Bi₂O₃ (mg) | 26.0 | 77.9 | 155.4 | 311.1 |
| (8.9 g/cm3) | | | | |
| Weight percent of Bi₂O₃ to | 0.02% | 0.06% | 0.12% | 0.24% |
| provide target amount of oxide in | | | | |
| immediately preceding row, in a | | | | |
| separator assuming a weight of | | | | |
| 92 g for the separator | | | | |
| Coating depth on a reference | 0.05 | 0.15 | 0.30 | 0.60 |
| battery container to provide | | | | |
| target amount (from above) of | | | | |
| metal oxide. | | | | |
| Coating depth on the reference | 0.007 | 0.02 | 0.04 | 0.08 |
| battery plates to provide target | | | | |
| amount (from above) of metal | | | | |
| oxide. | | | | |
| Coating depth on a reference | 0.008 | 0.02 | 0.05 | 0.09 |
| battery separator to provide | | | | |
| target amount (from above) of | | | | |
| metal oxide. | | | | |

Other metal oxide particles can produce a hydrogen shift of 10, 30, 60 and 120 mV in place of the bismuth oxide particles as outlined in Table 11 below.

TABLE 11
Amount and Coating Depths of Various Metal Oxides for a Low
Plate Count Battery in Metal Oxide Coating (Non-Reference Cell)

| | Hydrogen Shift (mV) | | | |
|---|---|---|---|---|
| | 10 | 30 | 60 | 120 |
| Target amount of NiO₂ (mg) (6.72 g/cm3) | 5.7 | 16.9 | 33.8 | 67.4 |
| Weight percent of NiO₂ to provide target | 0.004 | 0.01 | 0.03 | 0.05 |
| amount of oxide in immediately preceding | | | | |
| row, in a separator assuming a weight of 92 g | | | | |
| for the separator | | | | |
| Coating depth on a reference battery container | 0.015 | 0.04 | 0.09 | 0.17 |
| to provide target amount (from above) of | | | | |
| metal oxide. | | | | |
| Coating depth on the reference battery plates | 0.002 | 0.006 | 0.01 | 0.02 |
| to provide target amount (from above) of | | | | |
| metal oxide. | | | | |
| Coating depth on a reference battery separator | 0.002 | 0.007 | 0.01 | 0.03 |
| to provide target amount (from above) of | | | | |
| metal oxide. | | | | |
| Target amount of SnO₂ (mg) (6.85 g/cm3) | 4.7 | 13.8 | 27.8 | 55.7 |
| Weight percent of SnO₂ to provide target | 0.004 | 0.01 | 0.02 | 0.04 |
| amount of oxide in immediately preceding | | | | |
| row, in a separator assuming a weight of 92 g | | | | |
| for the separator | | | | |
| Coating depth on a reference battery container | 0.012 | 0.03 | 0.07 | 0.14 |
| to provide target amount (from above) of | | | | |
| metal oxide. | | | | |
| Coating depth on the reference battery plates | 0.002 | 0.005 | 0.01 | 0.02 |
| to provide target amount (from above) of | | | | |
| metal oxide. | | | | |
| Coating depth on a reference battery separator | 0.002 | 0.005 | 0.01 | 0.02 |
| to provide target amount (from above) of | | | | |
| metal oxide. | | | | |
| Target amount of Sb₂O₃ (mg) (5.58 g/cm3) | 8.9 | 26.5 | 53.1 | 106.2 |
| Weight percent of Sb₂O₃ to provide target | 0.007 | 0.02 | 0.04 | 0.08 |
| amount of oxide in immediately preceding | | | | |
| row, in a separator assuming a weight of 92 g | | | | |
| for the separator | | | | |
| Coating depth on a reference battery container | 0.03 | 0.08 | 0.16 | 0.32 |
| to provide target amount (from above) of | | | | |
| metal oxide. | | | | |
| Coating depth on the reference battery plates | 0.004 | 0.01 | 0.02 | 0.05 |
| to provide target amount (from above) of | | | | |
| metal oxide. | | | | |
| Coating depth on a reference battery separator | 0.004 | 0.01 | 0.03 | 0.05 |
| to provide target amount (from above) of | | | | |
| metal oxide. | | | | |
| Target amount of CoO (mg) (6.44 g/cm3) | 13.1 | 39.4 | 78.8 | 157.8 |
| Weight percent of CoO to provide target | 0.01 | 0.03 | 0.06 | 0.12 |
| amount of oxide in immediately preceding | | | | |
| row, in a separator assuming a weight of 92 g | | | | |
| for the separator | | | | |
| Coating depth on a reference battery container | 0.04 | 0.10 | 0.21 | 0.42 |
| to provide target amount (from above) of | | | | |
| metal oxide. | | | | |
| Coating depth on the reference battery plates | 0.005 | 0.02 | 0.03 | 0.06 |
| to provide target amount (from above) of | | | | |
| metal oxide. | | | | |
| Coating depth on a reference battery separator | 0.005 | 0.02 | 0.03 | 0.07 |
| to provide target amount (from above) of | | | | |
| metal oxide. | | | | |
| Target amount of CuO (mg) (6.31 g/cm3) | 7.3 | 21.5 | 43.2 | 86.1 |
| Weight percent of CuO to provide target | .006 | 0.02 | 0.03 | 0.07 |
| amount of oxide in immediately preceding | | | | |
| row, in a separator assuming a weight of 92 g | | | | |
| for the separator | | | | |
| Coating depth on a reference battery container | 0.02 | 0.06 | 0.12 | 0.23 |
| to provide target amount (from above) of | | | | |
| metal oxide. | | | | |
| Coating depth on the reference battery plates | 0.003 | 0.008 | 0.02 | 0.03 |
| to provide target amount (from above) of | | | | |
| metal oxide. | | | | |
| Coating depth on a reference battery separator | 0.003 | 0.009 | 0.02 | 0.04 |
| to provide target amount (from above) of | | | | |
| metal oxide. | | | | |
| Target amount of TiO₂ (mg) (4.23 g/cm3) | 9.7 | 28.7 | 57.5 | 114.9 |
| Weight percent of TiO₂ to provide target | 0.008 | 0.02 | 0.04 | 0.09 |
| amount of oxide in immediately preceding | | | | |
| row, in a separator assuming a weight of 92 g | | | | |
| for the separator | | | | |
| Coating depth on a reference battery container | 0.04 | 0.12 | 0.23 | 0.46 |
| to provide target amount (from above) of | | | | |
| metal oxide. | | | | |
| Coating depth on the reference battery plates | 0.005 | 0.02 | 0.03 | 0.07 |
| to provide target amount (from above) of | | | | |
| metal oxide. | | | | |
| Coating depth on a reference battery separator | 0.006 | 0.02 | 0.04 | 0.07 |
| to provide target amount (from above) of | | | | |
| metal oxide. | | | | |

f. Metal Oxide Coatings on Battery Components—Target Amount in High Plate Count Battery

In some embodiments, the lead acid battery has a high plate count, e.g., the battery has 21 electrode plates as opposed to the 12 plates in the reference cell described previously. It is to be understood that alternative batteries with high plate count may include as many as 13, 14, 15, 16, 17, 18, 19, 20, 21, 22, 23, 24, 25 or more plates. The higher plate count results in a change in the quantity of electrolyte and mass of the separator per cell, and thus changes the amount of metal oxide required to achieve a particular concentration of metal ions in the electrolyte. In one embodiment, the separator in a high plate count battery has a mass of 57 grams and the cell contain 0.78 liters of sulfuric acid. As described above, the sulfuric acid has a density of 1.3 g/ml.

The dimensions of a typical cell in a high plate count battery are the same as described above: the case confining the cell measures 7″×6.5″×2″ resulting in an interior surface area of 91 in² or 587 cm² for coating the container. Each battery cell contains only 21 plates, which measure 6″×6″ (36 in² on each side of the electrode plate). The plates are spaced with a 6″×6″ separator (36 in²). Contact surface area of the plates would be 36 inches²×21 plates×2 surfaces=1512 inches² or 9755 cm². The surface area of the separators would be 36 inches²×20 separators×2 surfaces=1440 inches² or 9290 cm².

To produce a hydrogen shift of 10 mV, a bismuth target ion concentration of about 14.3 ppm in the electrolyte should be provided. This can be accomplished by coating a battery component with a bismuth oxide coating such that about 16.3 mg of bismuth oxide is present in a given cell. Determining the target amount of bismuth oxide is similar to the process outlined in Equation 12, however, the different volume of the reference cell changes the calculation, by adding a multiplier of 0.78 to account for the larger cell volume. Equation 12 is therefore modified to:

Y=1.3*0.78*X*(molar mass of metal oxide/molar mass of metal ion) Eqn. 18

where Y is the target weight (in mg), X is the target concentration (in ppm), 1.3 is the density of the solution (in g/ml), and 0.78 is the volume of the cell (in liters).

The coating depth in microns to provide the adequate amount required for the various components will depend on the available surface area. For example, about 0.03 microns of a bismuth oxide coating might be needed to provide about 16.3 mg of bismuth oxide when the inside of a reference battery case is being coated (91 inches² or 587 cm² of available surface area), a coating of about 0.002 microns would be needed when the electrode plates are being coated (1512 inches² or 9755 cm² of available surface area), and a coating of about 0.002 microns would be needed when the separators are being coated (1440 inches² or 9290 cm² of available surface area).

To provide a hydrogen shift of 30 mV, a bismuth target ion concentration of about 43 ppm in the electrolyte should be provided. This can be accomplished by coating a battery component with a bismuth oxide coating such that about 48.9 mg of bismuth oxide per cell is added to the battery to leach into the electrolyte. Again, the coating depth will vary based on the component selected, for example, about 0.09 microns of a bismuth oxide coating might be needed to provide about 48.9 mg of bismuth oxide when the inside of a reference battery case is being coated (91 inches² or 587 cm² of available surface area), a coating of about 0.006 microns would be needed when the electrode plates are being coated (1512 inches² or 9755 cm² of available surface area), and a coating of about 0.006 microns would be needed when the separators are being coated (1440 inches² or 9290 cm² of available surface area).

To provide a hydrogen shift of 60 mV, a bismuth target ion concentration of about 86 ppm in the electrolyte should be provided. This can be accomplished by coating a battery component with a bismuth oxide coating such that about 97.8 mg of bismuth oxide per cell are added to the battery to leach into the electrolyte. Again, the coating depth will vary based on the component selected, for example, about 0.0.19 microns of a bismuth oxide coating might be needed to provide about 97.8 mg of bismuth oxide when the inside of a reference battery case is being coated (91 inches² or 587 cm² of available surface area), a coating of about 0.01 microns would be needed when the electrode plates are being coated (1512 inches² or 9755 cm² of available surface area), and a coating of about 0.01 microns would be needed when the separators are being coated (1440 inches² or 9290 cm² of available surface area).

To provide a hydrogen shift of 120 mV, a bismuth target ion concentration of about 172 ppm in the electrolyte should be provided. This can be accomplished by coating a battery component with a bismuth oxide coating such that about 195.6 mg of bismuth oxide per cell are added to the battery to leach into the electrolyte. Again, the coating depth will vary based on the component selected, for example, about 0.37 microns of a bismuth oxide coating might be needed to provide about 195.6 mg of bismuth oxide when the inside of a reference battery case is being coated (91 inches² or 587 cm² of available surface area), a coating of about 0.02 microns would be needed when the electrode plates are being coated (1512 inches² or 9755 cm² of available surface area), and a coating of about 0.02 microns would be needed when the separators are being coated (1440 inches² or 9290 cm² of available surface area).

TABLE 12
Amount and Coating Depths of Bismuth Oxide for a High Plate
Count Battery in a Bismuth Oxide Coating (Non-Reference Cell)

| | Hydrogen Shift (mV) | | | |
|---|---|---|---|---|
| | 10 | 30 | 60 | 120 |
| Target amount of Bi₂O₃ (mg) | 16.3 | 48.9 | 97.8 | 195.6 |
| (8.9 g/cm3) | | | | |
| Weight percent of Bi₂O₃ to | 0.03% | 0.09% | 0.17% | 0.34% |
| provide target amount of oxide in | | | | |
| immediately preceding row, in a | | | | |
| separator assuming a weight of | | | | |
| 92 g for the separator | | | | |
| Coating depth on a reference | 0.03 | 0.09 | 0.19 | 0.37 |
| battery container to provide target | | | | |
| amount (from above) of metal | | | | |
| oxide. | | | | |
| Coating depth on the reference | 0.002 | 0.006 | 0.01 | 0.02 |
| battery plates to provide target | | | | |
| amount (from above) of metal | | | | |
| oxide. | | | | |
| Coating depth on a reference | 0.002 | 0.006 | 0.01 | 0.02 |
| battery separator to provide target | | | | |
| amount (from above) of metal | | | | |
| oxide. | | | | |

Other metal oxide particles can be produce a hydrogen shift of 10, 30, 60 and 120 mV in place of the bismuth oxide particles as outlined in Table 13 below.

TABLE 13
Amount and Coating Depths of Various Metal Oxides for a High Plate Count
Battery in a Metal Oxide Coating (Non-Reference Cell)

| | Hydrogen Shift (mV) | | | |
|---|---|---|---|---|
| | 10 | 30 | 60 | 120 |
| Target amount of NiO₂ (mg) (6.72 g/cm3) | 3.6 | 10.7 | 21.2 | 42.5 |
| Weight percent of NiO₂ to provide target | 0.006% | 0.02% | 0.04% | 0.07% |
| amount of oxide in immediately preceding | | | | |
| row, in a separator assuming a weight of 92 g | | | | |
| for the separator | | | | |
| Coating depth on a reference battery | 0.009 | 0.03 | 0.05 | 0.11 |
| container to provide target amount (from | | | | |
| above) of metal oxide. | | | | |
| Coating depth on the reference battery plates | 0.0005 | 0.002 | 0.003 | 0.006 |
| to provide target amount (from above) of | | | | |
| metal oxide. | | | | |
| Coating depth on a reference battery | 0.0006 | 0.002 | 0.003 | 0.007 |
| separator to provide target amount (from | | | | |
| above) of metal oxide. | | | | |
| Target amount of SnO₂ (mg) (6.85 g/cm3) | 2.9 | 8.8 | 17.5 | 35.0 |
| Weight percent of SnO₂ to provide target | 0.005% | 0.02% | 0.03% | 0.06% |
| amount of oxide in immediately preceding | | | | |
| row, in a separator assuming a weight of 92 g | | | | |
| for the separator | | | | |
| Coating depth on a reference battery | 0.007 | 0.02 | 0.04 | 0.09 |
| container to provide target amount (from | | | | |
| above) of metal oxide. | | | | |
| Coating depth on the reference battery plates | 0.0004 | 0.001 | 0.003 | 0.005 |
| to provide target amount (from above) of | | | | |
| metal oxide. | | | | |
| Coating depth on a reference battery | 0.0005 | 0.001 | 0.003 | 0.006 |
| separator to provide target amount (from | | | | |
| above) of metal oxide. | | | | |
| Target amount of Sb₂O₃ (mg) (5.58 g/cm3) | 5.6 | 16.6 | 33.4 | 66.8 |
| Weight percent of Sb₂O₃ to provide target | 0.010% | 0.029% | 0.059% | 0.12% |
| amount of oxide in immediately preceding | | | | |
| row, in a separator assuming a weight of 92 g | | | | |
| for the separator | | | | |
| Coating depth on a reference battery | 0.02 | 0.05 | 0.10 | 0.20 |
| container to provide target amount (from | | | | |
| above) of metal oxide. | | | | |
| Coating depth on the reference battery plates | 0.001 | 0.003 | 0.006 | 0.01 |
| to provide target amount (from above) of | | | | |
| metal oxide. | | | | |
| Coating depth on a reference battery | 0.001 | 0.003 | 0.006 | 0.01 |
| separator to provide target amount (from | | | | |
| above) of metal oxide. | | | | |
| Target amount of CoO (mg) (6.44 g/cm3) | 8.3 | 24.8 | 49.6 | 99.3 |
| Weight percent of CoO to provide target | 0.01% | 0.04% | 0.09% | 0.17% |
| amount of oxide in immediately preceding | | | | |
| row, in a separator assuming a weight of 92 g | | | | |
| for the separator | | | | |
| Coating depth on a reference battery | 0.02 | 0.06 | 0.13 | 0.26 |
| container to provide target amount (from | | | | |
| above) of metal oxide. | | | | |
| Coating depth on the reference battery plates | 0.001 | 0.004 | 0.008 | 0.02 |
| to provide target amount (from above) of | | | | |
| metal oxide. | | | | |
| Coating depth on a reference battery | 0.001 | 0.004 | 0.008 | 0.02 |
| separator to provide target amount (from | | | | |
| above) of metal oxide. | | | | |
| Target amount of CuO (mg) (6.31 g/cm3) | 4.6 | 13.5 | 27.2 | 54.2 |
| Weight percent of CuO oxide to provide | 0.008% | 0.02% | 0.05% | 0.10% |
| target amount of oxide in immediately | | | | |
| preceding row, in a separator assuming a | | | | |
| weight of 92 g for the separator | | | | |
| Coating depth on a reference battery | 0.01 | 0.04 | 0.07 | 0.15 |
| container to provide target amount (from | | | | |
| above) of metal oxide. | | | | |
| Coating depth on the reference battery plates | 0.001 | 0.002 | 0.004 | 0.009 |
| to provide target amount (from above) of | | | | |
| metal oxide. | | | | |
| Coating depth on a reference battery | 0.001 | 0.002 | 0.005 | 0.009 |
| separator to provide target amount (from | | | | |
| above) of metal oxide. | | | | |
| Target amount of TiO₂ (mg) (4.23 g/cm3) | 6.2 | 18.0 | 36.2 | 72.4 |
| Weight percent of TiO₂ to provide target | 0.01% | 0.03% | 0.06% | 0.13% |
| amount of oxide in immediately preceding | | | | |
| row, in a separator assuming a weight of 92 g | | | | |
| for the separator | | | | |
| Coating depth on a reference battery | 0.03 | 0.07 | 0.15 | 0.29 |
| container to provide target amount (from | | | | |
| above) of metal oxide. | | | | |
| Coating depth on the reference battery plates | 0.001 | 0.004 | 0.009 | 0.02 |
| to provide target amount (from above) of | | | | |
| metal oxide. | | | | |
| Coating depth on a reference battery | 0.002 | 0.005 | 0.009 | 0.02 |
| separator to provide target amount (from | | | | |
| above) of metal oxide. | | | | |

In some embodiments, the metal oxide is bismuth, and the amount of metal oxide added on a reference cell basis (as defined above) by the oxide coating is in the range of about 16.3 mg to about 195.6 mg, about 16.3 mg to about 48.9 mg, about 16.3 mg to about 97.8 mg, about 48.9 mg to about 97.8 mg, about 48.9 mg to about 195.6 mg or about 97.8 mg to about 195.6 mg.

In some embodiments, the metal oxide is nickel, and the amount of metal oxide added on a reference cell basis (as defined above) by the oxide coating is in the range of about 3.6 mg to about 42.5 mg, about 3.6 mg to about 10.7 mg, about 3.6 mg to about 21.2 mg, about 10.7 mg to about 21.2 mg, about 10.7 mg to about 42.5 mg or about 21.2 mg to about 42.5 mg.

In some embodiments, the metal oxide is tin, and the amount of metal oxide added on a reference cell basis (as defined above) by the oxide coating is in the range of about 2.9 mg to about 35.0 mg, about 2.9 mg to about 8.8 mg, about 2.9 mg to about 17.5 mg, about 8.8 mg to about 17.5 mg, about 8.8 mg to about 35.0 mg or about 17.5 mg to about 35.0 mg.

In some embodiments, the metal oxide is antimony, and the amount of metal oxide added on a reference cell basis (as defined above) by the oxide coating is in the range of about 5.6 mg to about 66.8 mg, about 5.6 mg to about 16.6 mg, about 5.6 mg to about 33.4 mg, about 16.6 mg to about 33.4 mg, about 16.6 mg to about 66.8 mg or about 33.4 mg to about 66.8 mg.

In some embodiments, the metal oxide is cobalt, and the amount of metal oxide added on a reference cell basis (as defined above) by the oxide coating is in the range of about 8.3 mg to about 99.3 mg, about 8.3 mg to about 24.8 mg, about 8.3 mg to about 49.6 mg, about 24.8 mg to about 49.6 mg, about 24.8 mg to about 99.3 mg or about 49.6 mg to about 99.3 mg.

In some embodiments, the metal oxide is copper, and the amount of metal oxide added on a reference cell basis (as defined above) by the oxide coating is in the range of about 4.6 mg to about 54.2 mg, about 4.6 mg to about 13.5 mg, about 4.6 mg to about 27.2 mg, about 13.5 mg to about 27.2 mg, about 13.5 mg to about 54.2 mg or about 27.2 mg to about 54.2 mg.

In some embodiments, the metal oxide is titanium, and the amount of metal oxide added on a reference cell basis (as defined above) by the oxide coating is in the range of about 6.2 mg to about 72.4 mg, about 6.2 mg to about 18.0 mg, about 6.2 mg to about 36.2 mg, about 18.0 mg to about 36.2 mg, about 18.0 mg to about 72.4 mg or about 36.2 mg to about 72.4 mg.

8. Metal Ion Sources—Metal Oxides Integrated within a Battery Component

As noted above, in a second aspect, a source of metal ions (e.g., metal oxide) is integrated into the structure of a battery component instead of being coated on a surface. As discussed in more detail below, in certain embodiments, the battery component may be an electrode grid, a resin filled battery separator, a separator made with fibers that are associated with metal oxide particles added during a wet-laid production process, etc. In certain embodiments, the source of metal ions is included as an ingredient in the alloy used to make an electrode grid. In certain embodiments, the source of metal ions is included as part of the resin in a resin filled separator. In certain embodiments, metal oxide particles are associated with separator fibers during a wet-laid process. For example, the metal oxide particles may be added to the beater-add mix tank, with the glass fibers, non-glass additive fibers as well as further optional additives that facilitate the association between metal oxide particles and the non-glass additive fibers (e.g., cellulose fibers such as the fibers from red cedar wood pulp, or synthetic fibers).

Each of the foregoing metal ion sources is described in more detail in the following sections. In addition, for each metal ion source we have provided some exemplary amounts of metal ion source to be used in order to achieve different target metal ion concentrations in the electrolyte (and therefore different hydrogen shifts).

We begin by describing embodiments of the second aspect where the source of metal ions is included as an ingredient in the alloy used to make an electrode grid. Under a separate heading we then describe embodiments where the source of metal ions is included as part of the resin in a resin filled separator. Under a final heading we describe embodiments where metal oxide particles are associated with certain of the separator fibers during a wet-laid process.

a. Electrode Grid Metal Alloys Containing Metal Oxides—Generally

Lead acid battery electrode grids have typically been manufactured for a combination of thinness, hardness and resistance to corrosion. Corrosion of the positive grid, however, is inevitable in the operation of the lead acid battery over its life. Through corrosion over a battery's life, the battery's capacity may be diminished by as much as about 80% of its initial capacity. In that process about a significant amount (e.g., about 35 to 65%) of the positive grid metal is typically oxidized to lead dioxide and released into the electrolyte. The corrosion of the electrode plate grid can used as a mechanism by which metal ions are released into the battery electrolyte. As metallic lead is oxidized to lead dioxide, metallic constituents are liberated from the structure of the grid and enter into the electrolyte and can deposit on the surface of the negative and positive plate to cause electrochemical action. By liberating ions from the grid, a source of these metal ions can be provided.

It is well established that corrosion of the positive grid can be significant. Over the life of a battery a significant amount of water can be lost, which is coupled with a corrosion of positive grid metal, reducing the battery grid's weight. In a reference lead-acid battery cell (e.g., a cell from a 100 amp-hour valve regulated lead acid (VRLA) battery) about 120 g of water and about 280 g (about 40% of the total weight of a standard 700 g electrode plate grid) of the electrode plate grid is lost through corrosion. The lead is not lost from the battery entirely, but it is converted to lead dioxide, and released in to the electrolyte. Thus, the 40% grid weight loss in the reference cell (based on one liter of sulfuric acid with density of 1.3 g/ml) can be used to calculate target ion concentrations, and, in turn, the target amount of metal components within the battery to provide ion concentrations. As in previous aspect of the present disclosure it is to be understood that values generated using this exemplary “reference cell” can be adjusted for non-reference cells including cells that include an electrode grid that corrodes more or less than 40% within its useful life (defined herein as the time from onset of battery use to the battery reaching 80% of its initial or nominal capacity).

Positive electrode grid metal alloys, particularly low gassing alloys for VRLA or maintenance-free batteries, are a complex mix of different metals. The various metal components of the grid metal alloy serve various purposes within the battery. For example, calcium is a common grid metal alloy component. In certain embodiments, calcium provides hardness to enable the lead to be handled in subsequent plate making processes. However, to keep the calcium from being volatilized in the melt, aluminum is commonly added as a stabilizer. Additionally, contact surface of the grid metal alloy with the active material which provides capacity in the battery is enhanced by the addition of tin. Tin prevents formation of insulating oxide layers between the grid and the active material. Further, silver is often added to the electrode grid metal alloy for improved high temperature corrosion resistance.

Grid metal alloys are usually made in large kettles then remelted in lead pots that feed the molten lead alloy to individual casting book molds or a continuous casting drum. Alternatively, the molten lead alloy is poured on a steel belt to form a strip. Grids according to the present invention can be formed by these traditional methods (e.g., expanded metal processing or book mold casting). Other processing steps may include aging, hardening and curing the grid, before or after pasting. These process steps may vary, be included or omitted based in part on the battery electrode plate grid alloy used.

Table 14 below outlines common grid metal alloy components and amounts of these components for two exemplary electrode grids. The first list of grid metal alloy components and amounts is for a “high tin” electrode grid metal alloy commonly used for positive plates for “long-life” batteries. The second list of grid metal alloy components and amounts is for a “low tin” electrode grid metal alloy, commonly used for negative plates. Although not listed in the table, lead makes up the balance of the metal alloy.

TABLE 14
Common battery grid lead alloy components
(all weight percent, balance lead):

| | High Tin, for | Low Tin, for |
|---|---|---|
| | Positive Plates for | Negative Plates and |
| Element | Long Life Batteries | Starter Batteries |
| Aluminum | 0.02-0.03 | 0.02-0.03 |
| Antimony | 0.001 | 0.0005 |
| Arsenic | 0.0005 | 0.0005 |
| Bismuth | 0.025 | 0.025 |
| Cadmium | 0.0005 | 0.0005 |
| Calcium | 0.085-0.100 | 0.085-0.100 |
| Copper | 0.001 | 0.001 |
| Iron | 0.001 | 0.001 |
| Nickel | 0.0003 | 0.0003 |
| Silver | 0.005 | 0.005 |
| Sodium | 0.001 | 0.001 |
| Sulfur | 0.0005 | 0.0005 |
| Tellurium | 0.0001 | 0.0001 |
| Tin | 1.3-1.6 | 0.50-0.60 |
| Zinc | 0.0002 | 0.0005 |

Different amounts of bismuth, copper, nickel, or other metal ions that are discussed herein can be included in the electrode grid metal alloy in order to achieve a desired target concentration (e.g., in a reference electrode). Some examples are provided in the following section. In addition, in some embodiments, the calcium concentration may be between about 0.01 and about 0.15 percent (by weight), e.g., between about 0.05 and about 0.15 percent or between about 0.085 and about 0.1 percent. In some embodiments, the tin concentration may be between about 0.01 and about 1.6 percent (by weight), e.g., between about 0.2 and about 2.5 percent, between about 0.5 and about 0.6 percent, or between about 1.3 and about 1.6 percent. In some embodiments, the silver concentration may be between about 0.001 percent to about 0.01 percent.

b. Electrode Grid Containing Metal Oxides—Target Amounts of Metal Oxide

As described above, the battery electrode grid metal alloy can be a source of metal ions for the electrolyte. The electrode grid metal alloy constituents will vary based on the target metal ion concentration. The values given below are based on the aforementioned reference lead-acid battery cell and electrode grid and can be scaled for non-reference cells that include a different electrolyte volume and/or different amount of electrode grid metal alloy, etc. The values given below are based on a range of hydrogen shifts (from 10 mV to 120 mV). For all calculations, it was also assumed that the reference cell contained: (a) 1 liter of 1.3 g/ml density sulfuric acid (i.e., the same as in previous calculations) and (b) a total of 700 g weight battery electrode grid, 280 g of which corrodes into the electrolyte by the time the battery reaches 80% of its initial (or nominal) capacity (i.e., the availability of the metal ion within the electrode grid metal alloy equals 280 g/700 g or 40%).

The following are estimates of the effects of bismuth ion in solution and their electrochemical effect on shifting the hydrogen gassing potential (point at which the negative electrode begins to liberate hydrogen). As in previous sections, our calculations are initially presented for bismuth oxide as the source of metal ion and then for other metal ion sources.

To produce a hydrogen shift of 10 mV, a bismuth target ion concentration of about 14.3 ppm in the electrolyte should be provided. This can be accomplished by having 18.6 mg of bismuth ion per cell leach into the electrolyte as the battery grid corrodes. The 18.6 mg of bismuth ion are released from the 280 g of grid metal that corrodes into the electrolyte. This gives a concentration of 0.007 weight percent of bismuth in the electrode grid metal alloy.

To produce a hydrogen shift of 30 mV, a bismuth target ion concentration of about 43 ppm in the electrolyte should be provided. This can be accomplished by having 56 mg of bismuth ion per cell leach into the electrolyte as the battery grid corrodes. Factoring in the 280 g of grid metal lost and the need for 56 mg of bismuth ion, this would correspond to 0.02 weight percent of bismuth in the electrode grid metal alloy.

To produce a hydrogen shift of 60 mV, a bismuth target ion concentration of about 86 ppm in the electrolyte should be provided. This can be accomplished by having 111 mg of bismuth ion per cell leach into the electrolyte as the battery grid corrodes. Factoring in the 280 g of grid metal lost and the need for 111 mg of bismuth ion, this would correspond to 0.04 weight percent of bismuth in the electrode grid metal alloy.

To produce a hydrogen shift of 120 mV, a bismuth target ion concentration of about 172 ppm in the electrolyte should be provided. This can be accomplished by having 223 mg of bismuth ion per cell leach into the electrolyte as the battery grid corrodes. Factoring in the 280 g of grid metal lost and the need for 223 mg of bismuth ion, this would correspond to 0.08 weight percent of bismuth in the electrode grid metal alloy.

Likewise, other metal ions can be incorporated into the electrode grid metal alloy. The following metal concentrations have been found to impart the desired electrochemical effect of shifting the hydrogen gassing where Func Y describes the formula for converting mV hydrogen shift to weight percent metal in the electrode grid metal alloy (e.g., for a 10 mV shift, Y=0.0007*10=0.007 weight percent bismuth in the electrode grid metal alloy):

TABLE 15
Metal Concentrations for Various Battery Plate Grid Alloys (all weight percent)

| Hydrogen | % Bi in | % Ni in | % Sn in | % Sb in | % Co in | % Cu in | % Ti in |
|---|---|---|---|---|---|---|---|
| Shift (mV) (X) | Alloy | Alloy | Alloy | Alloy | Alloy | Alloy | Alloy |
| 10 | 0.007 | 0.0011 | 0.0011 | 0.0021 | 0.0030 | 0.0017 | 0.0017 |
| 30 | 0.02 | 0.0032 | 0.0032 | 0.0064 | 0.0089 | 0.0050 | 0.0050 |
| 60 | 0.04 | 0.0063 | 0.0063 | 0.0128 | 0.0179 | 0.0099 | 0.0099 |
| 120 | 0.08 | 0.0125 | 0.0126 | 0.0255 | 0.0358 | 0.0198 | 0.0199 |
| Func Y = | .0007 * X | .000104 * X | .000104 * x | .000213 * X | .000213 * X | .0002 * X | .0002 * X |

In some embodiments, the metal is bismuth, and the weight percentage of bismuth in the electrode grid metal alloy is in the range of about 0.007 weight percent to about 0.08 weight percent, about 0.007 weight percent to about 0.02 weight percent, about 0.007 weight percent to about 0.04 weight percent, about 0.02 weight percent to about 0.04 weight percent, about 0.02 weight percent to about 0.08 weight percent or about 0.04 weight percent to about 0.08 weight percent.

In some embodiments, the metal is nickel, and the weight percentage of nickel in the electrode grid metal alloy is in the range of about 0.001 weight percent to about 0.013 weight percent, about 0.001 weight percent to about 0.003 weight percent, about 0.001 weight percent to about 0.006 weight percent, about 0.003 weight percent to about 0.006 weight percent, about 0.003 weight percent to about 0.013 weight percent or about 0.006 weight percent to about 0.013 weight percent.

In some embodiments, the metal is tin, and the weight percentage of tin in the electrode grid metal alloy is in the range of about 0.001 weight percent to about 0.013 weight percent, about 0.001 weight percent to about 0.003 weight percent, about 0.001 weight percent to about 0.006 weight percent, about 0.003 weight percent to about 0.006 weight percent, about 0.003 weight percent to about 0.013 weight percent or about 0.006 weight percent to about 0.013 weight percent.

In some embodiments, the metal is antimony, and the weight percentage of antimony in the electrode grid metal alloy is in the range of about 0.002 weight percent to about 0.026 weight percent, about 0.002 weight percent to about 0.006 weight percent, about 0.002 weight percent to about 0.013 weight percent, about 0.006 weight percent to about 0.013 weight percent, about 0.006 weight percent to about 0.026 weight percent or about 0.013 weight percent to about 0.026 weight percent.

In some embodiments, the metal is cobalt, and the weight percentage of cobalt in the electrode grid metal alloy is in the range of about 0.003 weight percent to about 0.036 weight percent, about 0.003 weight percent to about 0.089 weight percent, about 0.003 weight percent to about 0.018 weight percent, about 0.089 weight percent to about 0.018 weight percent, about 0.089 weight percent to about 0.036 weight percent or about 0.018 weight percent to about 0.036 weight percent.

In some embodiments, the metal is copper, and the weight percentage of copper in the electrode grid metal alloy is in the range of about 0.002 weight percent to about 0.02 weight percent, about 0.002 weight percent to about 0.005 weight percent, about 0.002 weight percent to about 0.01 weight percent, about 0.005 weight percent to about 0.01 weight percent, about 0.005 weight percent to about 0.02 weight percent or about 0.01 weight percent to about 0.02 weight percent.

In some embodiments, the metal is titanium, and the weight percentage of titanium in the electrode grid metal alloy is in the range of about 0.002 weight percent to about 0.02 weight percent, about 0.002 weight percent to about 0.005 weight percent, about 0.002 weight percent to about 0.01 weight percent, about 0.005 weight percent to about 0.01 weight percent, about 0.005 weight percent to about 0.02 weight percent or about 0.01 weight percent to about 0.02 weight percent.

c. Resin Filled Separator Containing Metal Oxides—Generally

In certain embodiments, the source of metal ions is included in the resin of a resin-filled battery separator. An advantage of this type of battery separator (i.e., a filled mat separator, or filled separator) is very low electrical resistance, high strength, high flexibility and high porosity. In this separator design an open fibrous mat is filled with a slurry that includes a binding resin and optionally silica powder.

In some embodiments, the resin is an organic resinous or plastic material. In certain embodiments, the resin is a polyacrylate (Acrylic), polystyreneacrylate (STYACR), styrene butadiene rubber (SBR), or polyvinylidine chloride (PVDC). Mixtures of the above can also be used. In certain embodiments, the resin is a latex. The resin may also contain additives such as wetting agents, thickeners, catalysts, accelerators, guar gum and polyacrylamides. In some embodiments, the resin solution is aqueous or uses an organic solvent. In some embodiments, the resin makes up between about 1 weight percent and about 35 weight percent of the bath or resin solution. In some embodiments, the additives are present in an amount between about 0 weight percent and about 20 weight percent of the resin weight in the solution or bath.

In one embodiment, the latex resin described is blended into a wet batch with precipitated silica and a thickening agent along with water and a base for pH balance. Metal powders or metal oxides can be incorporated into the latex batch and then leach into the electrolyte from the separator structure to deposit on the positive and negative battery plates to impact plate morphology and shift the electrochemical effect, particularly in shifting the onset of hydrogen generation on the negative electrode.

The availability of the resin filled separator can be any of the availability values described in the general availability section. In certain embodiments, the resin filled separator has about 70% availability. This would mean that only about 70% of the metal oxide added to the structure is available to electrolyte to leach out the specified metal ions. Therefore, 1.4 times the required amount of metal oxide particles would need to be added to impart the desired electrochemical effect, as compared to a 100% available separator.

d. Resin Filled Separator Containing Metal Oxides—Target Amounts of Metal Oxide

To determine the quantity of a metal oxide in a resin or resin filled separator, similar relationships can be used as for the resin coating methods described above (e.g., see Section 6a above). Again the specific concentration and amount of metal oxides will vary by selection of the particular metal and battery component geometry. The embodiments described below are for a reference lead-acid battery cell but can be scaled for non-reference cells. For all calculations, it was assumed that the reference cell contained: (a) 1 liter of 1.3 g/ml density sulfuric acid (i.e., the same as in previous calculations), (b) 92 g of separator (i.e., about 7.7 g per separator), and (c) that the metal oxide had 70% availability once present within the resin filler separator.

As discussed previously, it is to be understood that the “reference cell basis” values that are provided below using these reference cell assumptions can be readily scaled up or down when different electrolyte volumes or electrolyte strengths are used, when separators with different availabilities are used and/or when different amounts of separator are used. As in previous sections, our calculations are initially presented for bismuth oxide as the source of metal ion and then for other metal ion sources.

To produce a hydrogen shift of 10 mV, a bismuth target ion concentration of about 14.3 ppm in the electrolyte should be provided. This can be accomplished by adding bismuth oxide particles to a resin in the production of a resin filed separator. To achieve this electrolyte concentration the resin component of the battery separator should contain about 29.4 mg of bismuth oxide particles (e.g., 90-210 nm diameter particles). Referring to Equation 14, this target weight is determined in the same manner, but adjusted for the availability of the separator, in this case taken to be 70%. Thus equation 14 is revised to:

Y=1.3*X*1.43*1.0*(molar mass of metal oxide/molar mass of metal ion) Eqn. 19

where Y is the target weight (in mg), X is the target concentration (in ppm), 1.3 is the density of the solution (in g/ml), 1.43 is a factor that reflects the 70% availability and 1.0 is the volume of the cell (in liters).

The ultimate final product, a resin filed separator should have enough resin filler with metal oxide particles so that the separator, as a whole, includes 0.03 weight percent bismuth oxide particles.

To provide a hydrogen shift of 30 mV, a bismuth target ion concentration of about 43 ppm in the electrolyte should be provided. The ultimate final product, a resin filed separator should have enough resin filler with metal oxide particles so that the separator, as a whole, includes 0.10 weight percent bismuth oxide particles.

To provide a hydrogen shift of 60 mV, a bismuth target ion concentration of about 86 ppm in the electrolyte should be provided. The ultimate final product, a resin filed separator should have enough resin filler with metal oxide particles so that the separator, as a whole, includes 0.20 weight percent bismuth oxide particles.

To provide a hydrogen shift of 120 mV, a bismuth target ion concentration of about 172 ppm in the electrolyte should be provided. The ultimate final product, a resin filed separator should have enough resin filler with metal oxide particles so that the separator, as a whole, includes 0.39 weight percent bismuth oxide particles.

Other metal ions can be incorporated into the structure of the separator to achieve the desired electrochemical effect. The table below provides target hydrogen shifts and corresponding metal oxide particle loadings in the separator (presented as a total weight percent of the separator).

TABLE 16
Target Metal Oxide Concentrations for Resin
Filled Separators for Various Metal Oxides

Hydrogen Shift (mV)

| | 10 | 30 | 60 | 120 |
|---|---|---|---|---|
| Weight percent Bi₂O₃ | 0.03 | 0.10 | 0.20 | 0.39 |
| Weight percent NiO₂ | 0.007 | 0.02 | 0.04 | 0.08 |
| Weight percent SnO₂ | 0.006 | 0.02 | 0.04 | 0.07 |
| Weight percent Sb₂O₃ | 0.01 | 0.03 | 0.07 | 0.13 |
| Weight percent CoO | 0.02 | 0.05 | 0.10 | 0.19 |
| Weight percent CuO | 0.009 | 0.03 | 0.05 | 0.11 |
| Weight percent TiO₂ | 0.01 | 0.04 | 0.07 | 0.14 |

e. Beater-Add Methods Using Metal Oxides—Generally

In certain embodiments, the battery component with an integrated source of metal ions is a separator to which metal oxide particles are bound by electrostatic interaction. The metal oxides can be attached by using ionic interactions between non-glass additive fibers and the metal oxide particles in a wet-laid formation process. In this manner it is possible to attract and bind metal oxide particles to the formed paper structure. In certain embodiments, non-glass additive fibers (e.g., cellulosic pulps, such as cedar pulp) have negatively charged hydroxyl groups that can attract positively charged metal ions in the papermaking process thereby creating a separator with metal oxide particles. Exposure to battery electrolyte will break this bond, liberating the metal oxide from the separator structure. It is to be appreciated that any additive fiber with a negative charge or negative charged sites could be a substitute for the exemplary cellulosic fibers that are discussed herein. In particular, synthetic fibers can also be used in combination with, or in place of the cellulosic fibers. Further, optional additives (e.g., retention aids and dispersants) described below, can further enhance and strengthen the interactions between the non-glass additive fibers and the metal oxide particles.

The wet-laid process may also utilize flocculation, coagulation and/or retention to improve product quality and efficiency of manufacture. These actions all are agglomeration actions of filler particles, fines, or fibers with themselves or with each other. Agglomeration occurs as a result of electrostatic attraction (i.e., cationic polymers or ions are neutralized by anionic fibers, fines, or inorganic fillers) and is the mechanism by which metal oxide particles are attached to the fibers in the separator. Retention aids can enhance negative charge. Extra additional negative charge can also be added through dispersants such as polyacrylamide, poly(ethylene oxide), alum (potassium aluminum sulfate), carboxymethyl cellulose and natural gums such as guar gum. In general, the anionic acrylamide polymers, usually uses acrylic acid as the comonomer to impart the negative charge. Other anionic polymers such as polyacrylates, lignin sulfonates, and naphthalene sulfonates can also enhance negative charge of the pulp/fibers to enhance attraction and bonding of positively charged cations such Bi⁺², Cu⁺², Ni⁺², Ti⁺², Sn⁺² or other metal ions.

For purposes of illustration and without limitation, three exemplary separators were produced (each with different levels of bismuth oxide particles attached). Various levels of bismuth oxide particles with diameters of about 90 to about 210 nm were incorporated into the separator structure. The separator structure consisted of 90% by weight 1.4 micron diameter glass fibers and 10% by weight negatively charged non-glass additive fibers (cellulose pulp). Bismuth oxide particles were incorporated into the separator structure by addition to the beater tank at target levels of 0.2, 0.5 and 1 weight percent bismuth oxide particles. After separator formation, chemical analysis showed a bismuth oxide retention level of 0.11, 0.20 and 0.45 weight percent respectively. Without wishing to be limited to any theory, the less than full retention is thought to be through loss of very fine bismuth oxide particles, potentially through insufficient negative charge imparted by the cellulose fibers, or loss of the very fine cellulose fibrils themselves (with bismuth oxide particles attached). It is anticipated that increased retention can be achieved through routine optimization. Alternatively, it will be appreciated that the amounts of bismuth oxide particles added on the front end could simply be increased based on the portion that is typically retained.

f. Beater-Add Methods Using Metal Oxides—Target Amount of Metal Oxide

Determining the quantity of metal oxides for one of these “composite” separators in which the metal oxides are added to the beater tank is based on the target concentration of metal ions in the electrolyte. Because the metal oxide particles in the separator are 100 percent available, there is no need to account for availability. For example, empirical testing of three exemplary composite separators showed that the aforementioned composite separators with 0.11, 0.20 and 0.45 weight percent bismuth oxide leached to provide bismuth ion concentrations in the electrolyte of 67, 116 and 247 ppm, respectively. These values indicate full release of the bismuth oxide present in the composite separators (i.e., 100% availability). These exemplary concentrations, by the relationship described above of bismuth ion released to electrochemical action (hydrogen shift) would produce hydrogen shifts of 47 mV, 87 mV and 196 mV, respectively. Further concentrations of various metal oxides in composite separators are described in Table 17 below where Func Y describes the formula for converting mV hydrogen shift to weight percent metal oxide in the composite separator (e.g., for a 10 mV hydrogen shift using bismuth oxide, Y=0.0007*10=0.007 weight percent bismuth oxide in the separator).

For all calculations, it was also assumed that the composite separator was being used in a reference cell containing: (a) 1 liter of 1.3 g/ml density sulfuric acid (i.e., the same as in previous calculations) and (b) 92 g of separator (i.e., about 7.7 g per separator). As noted above, it was also assumed that the metal oxide had 100% availability within the composite separator.

As discussed previously, it is to be understood that the “reference cell basis” values that are provided below using these reference cell assumptions can be readily scaled up or down when different electrolyte volumes or electrolyte strengths are used, when different amounts of separator, when different amounts of glass fiber in the separator, etc. are used. As in previous sections, our calculations are initially presented for bismuth oxide as the source of metal ion and then for other metal ion sources.

To produce a hydrogen shift of 10 mV, a bismuth ion concentration of about 14.3 ppm in the electrolyte should be provided. This can be accomplished by adding bismuth oxide particles in the production of a composite separator. The ultimate final product, a separator with attached metal oxide particles should have 0.02 weight % bismuth oxide particles.

To produce a hydrogen shift of 30 mV, a bismuth ion concentration of about 43 ppm in the electrolyte should be provided. This can be accomplished by adding bismuth oxide particles in the production of a composite separator. The ultimate final product, a separator with attached metal oxide particles should have 0.07 weight % bismuth oxide particles.

To produce a hydrogen shift of 60 mV, a bismuth ion concentration of about 86 ppm in the electrolyte should be provided. This can be accomplished by adding bismuth oxide particles in the production of a composite separator. The ultimate final product, a separator with attached metal oxide particles should have 0.14 weight % bismuth oxide particles.

To produce a hydrogen shift of 120 mV, a bismuth ion concentration of about 172 ppm in the electrolyte should be provided. This can be accomplished by adding bismuth oxide particles in the production of a composite separator. The ultimate final product, a separator with attached metal oxide particles should have 0.27 weight % bismuth oxide particles.

TABLE 17
Concentrations of Various Metal Oxides, per cell, in a Composite Separator (all weight percent)

| | Weight | Weight | Weight | Weight | Weight | Weight | Weight |
|---|---|---|---|---|---|---|---|
| Hydrogen Shift | percent | percent | percent | percent | percent | percent | percent |
| (mV) (X) | Bi₂O₃ | NiO₂ | SnO₂ | Sb₂O₃ | CoO | CuO | TiO₂ |
| 10 | 0.02 | 0.0005 | 0.004 | 0.008 | 0.01 | 0.006 | 0.009 |
| 30 | 0.07 | 0.01 | 0.01 | 0.02 | 0.03 | 0.02 | 0.03 |
| 60 | 0.14 | 0.03 | 0.02 | 0.05 | 0.07 | 0.04 | 0.05 |
| 120 | 0.27 | 0.06 | 0.05 | 0.09 | 0.13 | 0.08 | 0.10 |
| Func Y = | .0023 * X | 0.0005 * X | 0.0004 * X | 0.0008 * X | 0.0011 * X | 0.0006 * X | 0.0008 * X |

Instead of a glass mat type separator containing metal oxide via the beater tank addition, a pasting paper can also be utilized as a vehicle for delivering beneficial metal ions to the electrolyte. Pasting paper is a thin layer of paper applied to the surfaces of the plate to aid processes enabling very thin plates to be pasted. The pasting paper is a very thin non-woven material, similar to a separator. Pasting paper is best constructed of glass fibers. The construction can be all glass, or can have synthetic fibers for a minority or majority of fibers for higher strength. The pasting paper is present in the battery cell at lower amounts than the separator (e.g., an exemplary cell will have a 92 g separator, but a 24.2 g sheet of pasting paper total). For all calculations, it was therefore assumed that (a) 24.2 g of pasting paper is present in each cell (b) each cell contains 1 liter of 1.3 g/ml density sulfuric acid. The metal oxide particles were again assumed to be 100% available in the pasting paper.

To produce a hydrogen shift of 10 mV, the bismuth target ion concentration of 14.3 ppm in the electrolyte should be provided. This can be accomplished by adding bismuth oxide particles so that the pasting paper contains 0.09 weight percent bismuth oxide particles.

To produce a hydrogen shift of 30 mV, 43 ppm of bismuth target ion must be released. This can be accomplished by adding bismuth oxide particles so that the pasting paper contains 0.26 weight percent bismuth oxide particles.

To produce a hydrogen shift of 60 mV, 86 ppm of bismuth target ion must be released. This can be accomplished by adding bismuth oxide particles so that the pasting paper contains 0.52 weight percent bismuth oxide particles.

To produce a hydrogen shift of 120 mV, 172 ppm of bismuth target ion must be released. This can be accomplished by adding bismuth oxide particles so that the pasting paper contains 1.04 weight percent bismuth oxide particles.

Other metal oxides can be used in lieu of bismuth oxide to achieve similar electrochemical effects. The weight percentages of bismuth oxides are summarized in the first row of the table below. Furthermore, weight percentages for pasting paper for alternative metal oxides are given in the table below.

TABLE 18
Weight Percent Metal Oxide content for Composite
Pasting Paper (all weight percent)

Hydrogen Shift (mV)

| | 10 | 30 | 60 | 120 |
|---|---|---|---|---|
| Bi₂O₃ | 0.08 | 0.26 | 0.52 | 1.04 |
| NiO₂ | 0.02 | 0.06 | 0.11 | 0.22 |
| SnO₂ | 0.02 | 0.05 | 0.09 | 0.19 |
| Sb₂O₃ | 0.03 | 0.09 | 0.18 | 0.35 |
| CoO | 0.04 | 0.13 | 0.26 | 0.51 |
| CuO | 0.024 | 0.07 | 0.14 | 0.29 |
| TiO₂ | 0.032 | 0.10 | 0.19 | 0.38 |

We claim:

1. A lead acid battery that comprises a negative electrode, a positive electrode, a separator between the negative and positive electrodes, and an electrolyte in contact with the negative and positive electrodes, wherein an electrode comprises an electrode grid metal alloy with a means for shifting the voltage at which hydrogen is produced at the negative electrode by between about 10 mV and about 120 mV.

2. A lead acid battery comprising the following components: a case, a negative electrode, a positive electrode, a separator, an electrolyte, and a coating of metal or metal oxide coating a surface of at least one battery component wherein the surface is a surface that contacts the electrolyte within the battery.

3. A lead acid battery comprising the following components: a case, a negative electrode, a positive electrode, a separator, electrolyte in contact with the components, and a resin containing particles of a metal or metal compound coating a surface of at least one battery component wherein the surface is a surface that contacts the electrolyte within the battery.
